(19) United States
(12) Patent Application Publication
(10) Pub. No.: US 2012/0179483 A1
(43) Pub. Date: Jul. 12, 2012

(54) REFERRAL CREATION AND TRACKING SYSTEM

(76) Inventor: Keith R. Norton, Gilbert, AZ (US)

(21) Appl. No.: 13/231,678

(22) Filed: Sep. 13, 2011

Related U.S. Application Data
(60) Provisional application No. 61/382,157, filed on Sep. 13, 2010.

(51) Int. Cl. G06Q 50/22

(52) U.S. Cl. 705/2

(57) ABSTRACT

Methods and computer programs for tracking referrals received from one or more referring persons to a professional are disclosed. The method may include receiving, from a referring person of the one or more referring persons, an electronic instruction to print a paper copy of referral data associated with a referral from the referring person. The method may additionally include storing the referral data in first and second portions of a database in response to receiving the electronic instruction, wherein the first portion is accessible via the Internet by the referring person and the second portion is accessible via the Internet by the professional.

### CROSS-REFERENCE TO RELATED APPLICATIONS

This application claims priority under 35 U.S.C. §119(e) to U.S. Provisional Patent Application Ser. No. 61/382,157 entitled “Referral Creation and Tracking System,” filed Sep. 13, 2010. The complete disclosure of the above application is hereby incorporated by reference for all purposes.

### FIELD OF THE DISCLOSURE

The invention relates to management systems and methods. More particularly, the invention relates to systems and methods for managing referrals of patient care activities between medical care providers. The system may have application to other service fields, including accounting and legal services.

### BACKGROUND OF THE DISCLOSURE

Service providers in many fields operate in a fast moving electronic environment in which detailed information is updated repeatedly and rapidly by multiple agents from multiple source points in scant time periods. In some cases, specific allocation of costs for services provided depend in part on referrals between service providers within a field, or between service providers in different fields, or between service providers in subfields, or between a primary (general) service provider and secondary (specialty) service providers. Medical services are commonly managed, financed, and resourced among a variety of general and specialist service providers. Referrals between such providers are a critical transfer operation within such systems, and are financially accounted in current medical cost allocation systems. However, current referral systems generally lack active tracking mechanisms for referral activity between medical service providers. Such deficiency permits referral activities and associated costs and remunerations to be lost soon after referral activity is initiated.

Examples of medical activity management methods are shown in U.S. Patent Application Nos. US20080052110, US20040249676, and US20040199412, and Canadian Patent Application CA2470027. The disclosures of these and all other publications referenced herein are incorporated by reference in their entirety for all purposes.

Using current practices for Dentists as an example, to effect patient care referrals, Specialist care providers provide General Dentists with “Referral Pads”, which commonly provide printed scripts or pre-set forms in a General Practitioner's practice management software. To create a referral, a General Practitioner fills out the form, and then provides the form to the patient. However, a referral has only successfully happened once the Specialty Practice is included. The General Practitioner may or may not send a copy of the referral to the referred specialist practitioner, which involves a phone call, a facsimile transmission (FAX), and/or an email message. This “Extra Step” is the Kiss of Death for many referrals. While a General Practitioner may be genuinely willing to help a referral to a specialist become successfully completed, at least in the interests of furthering patient care, such follow-up contact is an easy step to forget or otherwise lose track of.

Lost referrals are a common problem that undermines the true potential of specialty practices across the country. Paper based referrals get lost whenever a patient fails to take the initiative to take the first step and call the specialty practice to schedule an initial appointment. With paper based referrals, General Practitioners have to go out of their way to forward a copy of each referral to the specialty practice. That is, informing the specialty practice is not automatic. A terrible flaw in the old fashioned “paper based referral pad” system is that rarely, if ever, do referring doctors take the time to provide their specialty practices with the patient contact information for each new patient they refer. If a specialty practice was forwarded an original copy of every new patient referral form (including complete contact information), then the specialty practice's staff could follow up with every potential new patient, and lost referrals (and missed opportunities) would be a thing of the past.

The present invention provides a referral database system for enabling general and specialist medical service providers to establish and mutually track patient care referrals. In preferred examples, the referral database system provides a custom online referral-platform technology that enables service providers a mechanism to put an end to lost referrals in their practices; follow-up with patients they would otherwise miss; to create, send, receive and track unlimited online patient referrals from their own existing network of referring doctors; to send and receive unlimited service referrals in an online universal referral platform environment that us safe, secure, and HIPAA Compliant, and using customizable tools to fit their own practice. The referral database system provides a referred specialty practitioner with patient referral information, and patient contact information, automatically.

The referral database system is a cost-effective, secure, HIPAA compliant, universal referral platform that connects specialty practices to their new patient referrals in real-time. The technology provide specialty practitioners with all the tools they need to create a customized online referral form and then guide their referring doctors through the process of learning to use the new online referral system instead (of the old-fashioned paper pad and secondary notification system).

After a specialty practitioner has subscribed to the referral database system and has created a referral database systems form, referring general practitioners can easily find and save this form to their free General Practitioner account by searching for the specialist by name, zip code and/or city/state. When referring General Practitioners use their preferred specialist's referral database system's form to refer a patient, a referral notification including complete patient contact information is automatically generated and is sent directly to the specialist's inbox. Extensive safeguards are built into the technology to ensure the privacy of patients and to comply with all HIPAA regulated doctor/patient confidentiality requirements. Because linked referral notifications are both printed for the patient and forwarded to the specialist with a single keystroke, no extra step is required to notify the specialty practitioner that a referral has been made. The specialty practitioner (and/or his practice staff) will automatically receive a copy of the new patient referral every time.

Advantages of the present disclosure will be more readily understood after considering the drawings and the Detailed Description. The drawings show screen captures of an exemplary system according to the present disclosure, and include my trademarks, (e)ferral™ and The referral database system™.

### SUMMARY OF THE DISCLOSURE

The present disclosure is directed to a method of tracking referrals received from one or more referring persons to a professional. The method may include receiving, from a referring person of the one or more referring persons, an electronic instruction to print a paper copy of referral data associated with a referral from the referring person. The method may additionally include storing the referral data in first and second portions of a database in response to receiving the electronic instruction. The first portion may be accessible via the Internet by the referring person and the second portion may be accessible via the Internet by the professional.

The present disclosure is additionally directed to a storage medium, readable by a processor of a computer system, having embodied therein a computer program of commands executable by the processor. The computer program may be configured to be executed to receive an electronic instruction to print a paper copy of referral data associated with a referral from a referring person to a professional, and store the referral data in first and second portions of a database in response to receiving the electronic instruction. The first portion may be accessible via the Internet by the referring person and the second portion may be accessible via the Internet by the professional.

The present disclosure is further directed to a method of tracking referrals received from one or more referring general practitioners to a specialist. The method may include receiving at least one customized form from the specialist, providing the at least one customized form to the one or more referring general practitioners, and providing the one or more referring general practitioners with the ability to store the at least one customized form from the specialist in a portion of the database. The method may additionally include providing the at least one customized form to a referring general practitioner of the one or more referring general practitioners, and receiving an electronic instruction to print a paper copy of the at least one customized form having referral data associated with a referral from the referring general practitioner.

The method may further include storing the referral data in first and second portions of a database in response to receiving the electronic instruction. The first portion may be accessible via the Internet by the referring general practitioner and the second portion may be accessible via the Internet by the specialist. The method may additionally include receiving treatment status data via the Internet from the specialist, and associating the treatment status data with the referral data of the referral. The method may further include storing the associated treatment status data in the first and second portions of the database with the referral data.

### BRIEF DESCRIPTION OF DRAWINGS

FIGS. 1-13 show schematically the predominant current method of referral of patient care from a general practitioner to a specialty practitioner, including a script to the patient, and an independent notification to the specialty practitioner by the patient or by the referring general practitioner.

FIGS. 14-24 show schematically principal defects of the current method of separate referral notifications to a patient and a specialty practitioner.

FIGS. 25 and 26 show a verbal description of the predominant current method of referral of patient care “the way we do it now”.

FIGS. 27-29 show a verbal introduction to a system of managing referrals through a database according to the present disclosure, which provides for an automatic notification of a referred specialty practitioner linked to the creation of a referral provided to a patient.

FIGS. 30 and 31 show a captured image of an online introduction to a referral database system according to the present disclosure.

FIG. 32 shows a captured image of an online introduction to subscription pricing options for a referral database system according to the present disclosure.

FIGS. 33-34 show a General Practitioner registration feature for a referral database system according to the present disclosure.

FIG. 35 shows a referral database system form for a general practitioner to create a patent referral to a specialty practitioner.

FIGS. 36-41 show referral database system forms for creating referrals to specialty practitioners in different specialty care areas.

FIG. 42 shows a secure login entry mechanism consistent with the present disclosure.

FIGS. 43-48 show serial elements for establishing a specialty provider subscripted account in a referral database system according to the present disclosure.

FIGS. 49-50 show a central interaction center page for a subscripted specialty practitioner in the referral database system of the present disclosure.

FIGS. 52-54 show customizable information upload options for subscripted practitioners in the referral database system of the present disclosure.

FIGS. 55 shows a feature by which a referral may be directed to a particular specialty practitioner by searching for the practitioner in previous referral history in the database.

FIG. 56 show a feature by which a referral may be directed to a particular specialty practitioner by searching for the practitioner by name in the database.

FIGS. 57-61 show sequentially a procedure to create a coordinated patient referral according to the present disclosure though data entry on an online referral database system form.

FIGS. 62-67 show methods by which a practitioner may search the referral database for information specific to a referred patient, a referral practitioner, and/or a date of referral.

FIGS. 68-73 show analysis reports including statistical parameters of referrals generated by search requests of the referral database system according to the present disclosure.

FIGS. 74-75 show a Frequently Asked Questions (FAQ) user response page for an online subscripted patient referral management tracking system consistent with the present disclosure.

FIGS. 76-87 show schematically menu flow charts for organizing interactions between subscribers and the referral database system.

FIGS. 88-112 show captured images of an alternative embodiment of an online referral database system according to the present disclosure.

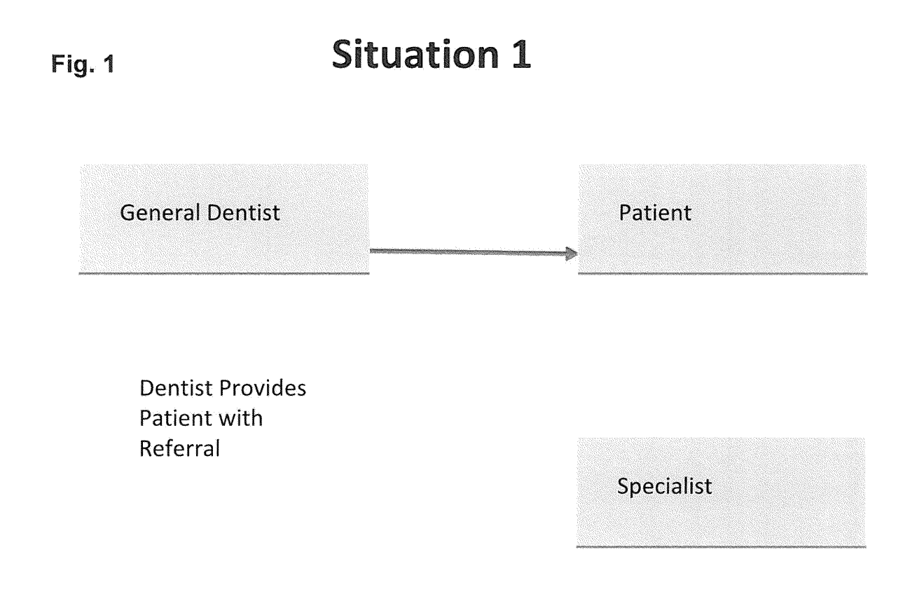

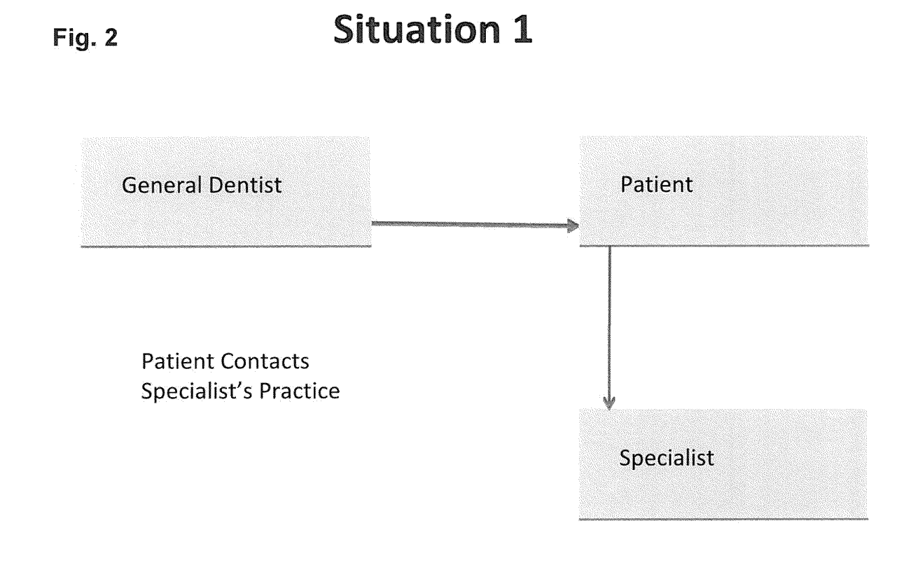

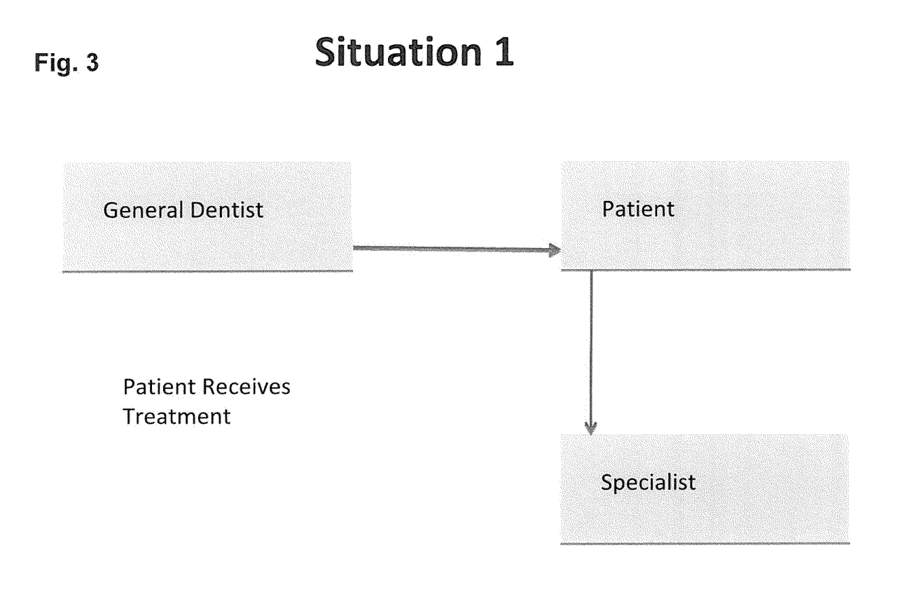

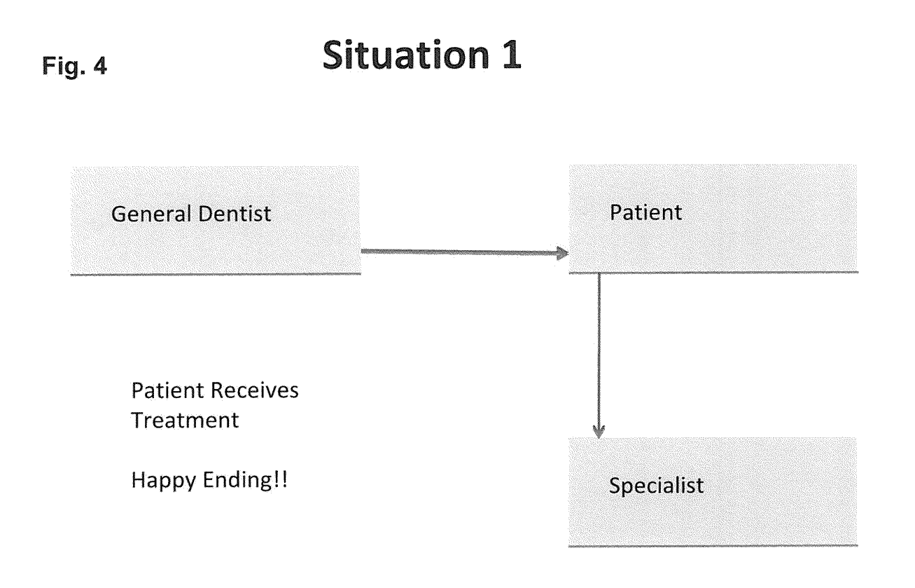

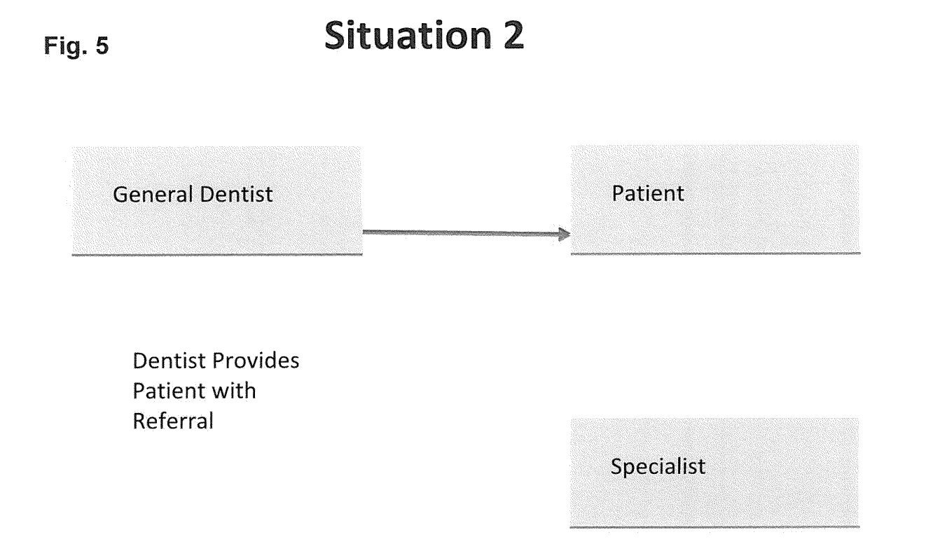

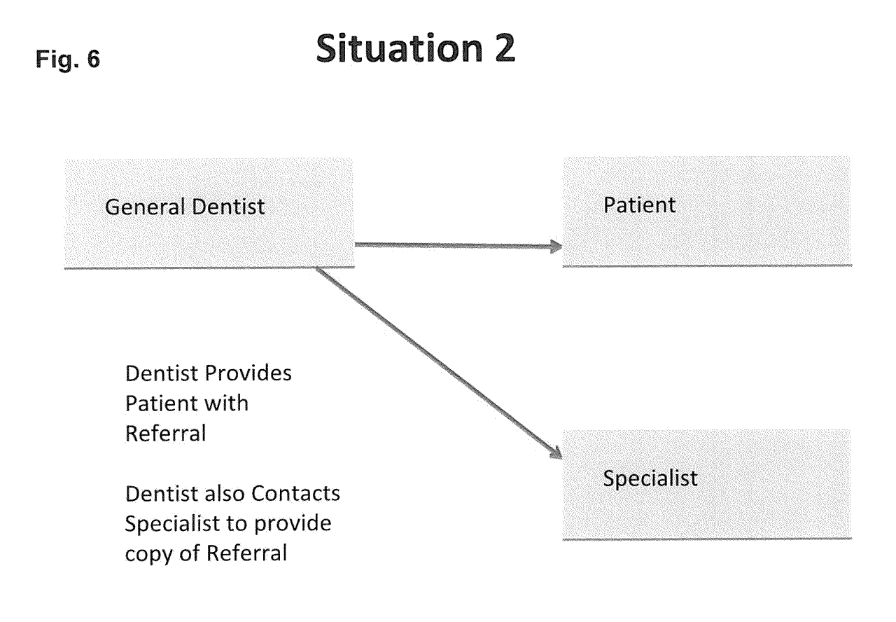

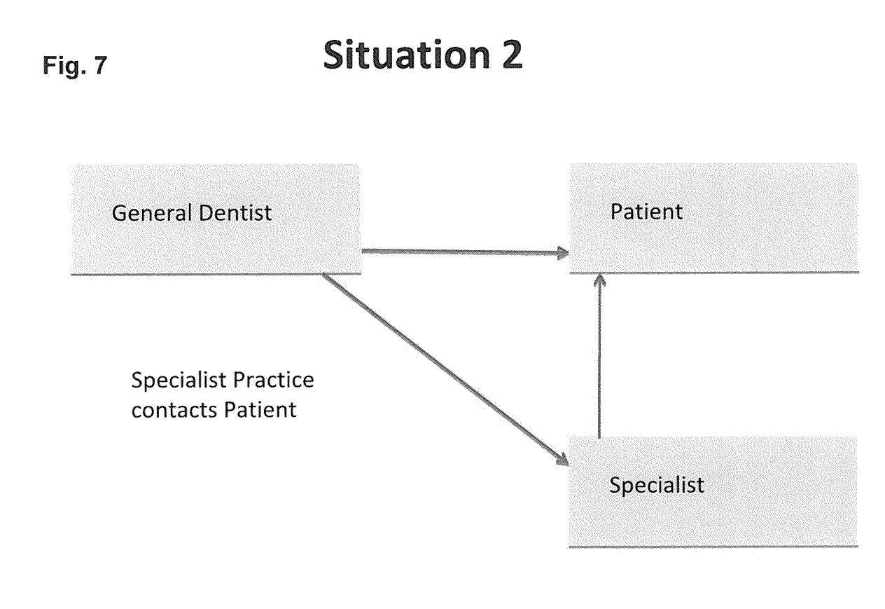

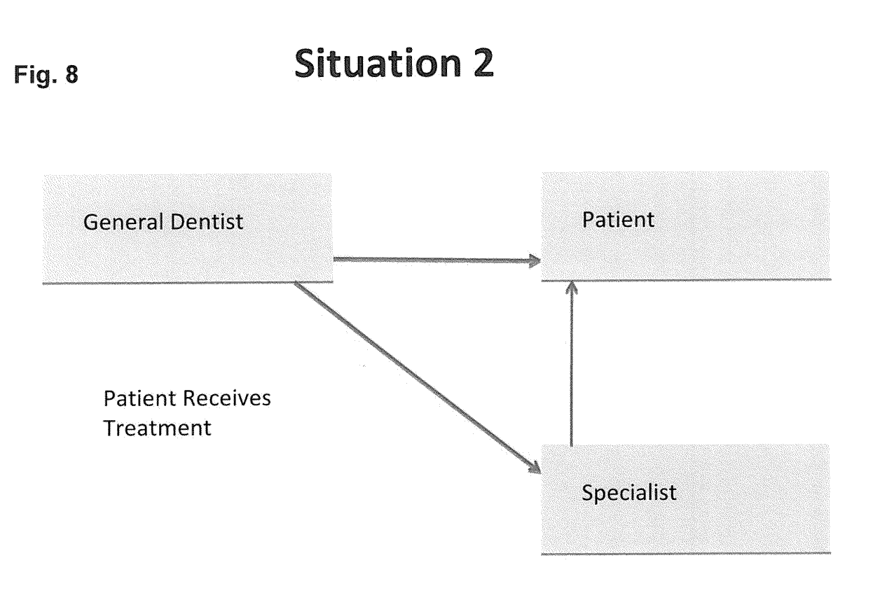

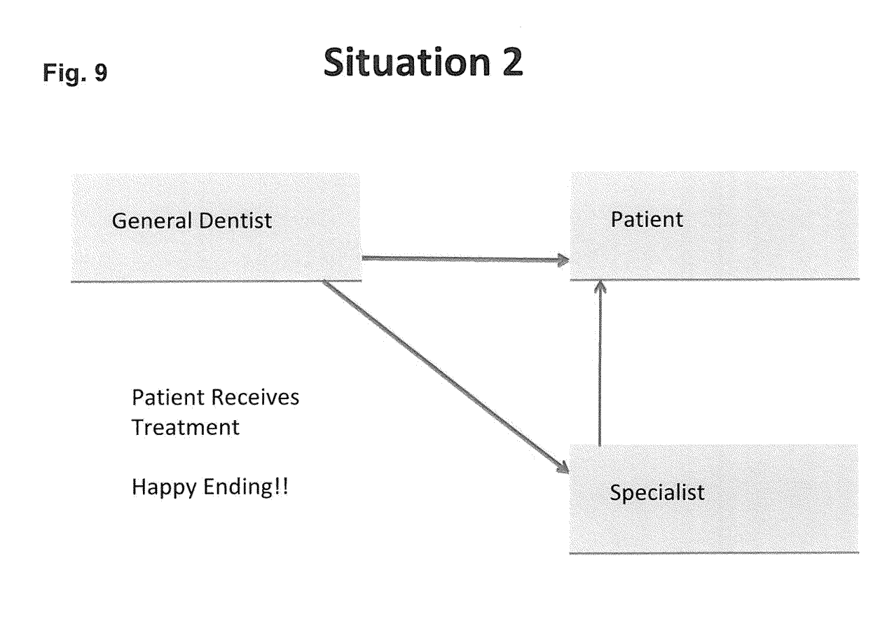

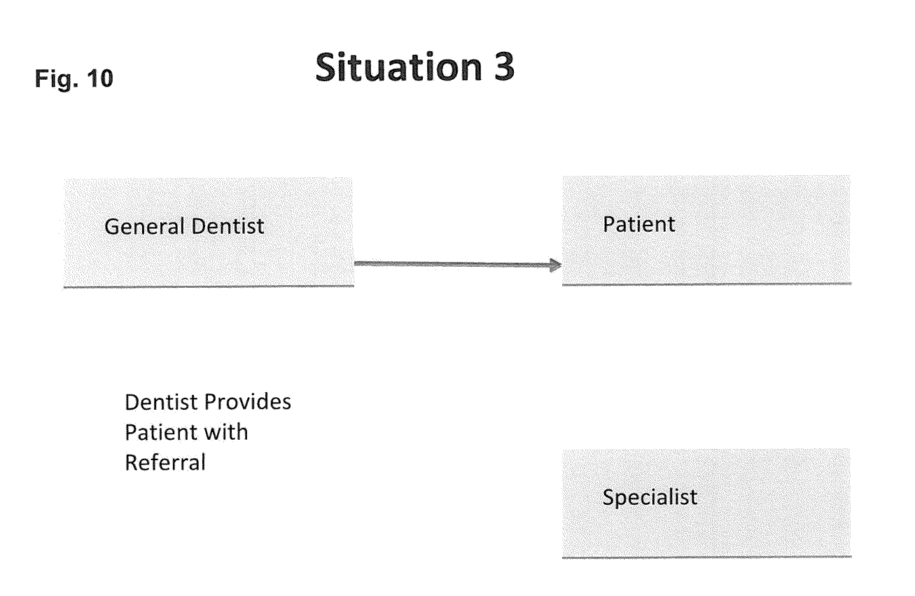

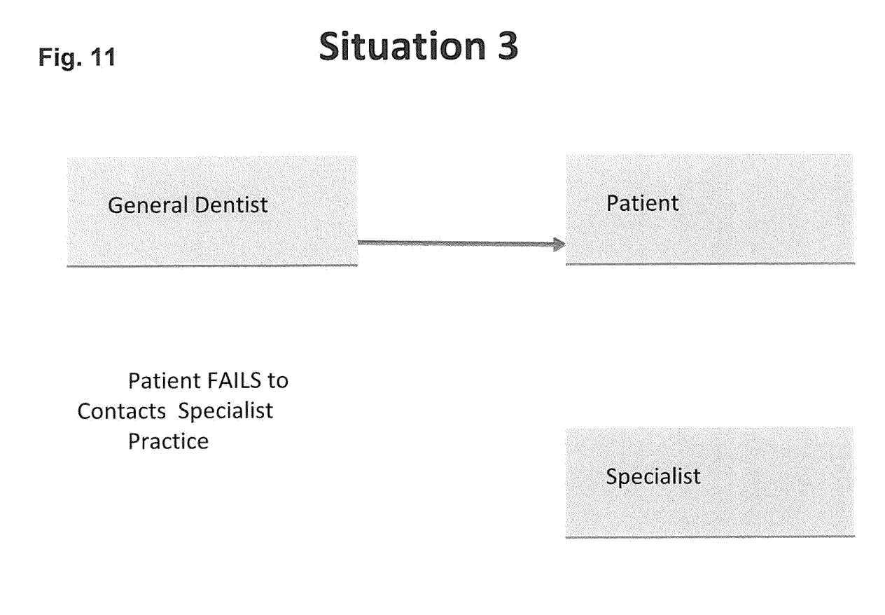

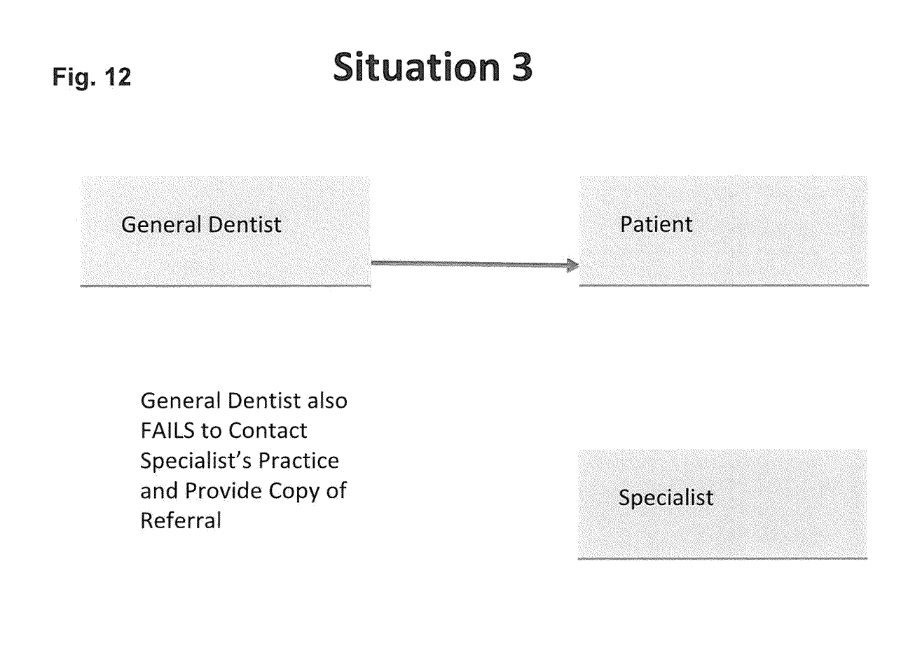

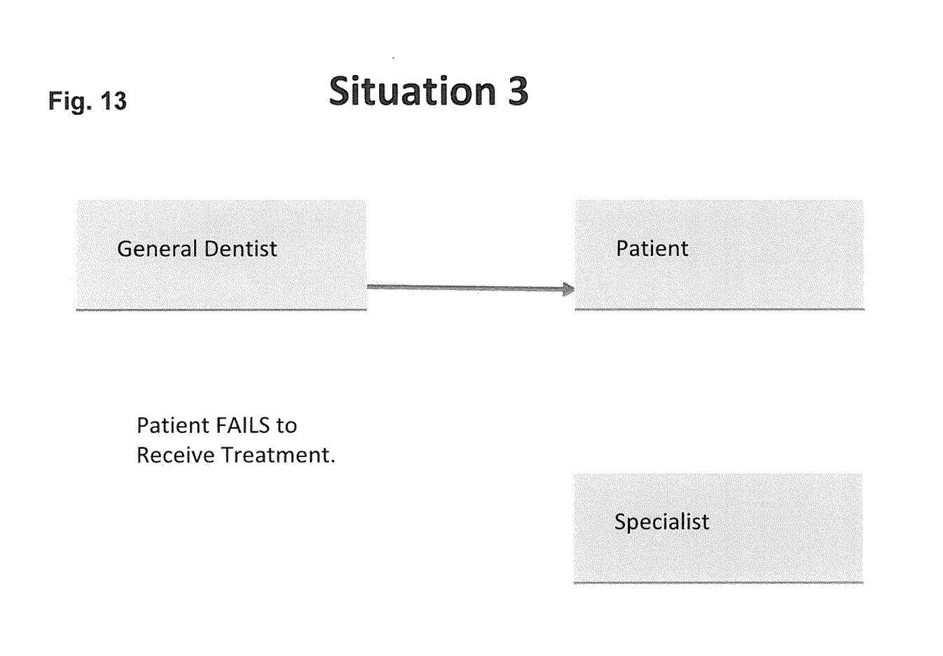

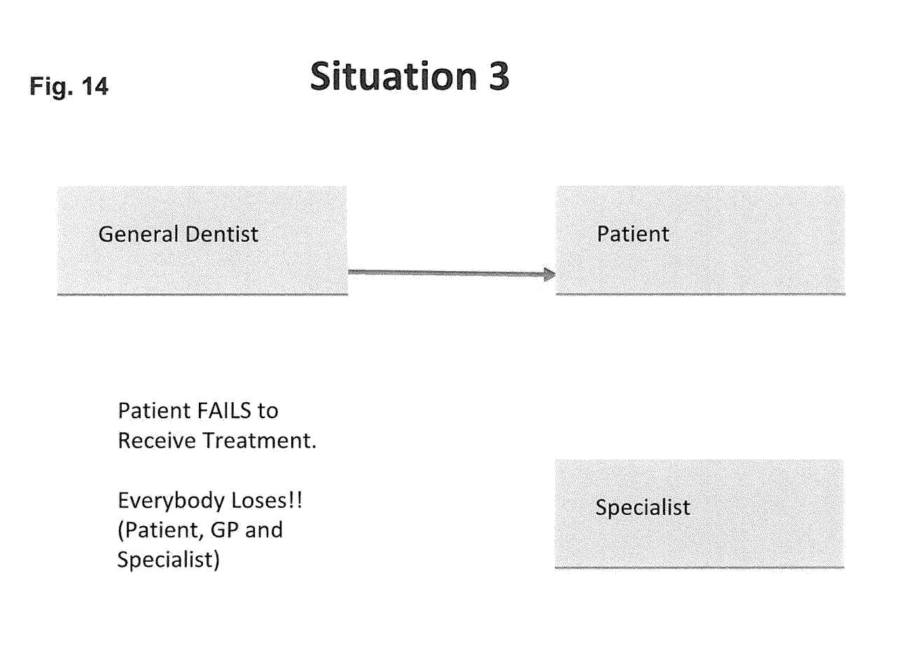

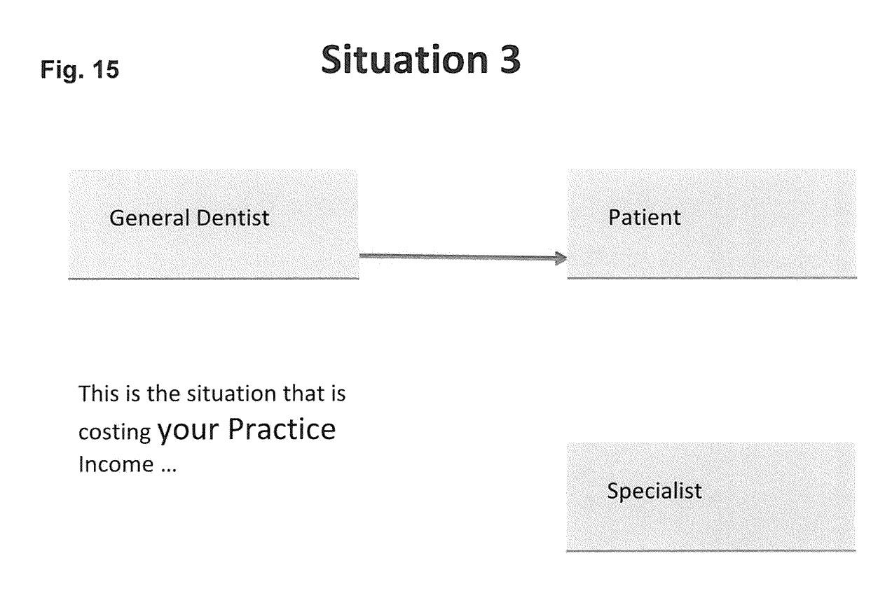

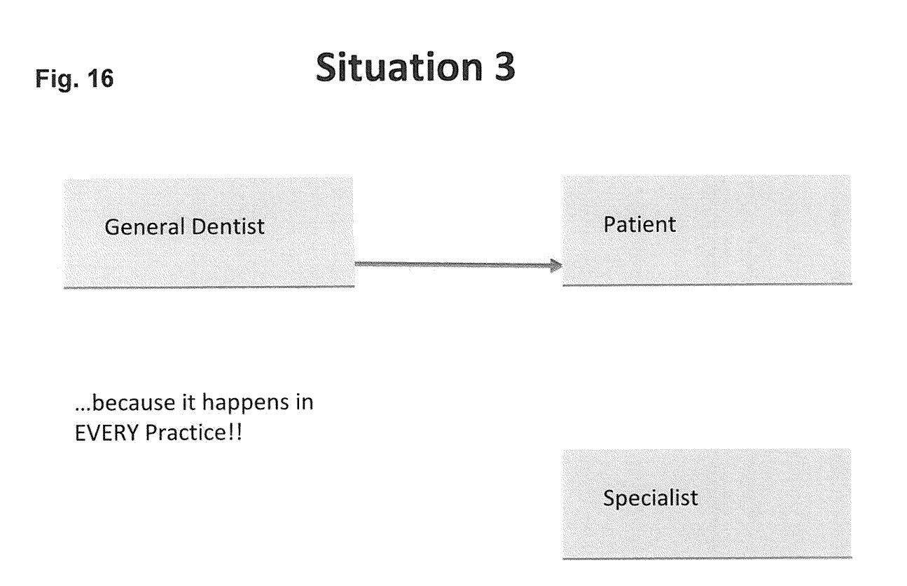

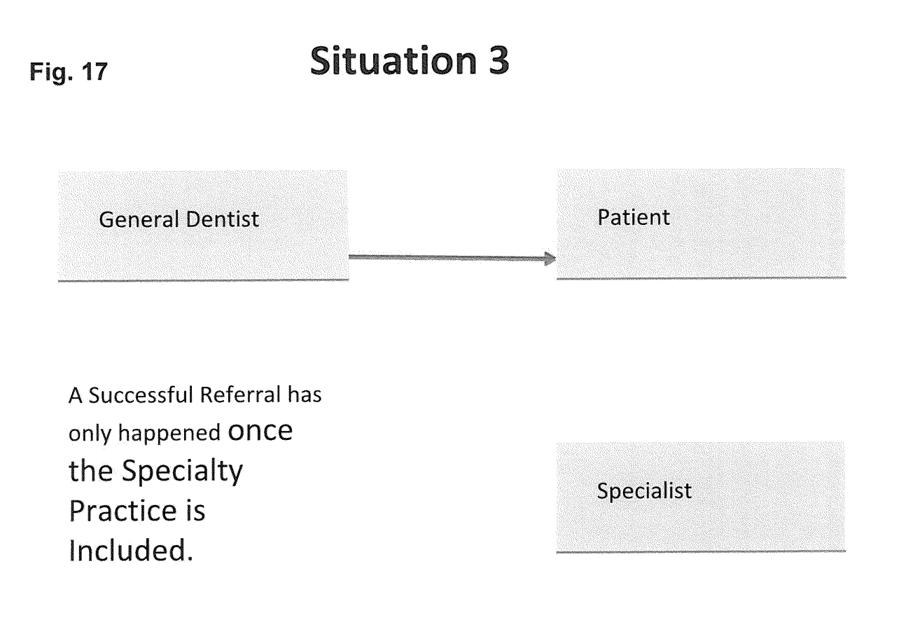

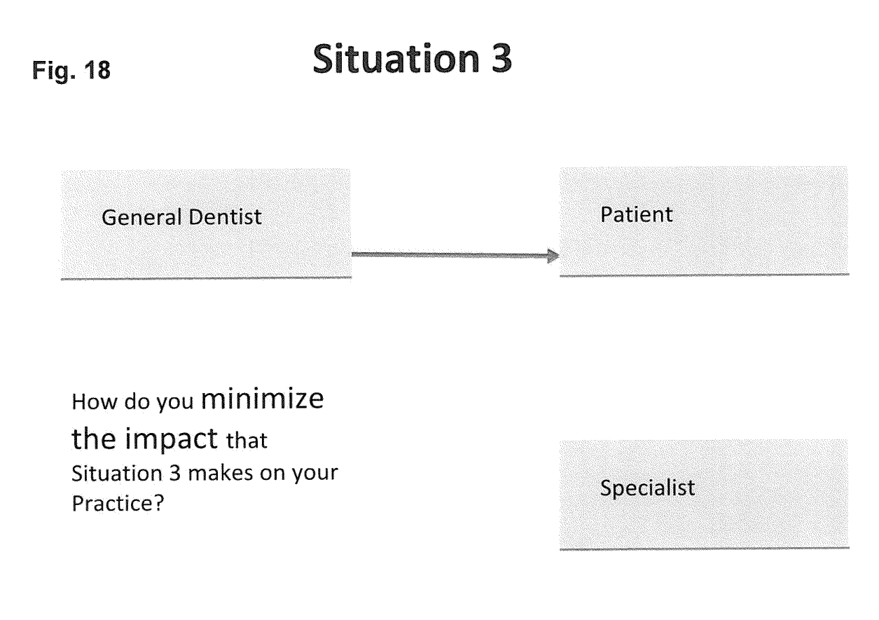

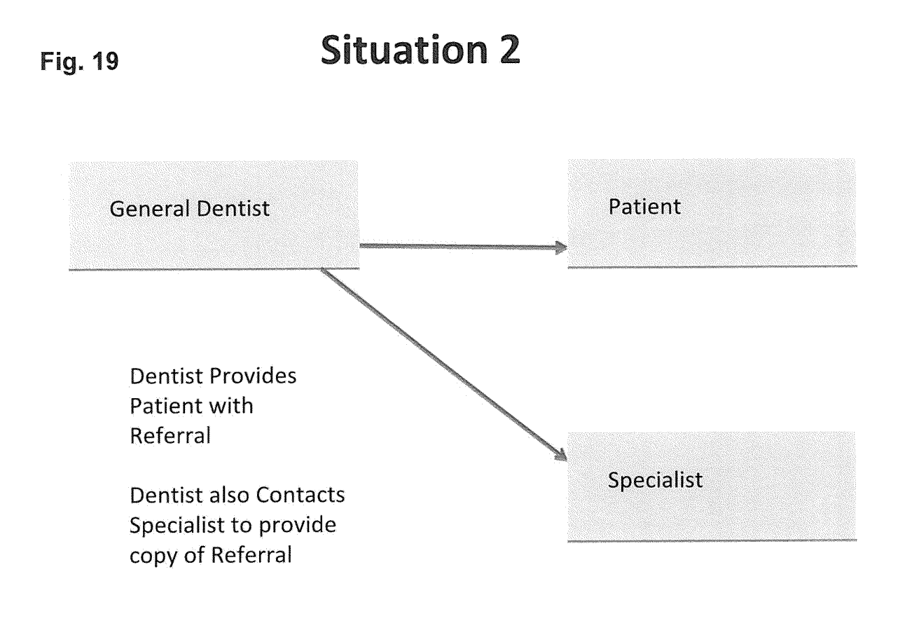

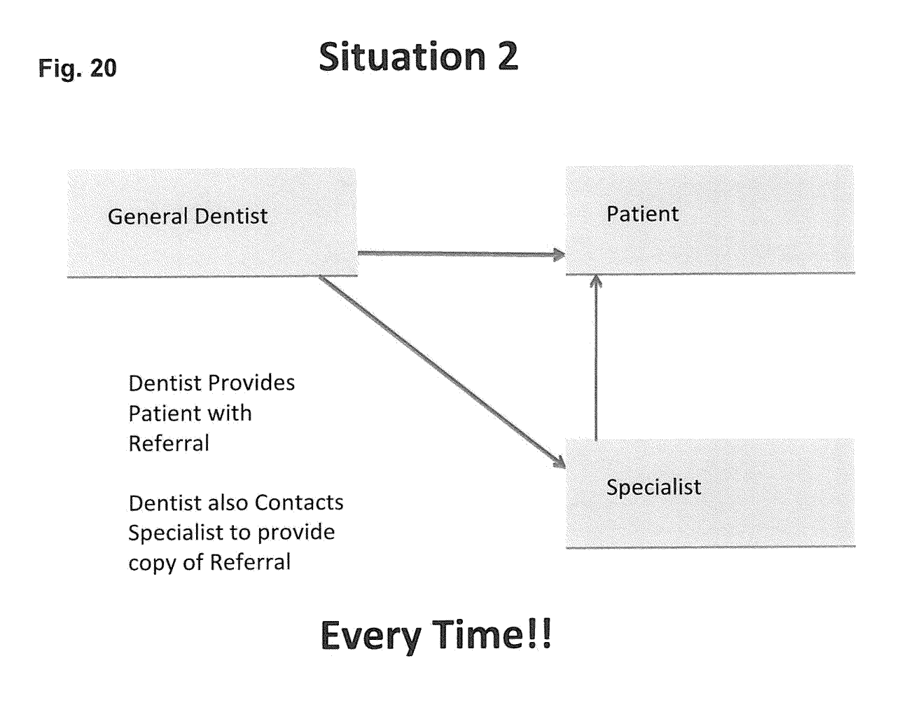

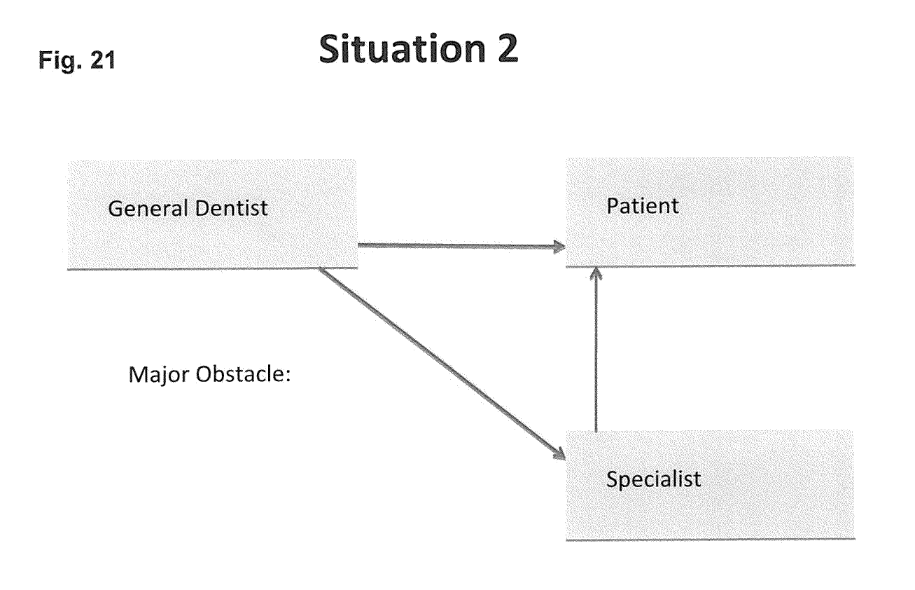

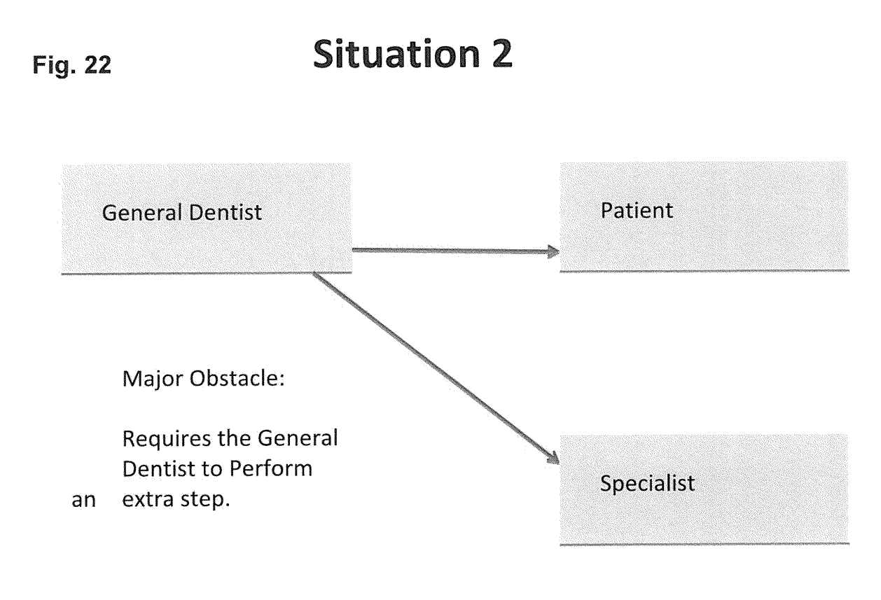

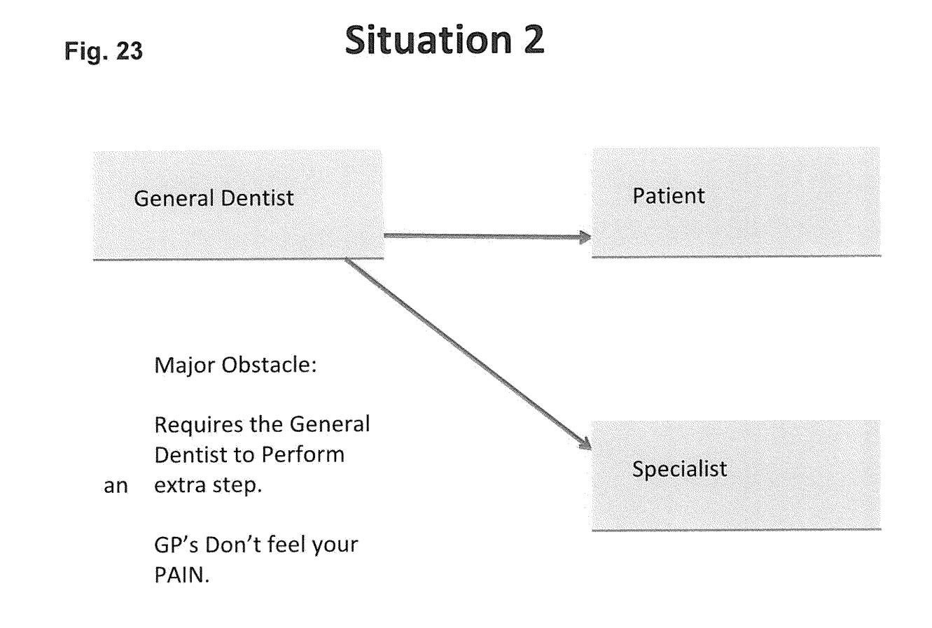

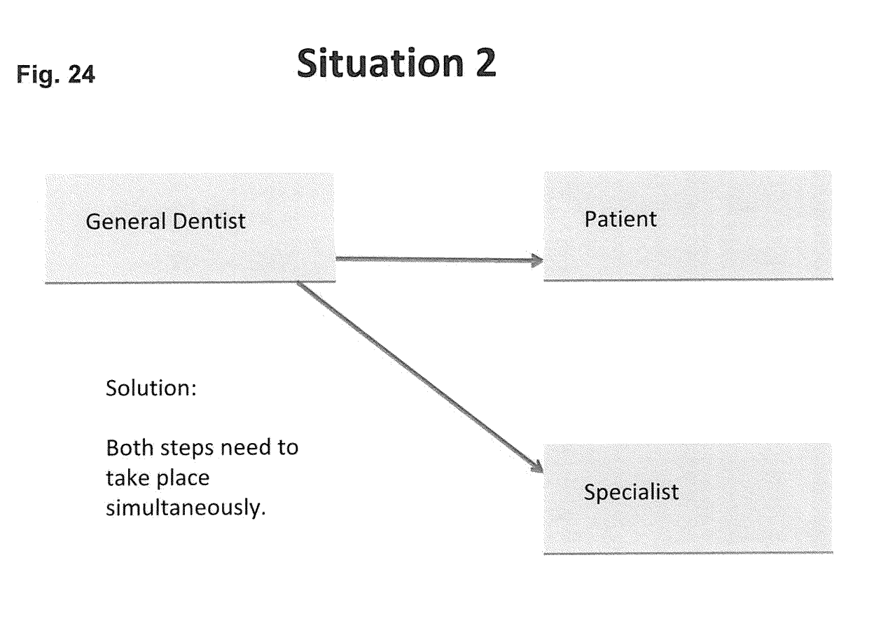

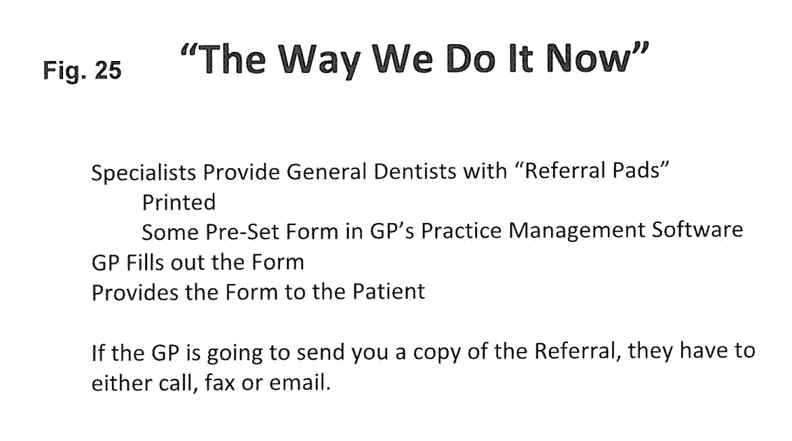

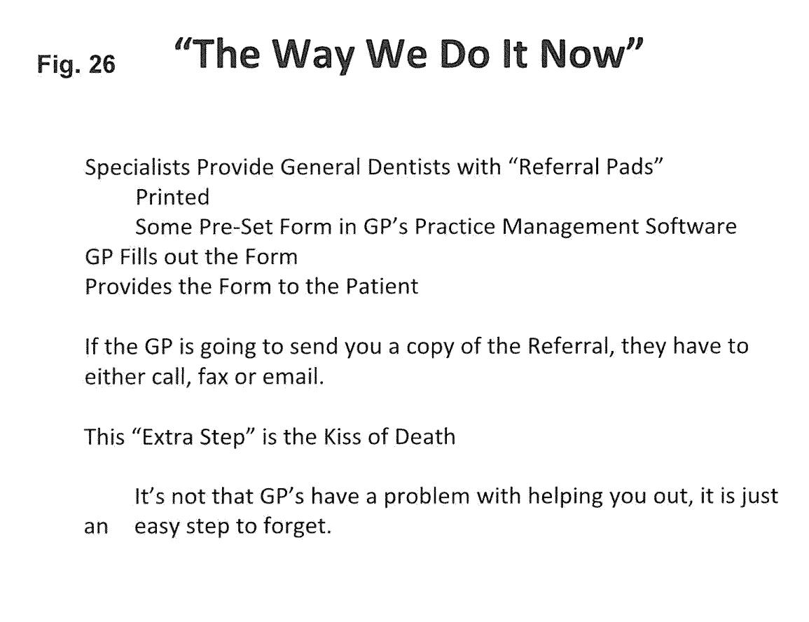

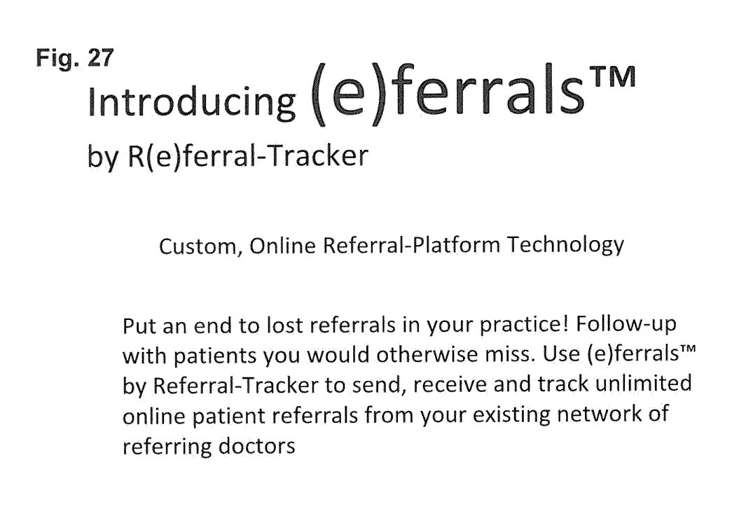

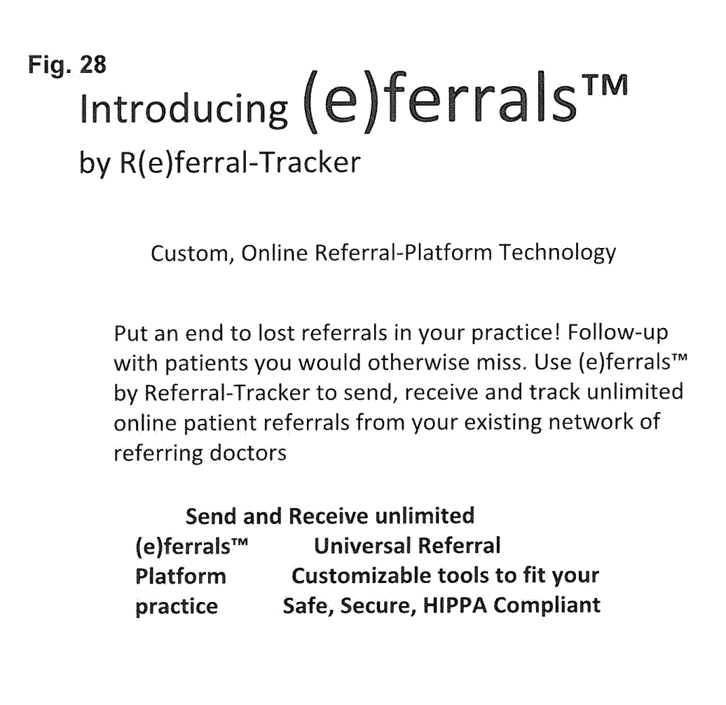

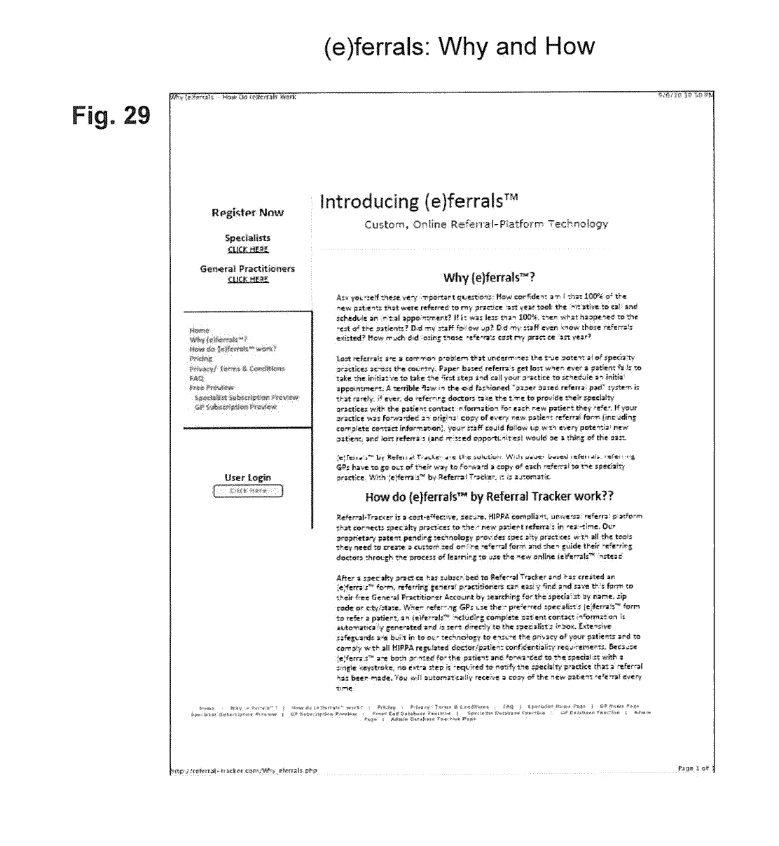

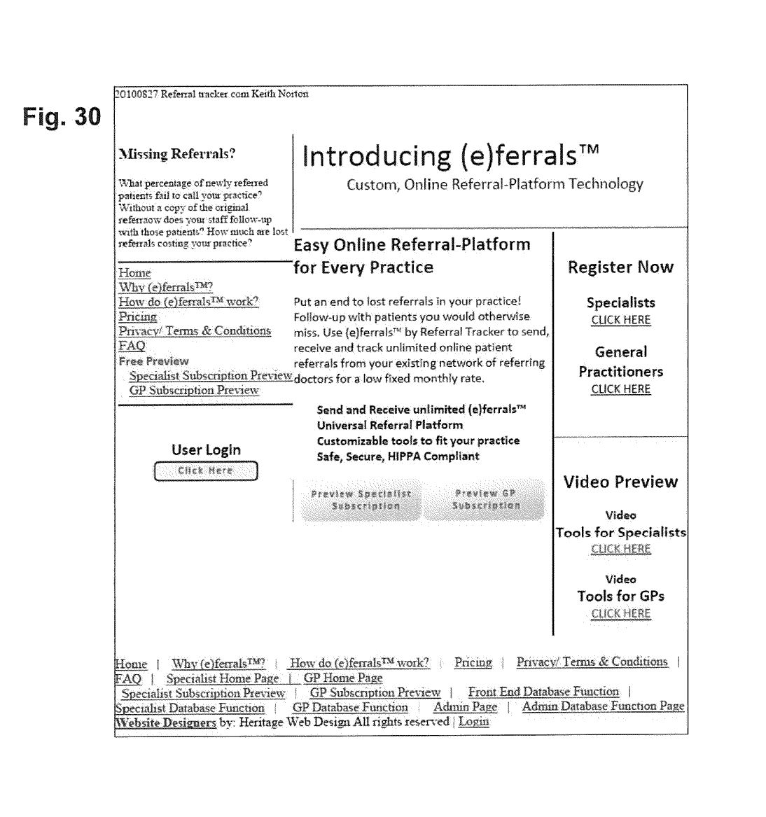

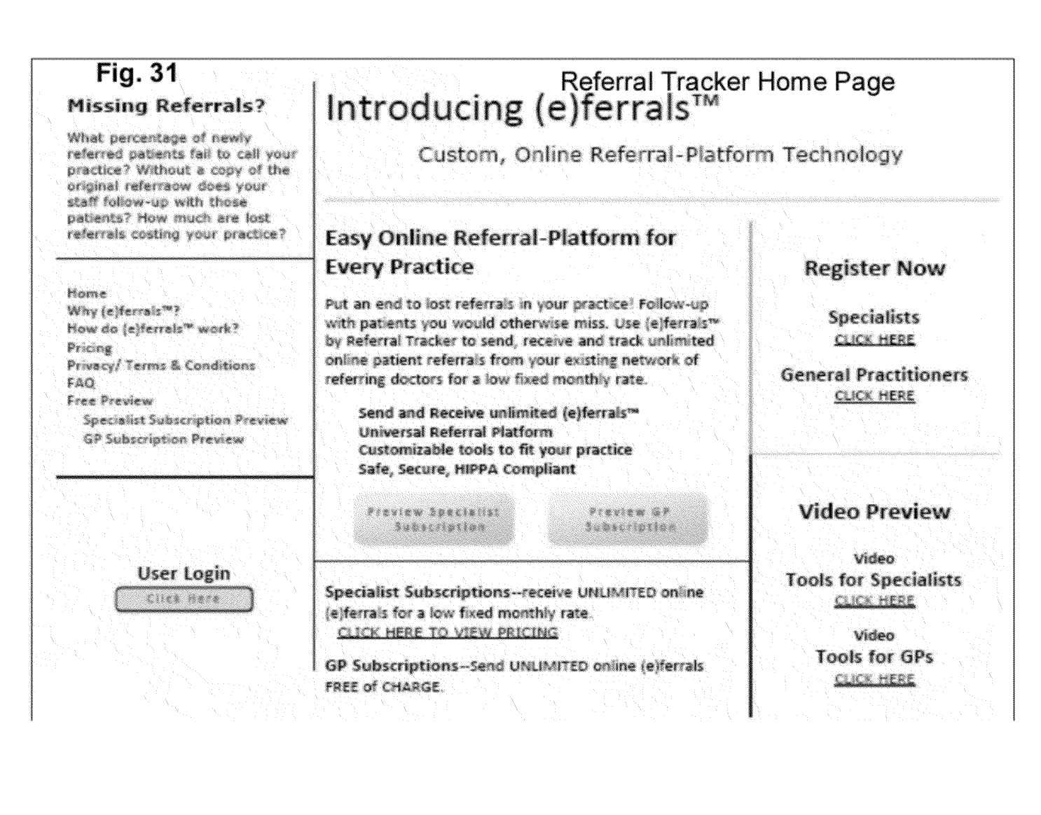

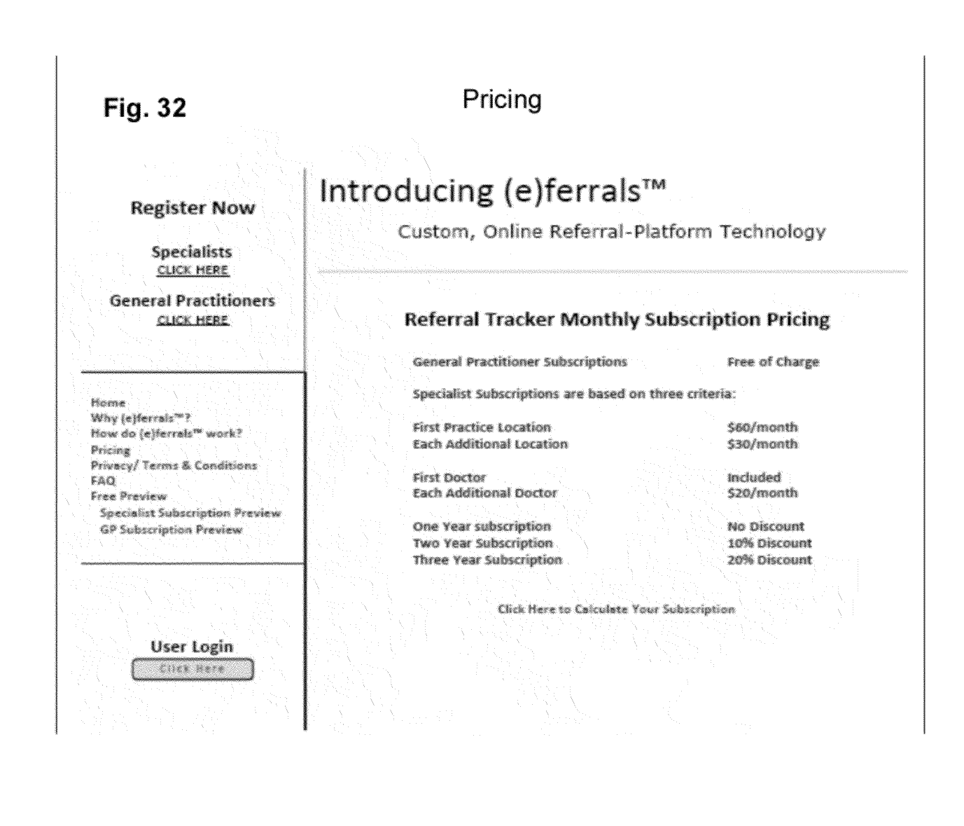

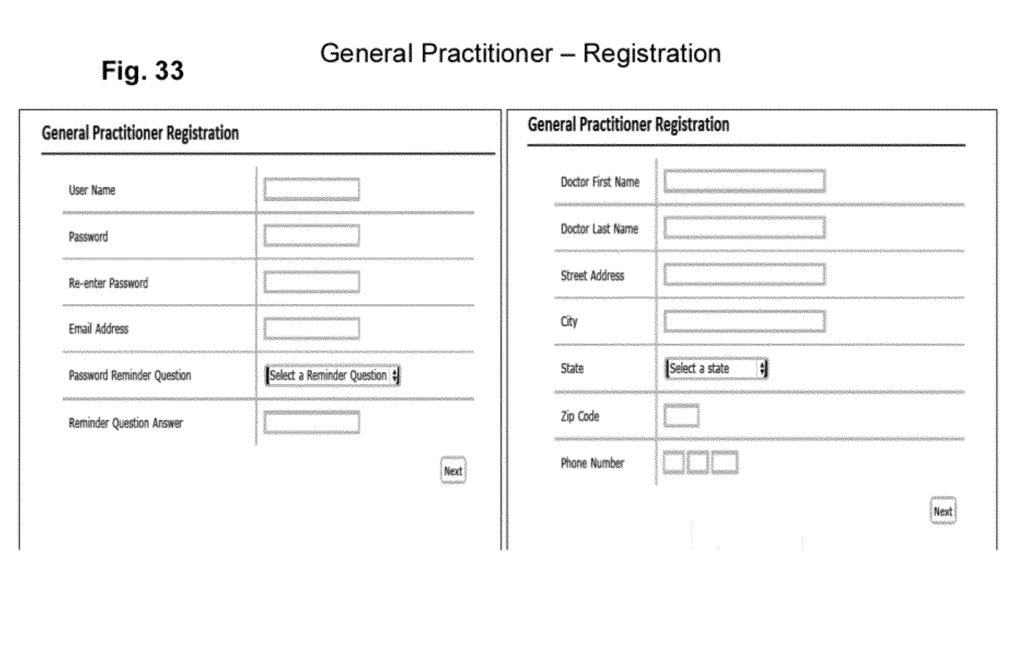

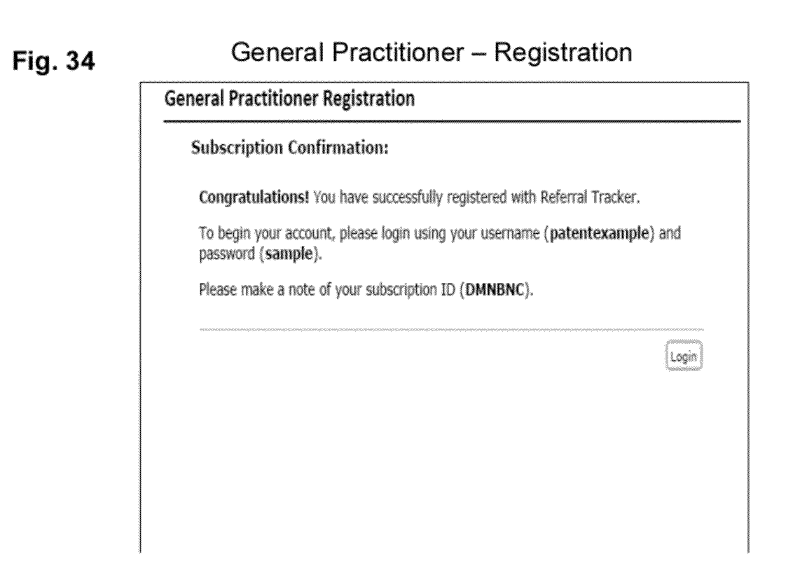

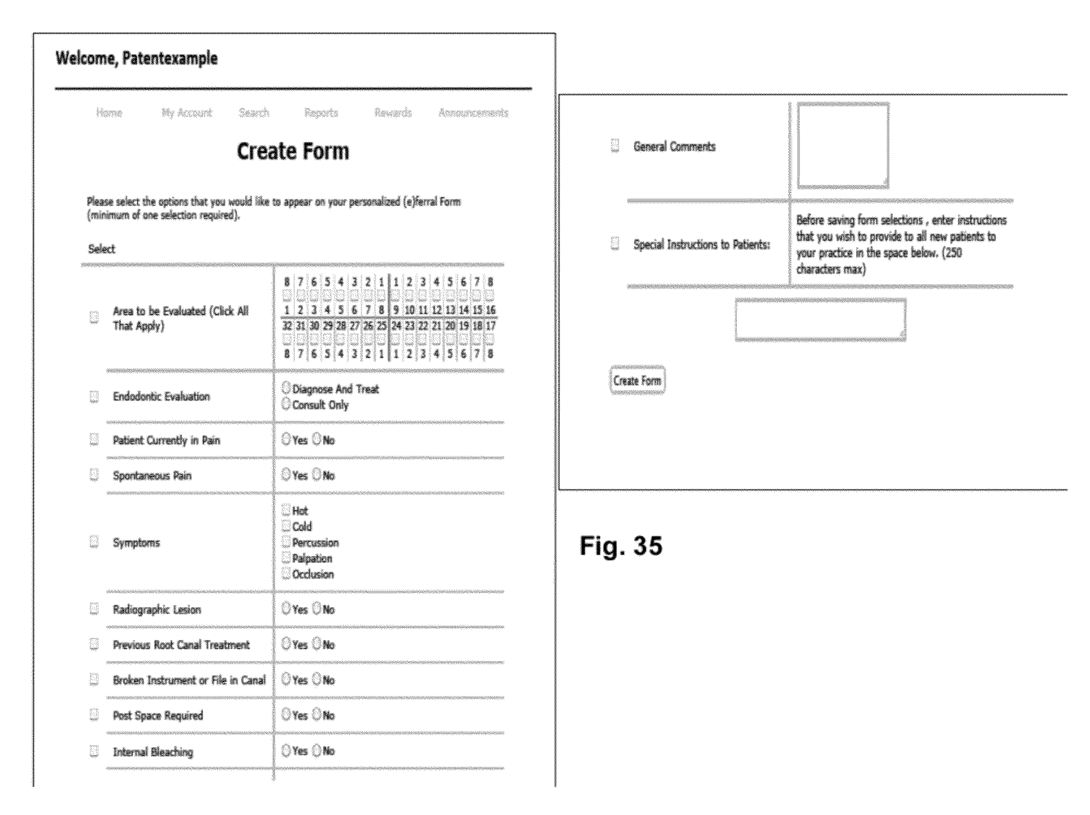

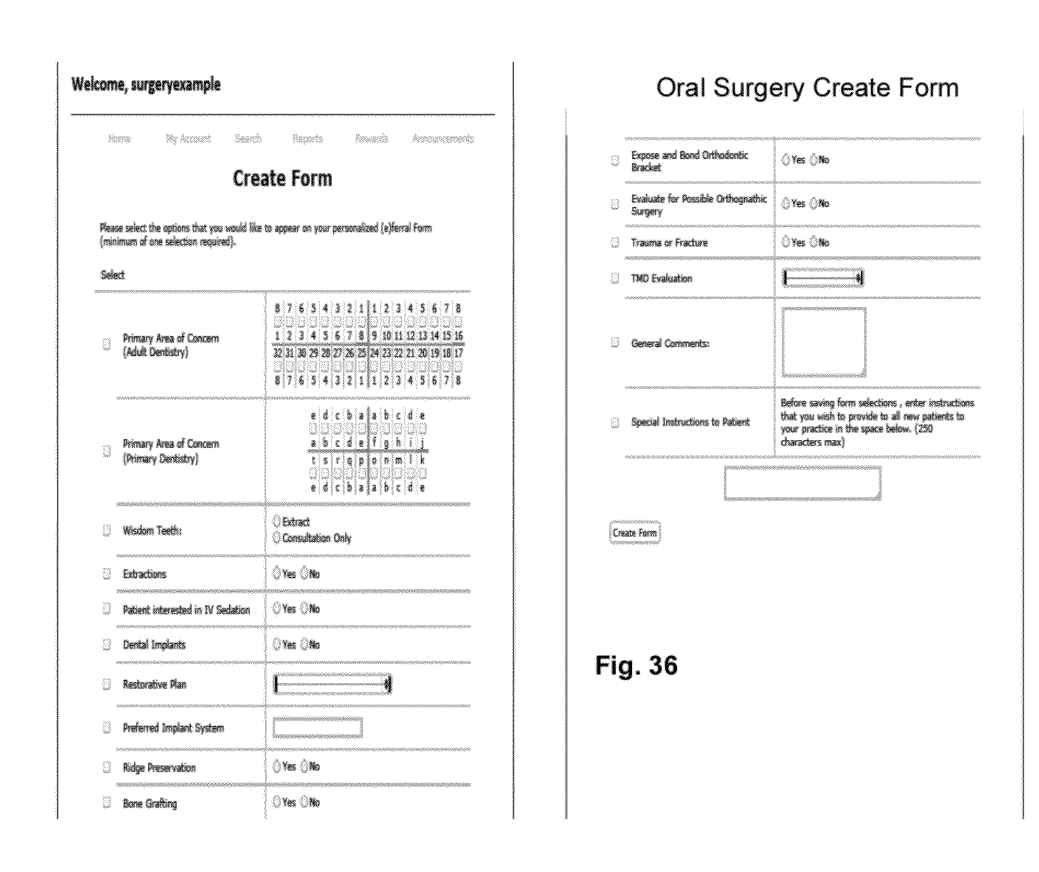

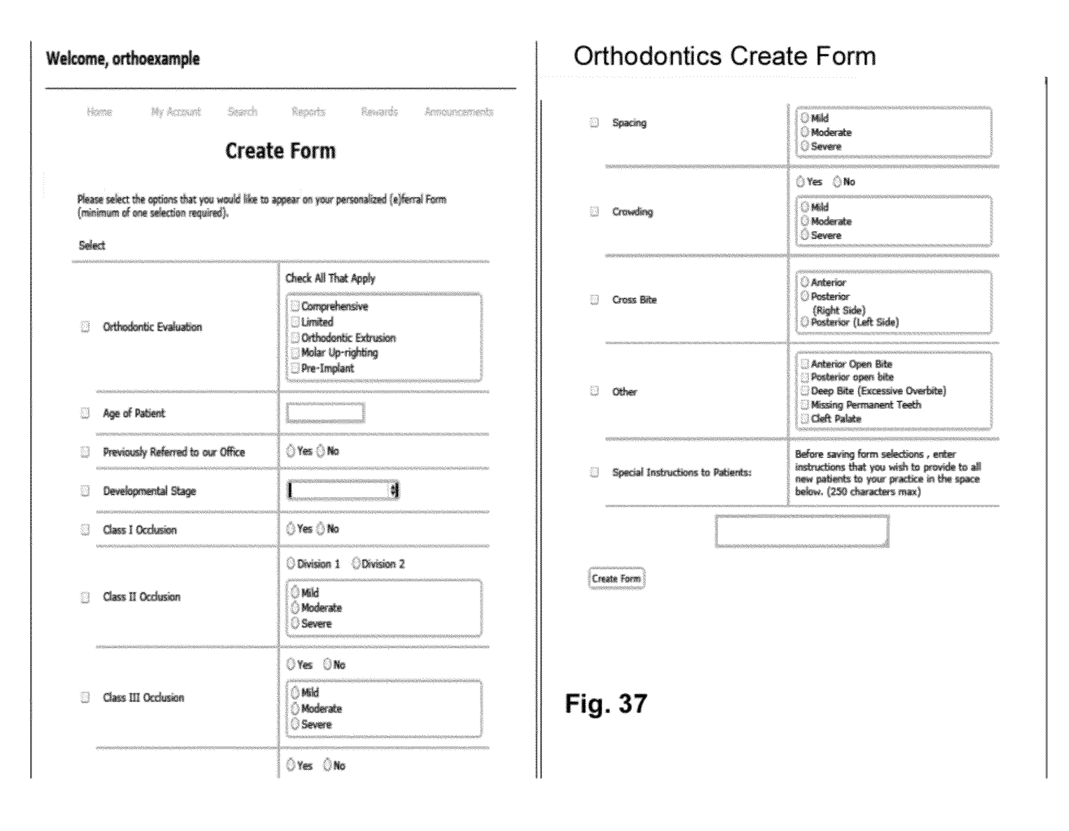

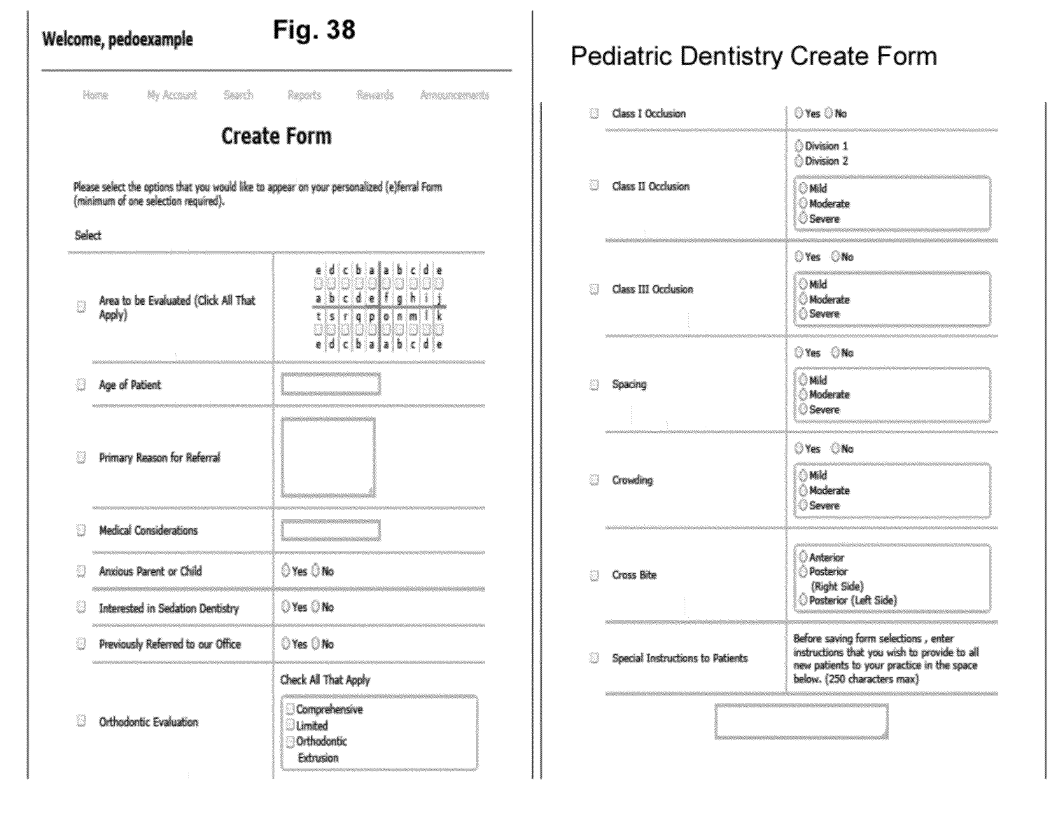

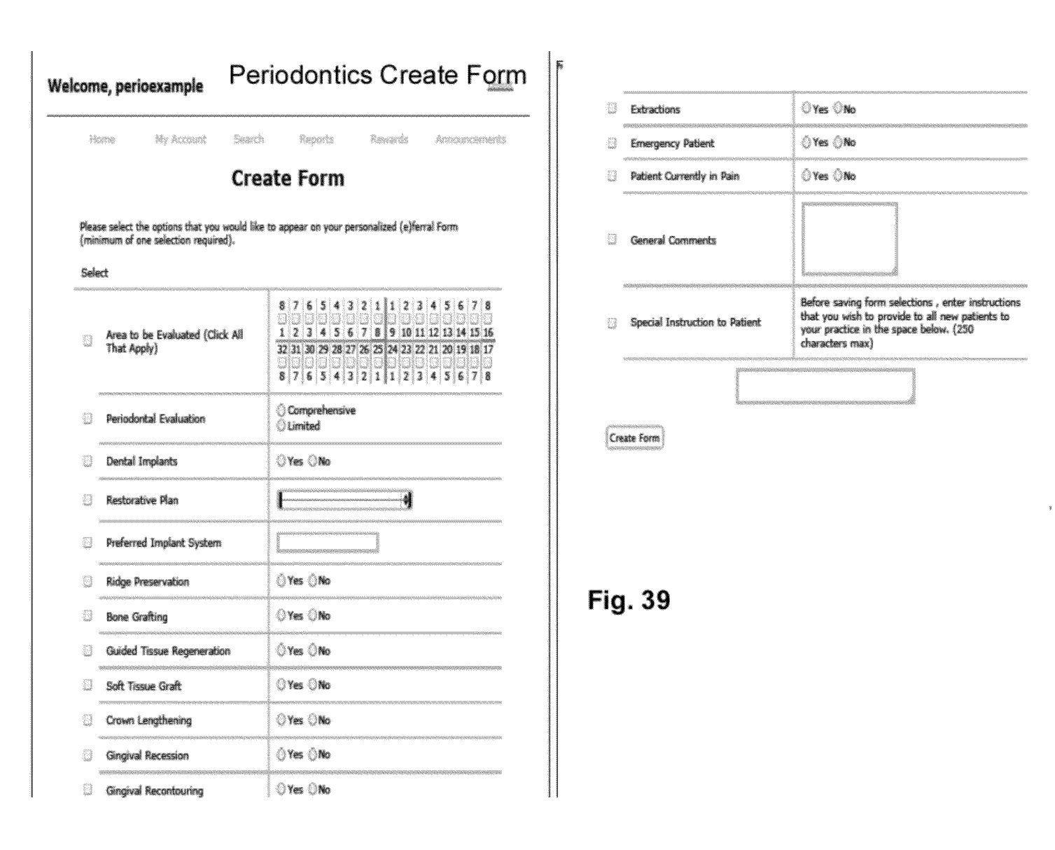

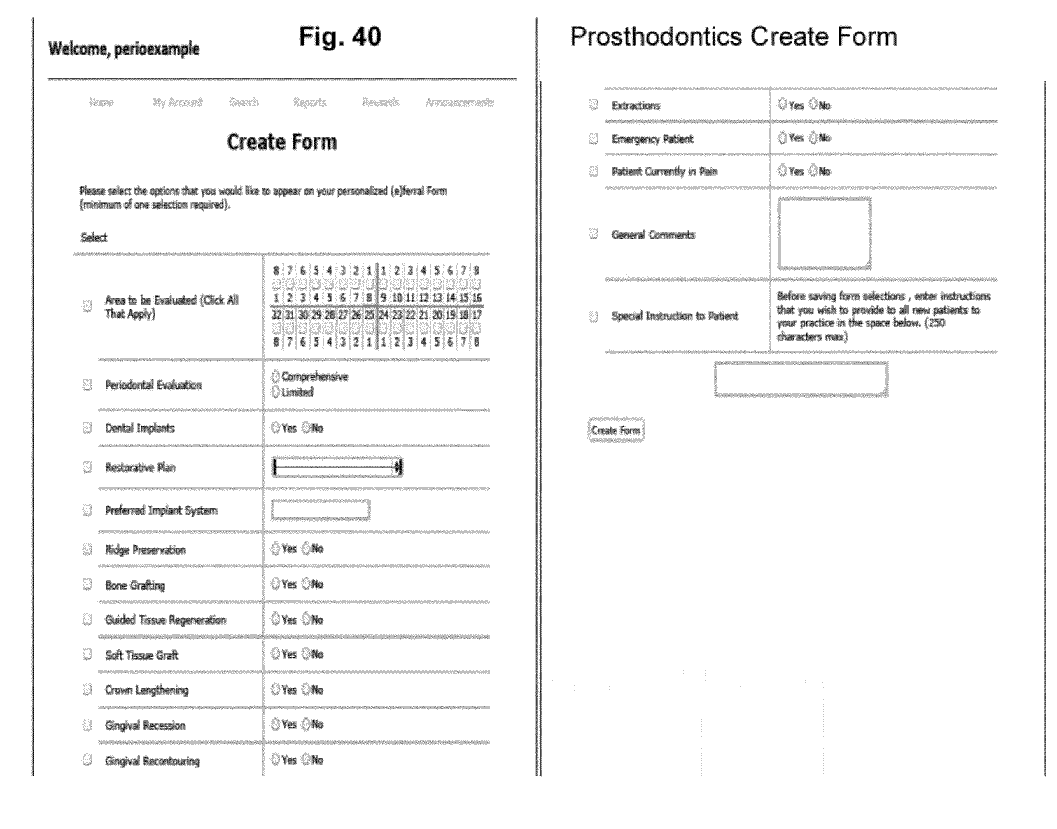

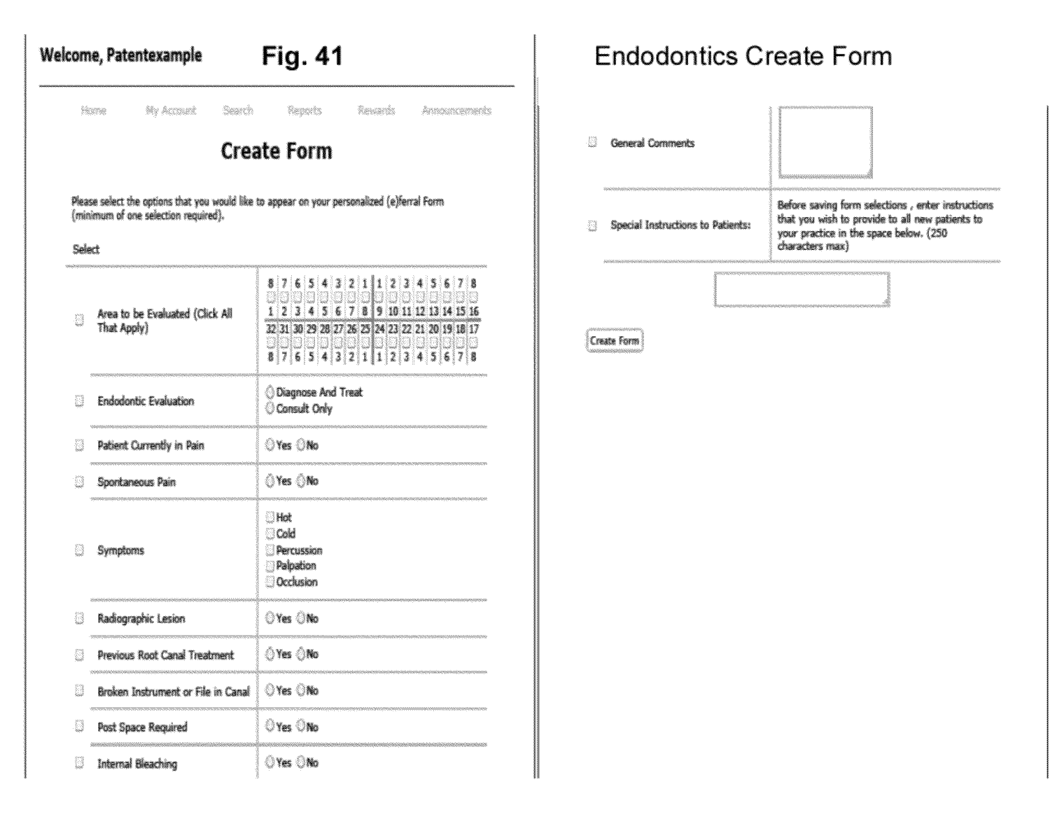

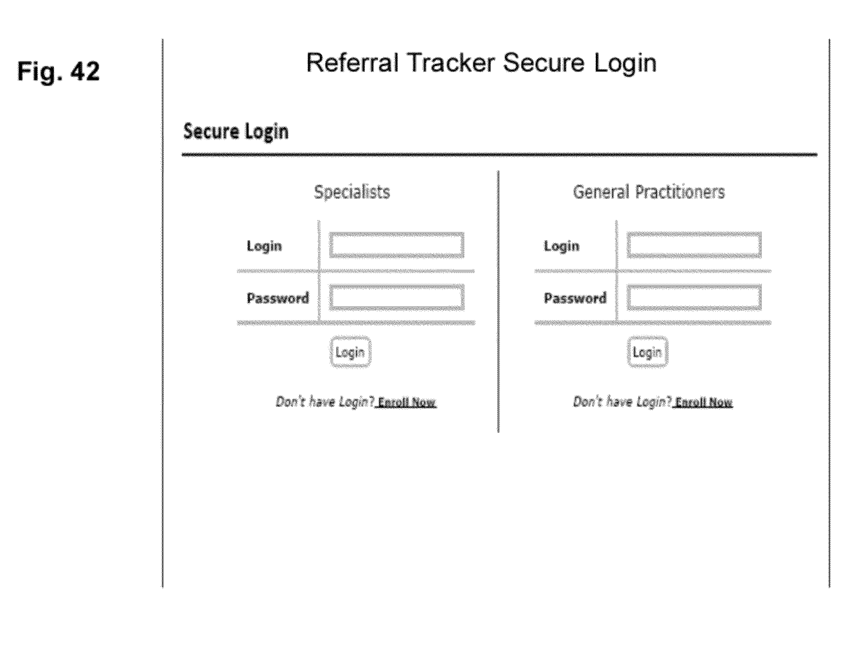

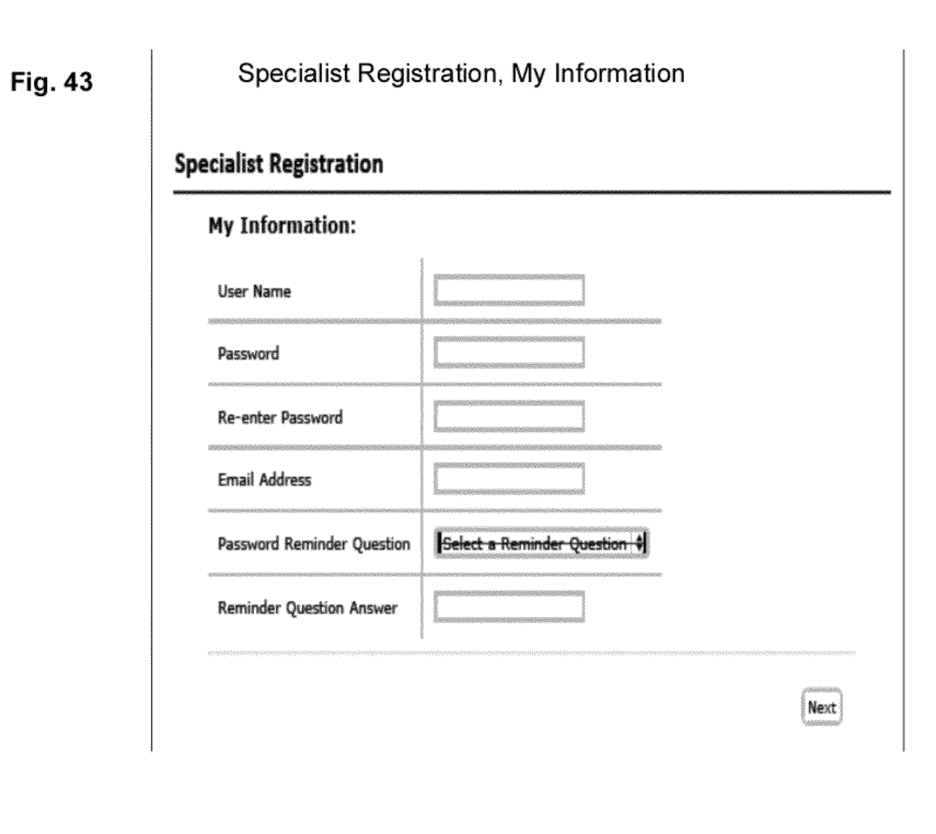

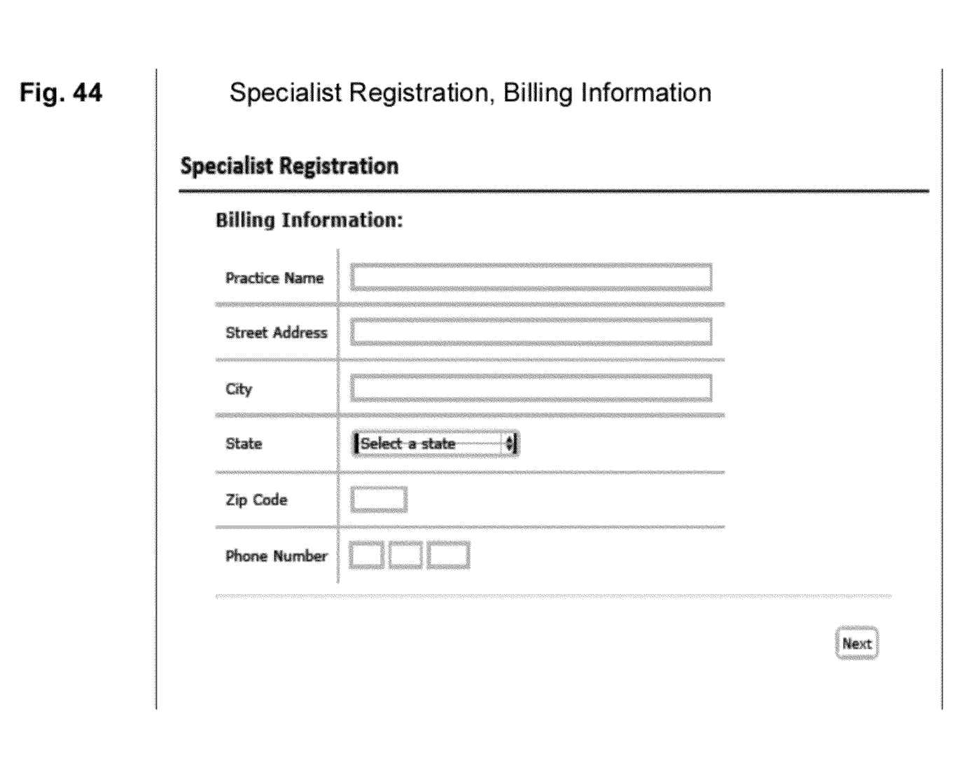

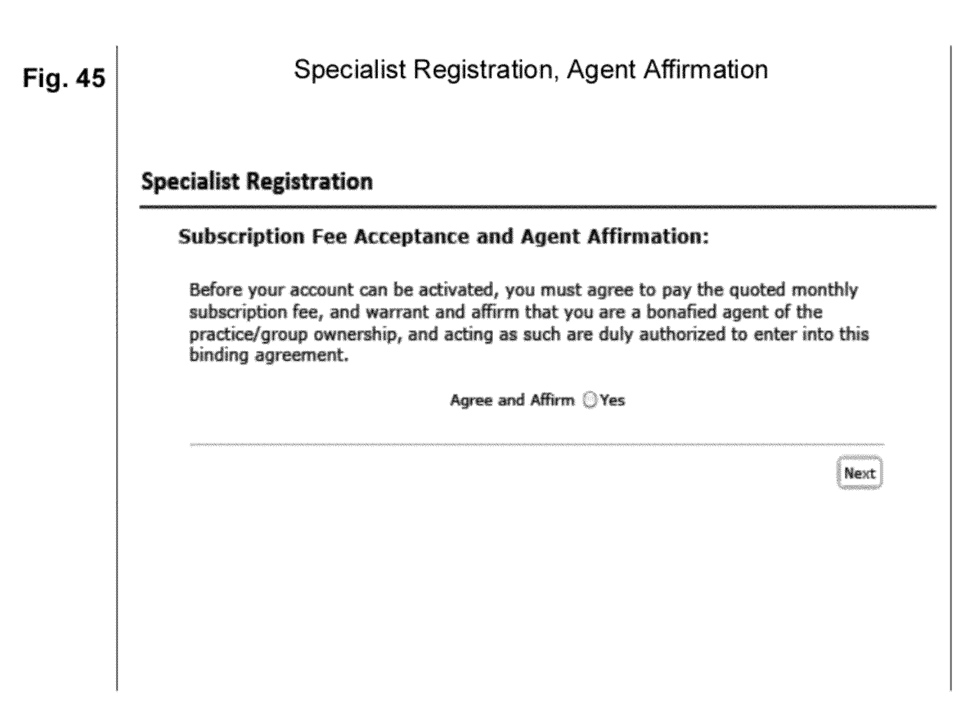

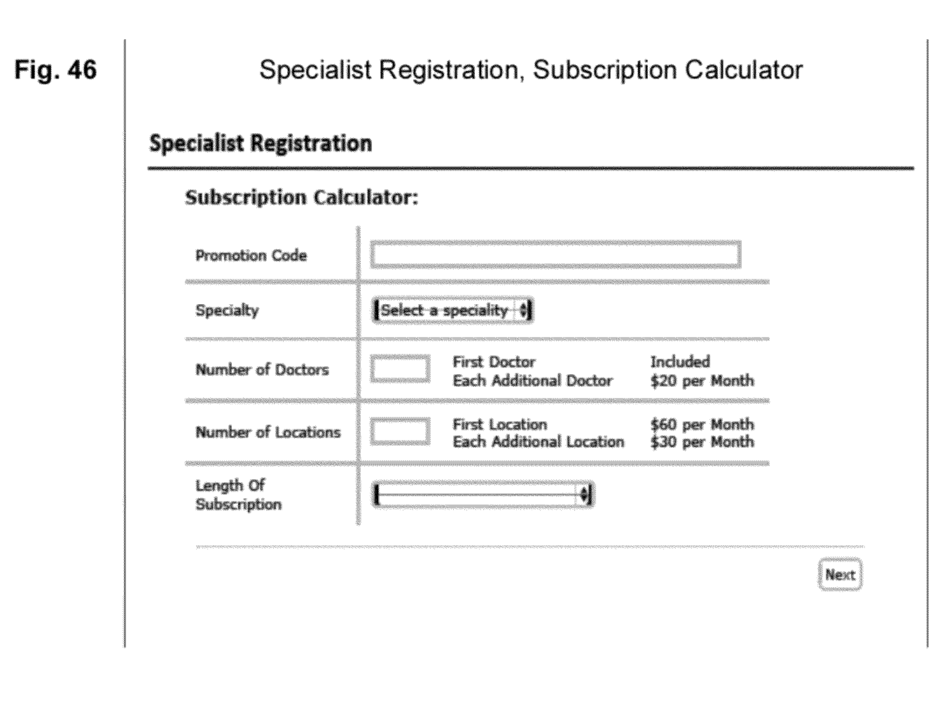

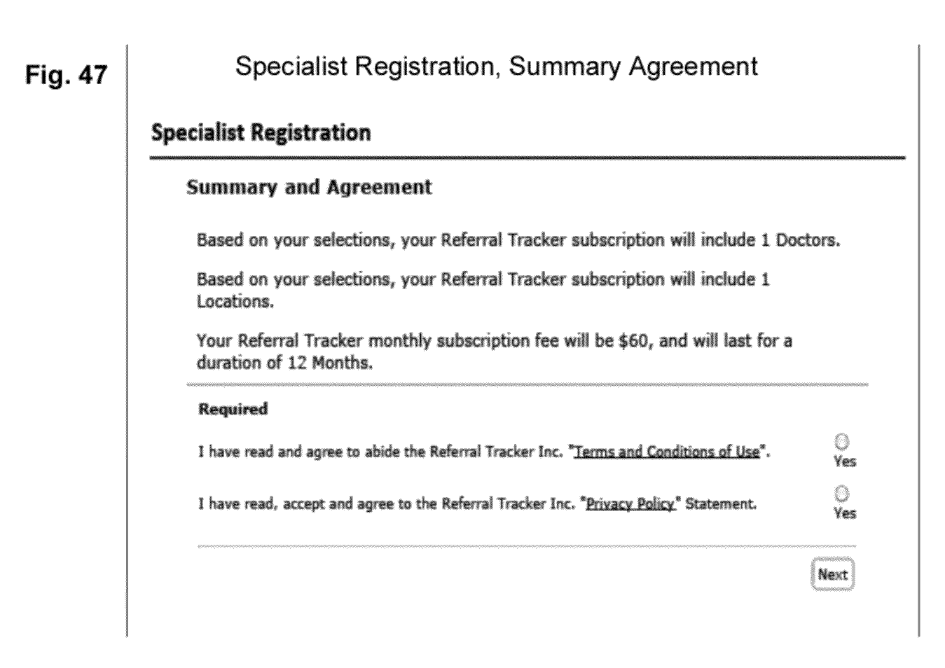

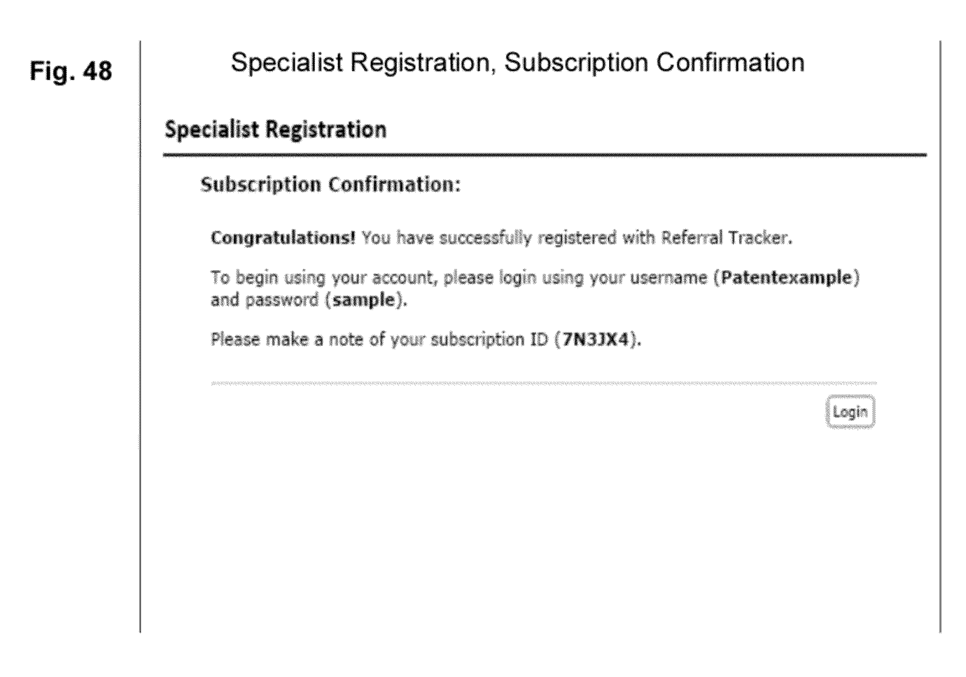

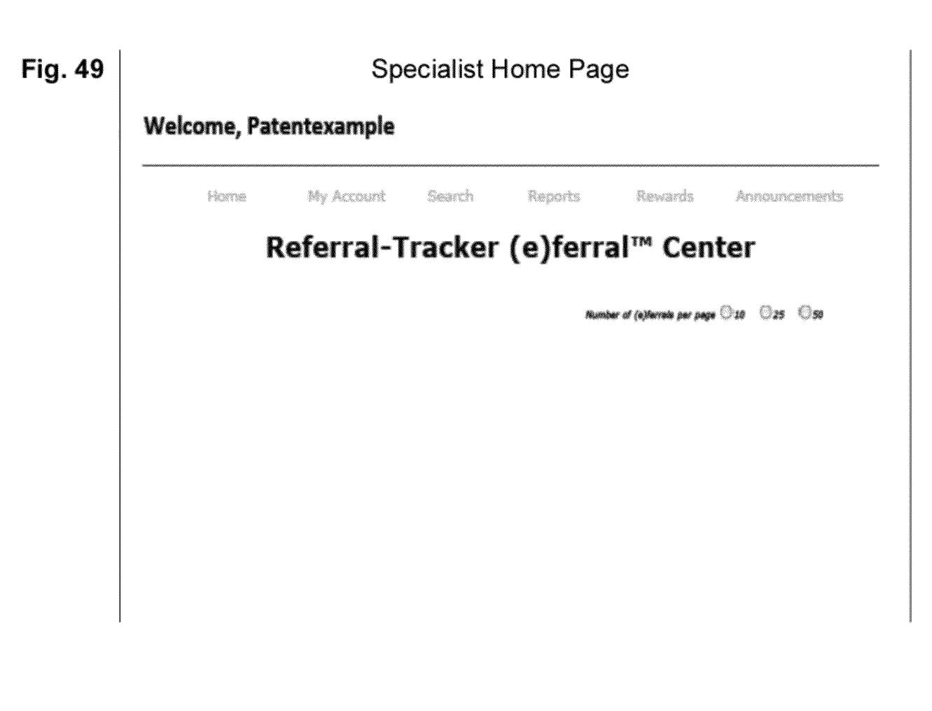

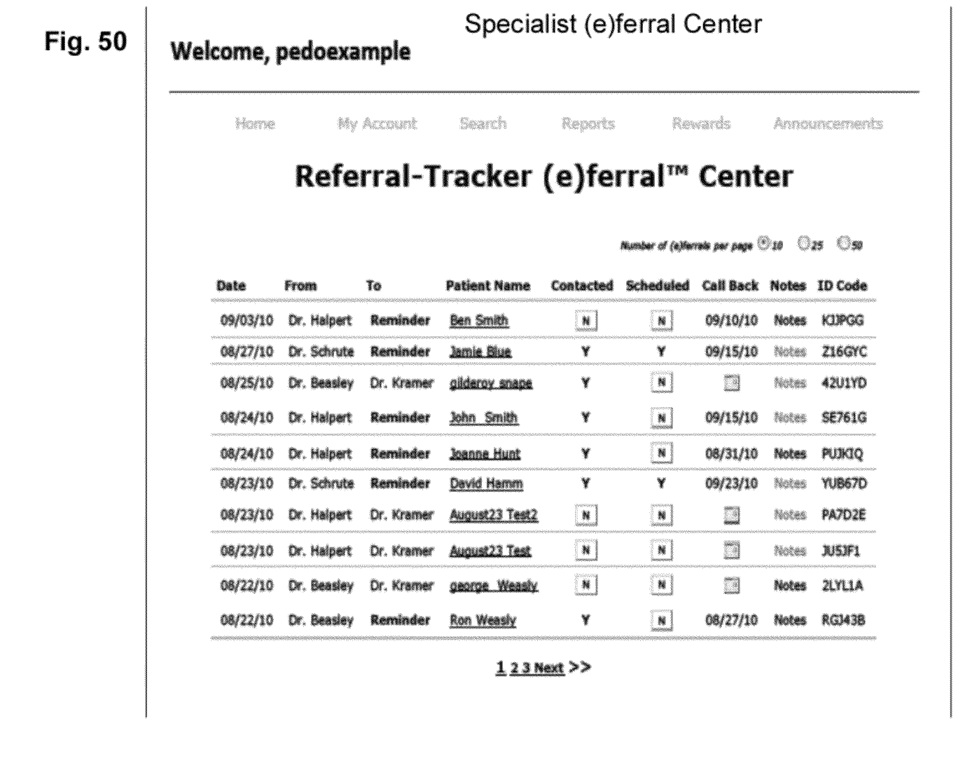

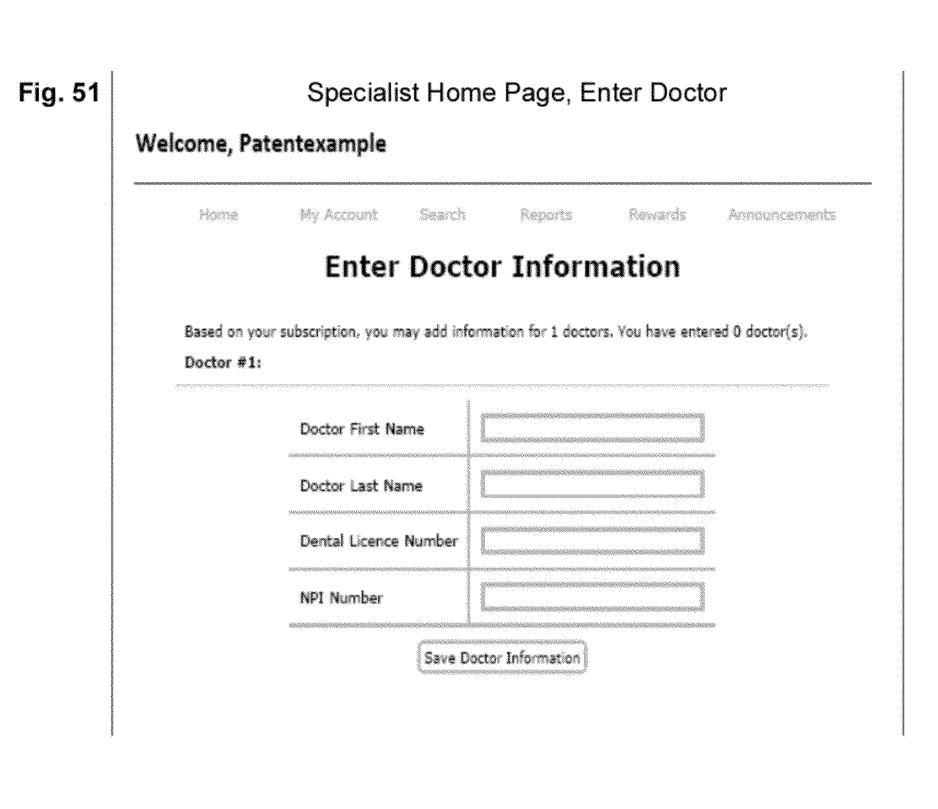

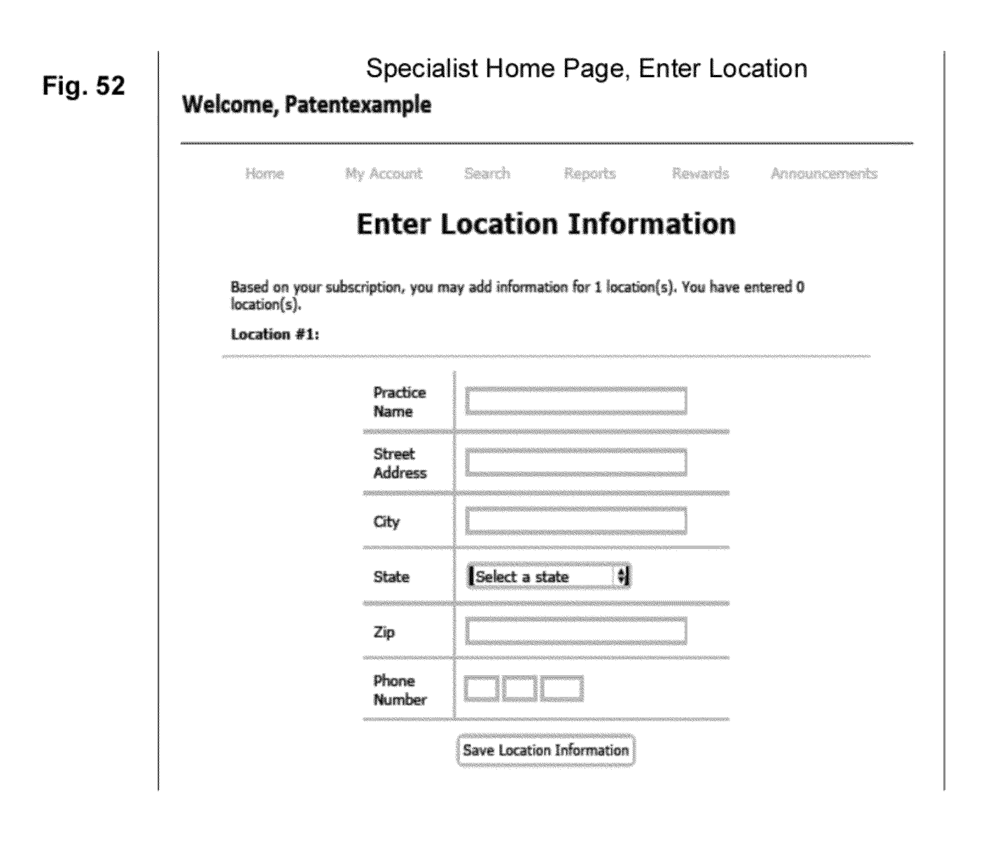

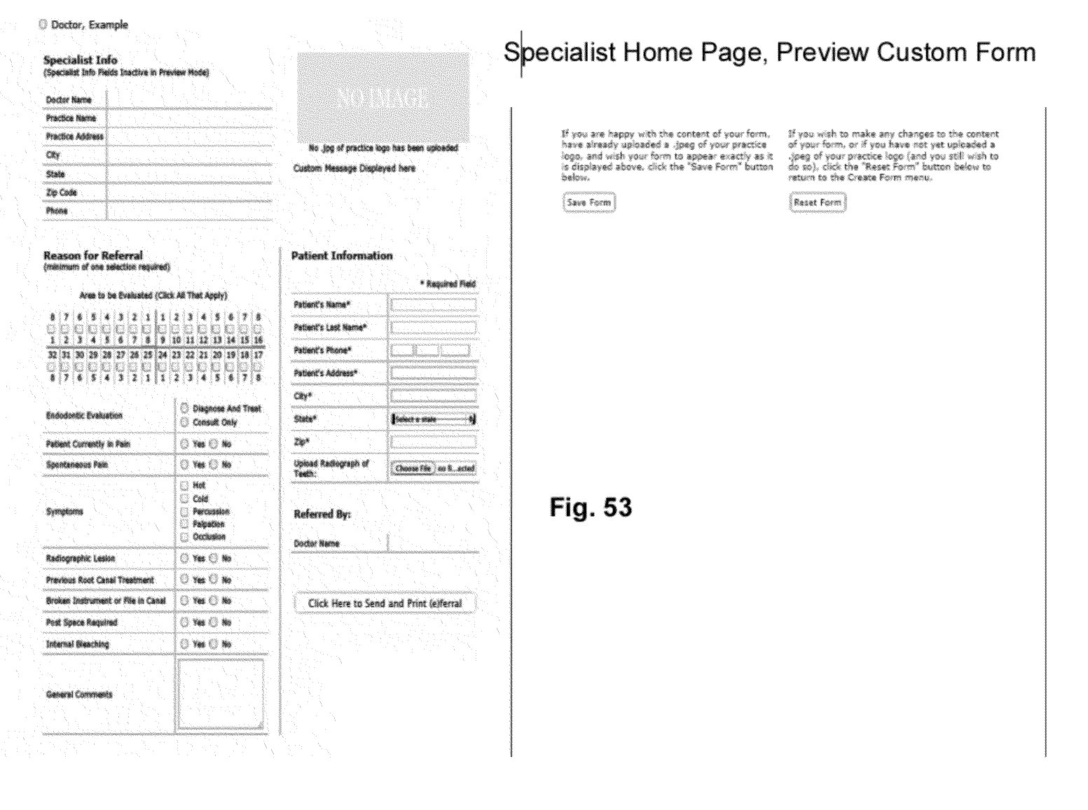

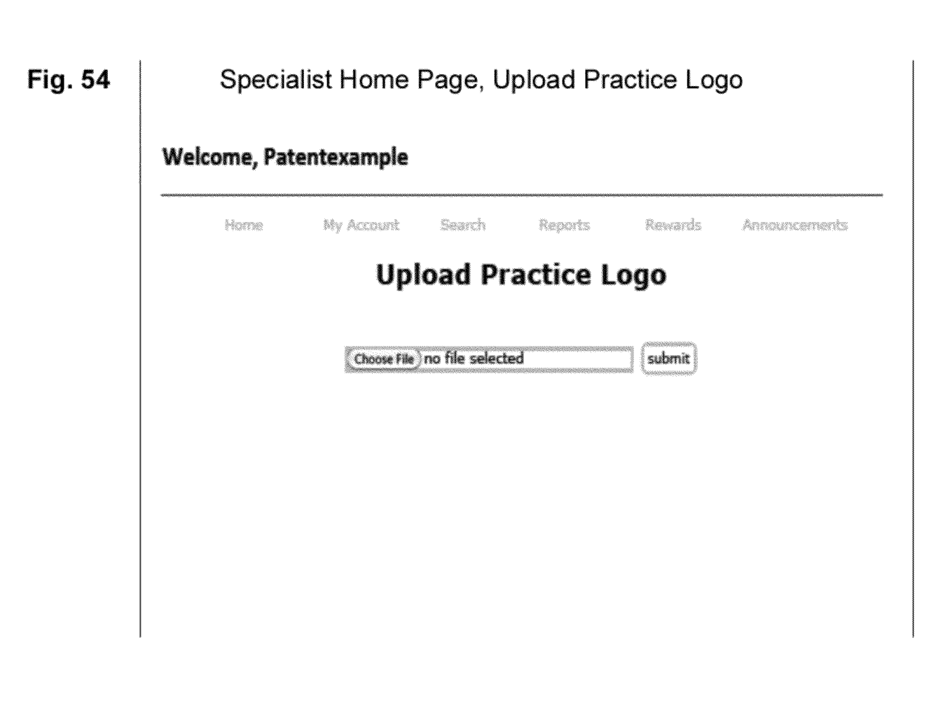

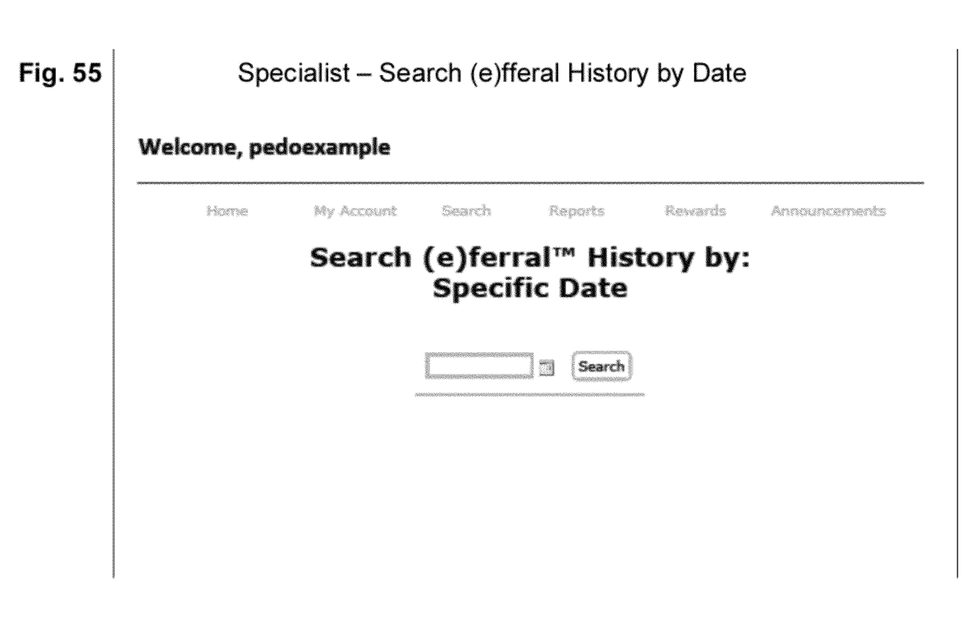

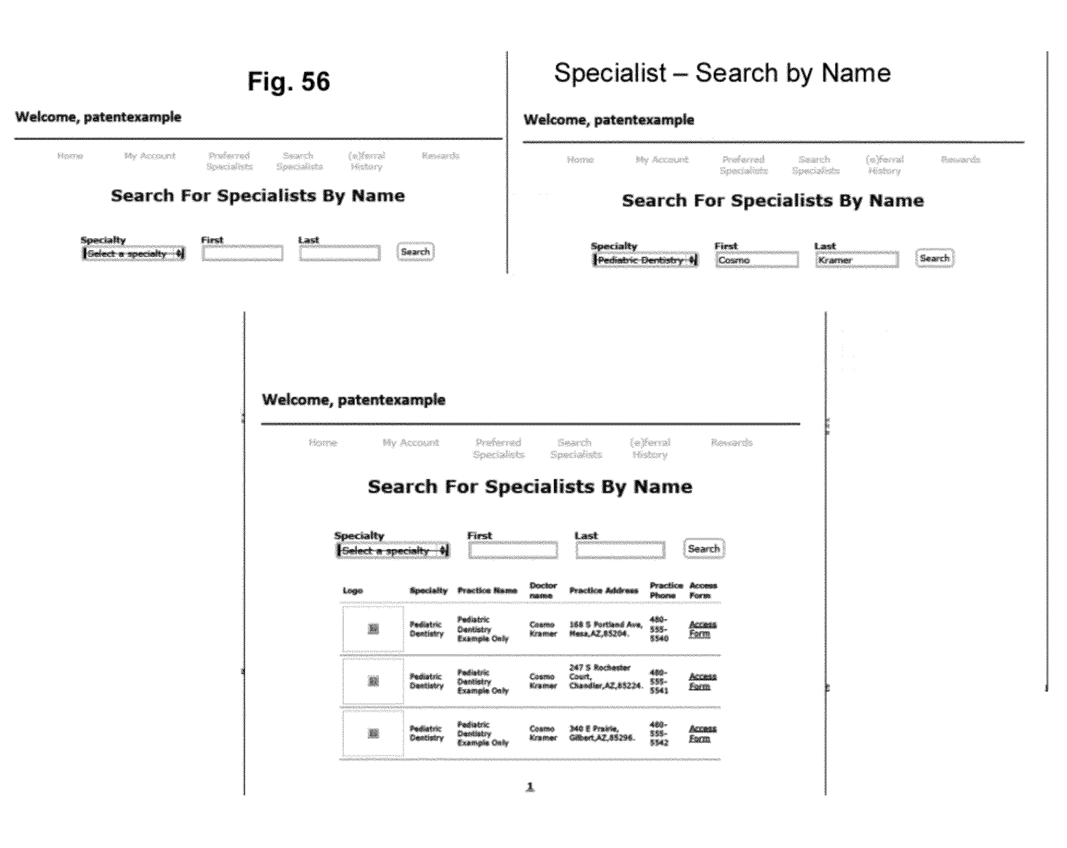

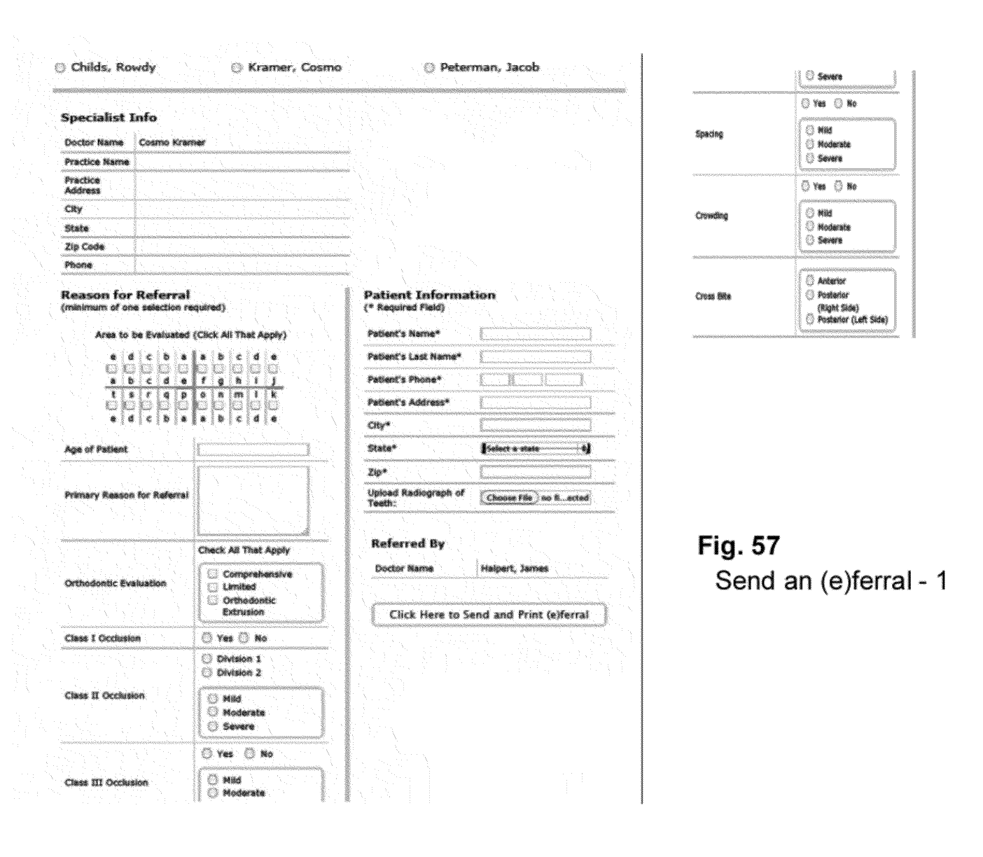

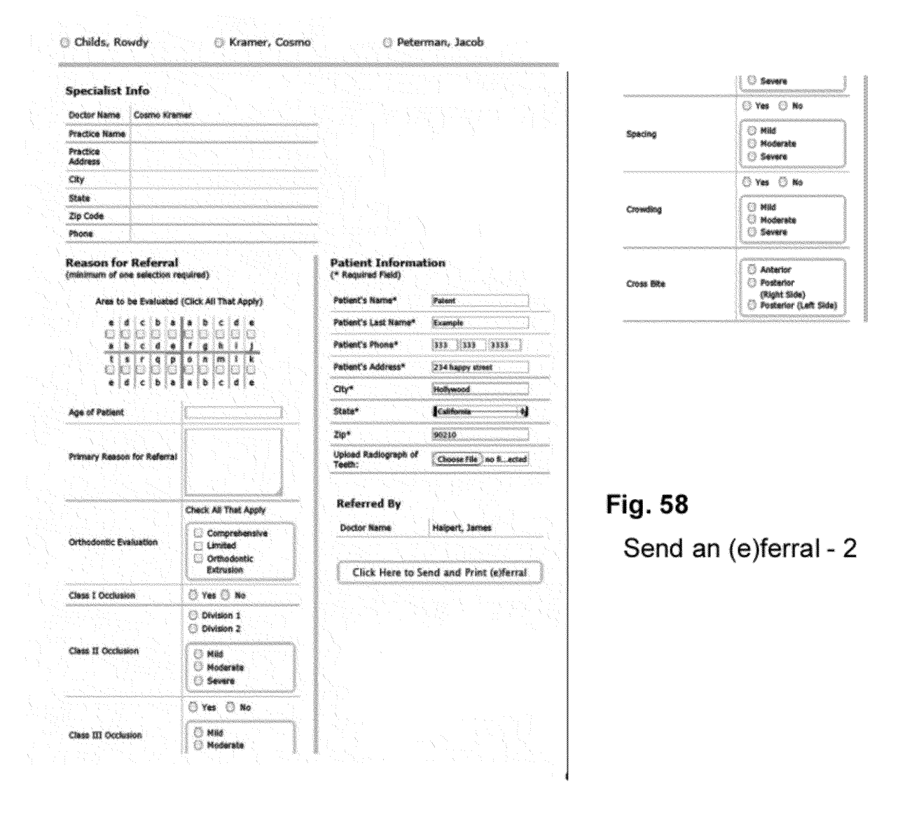

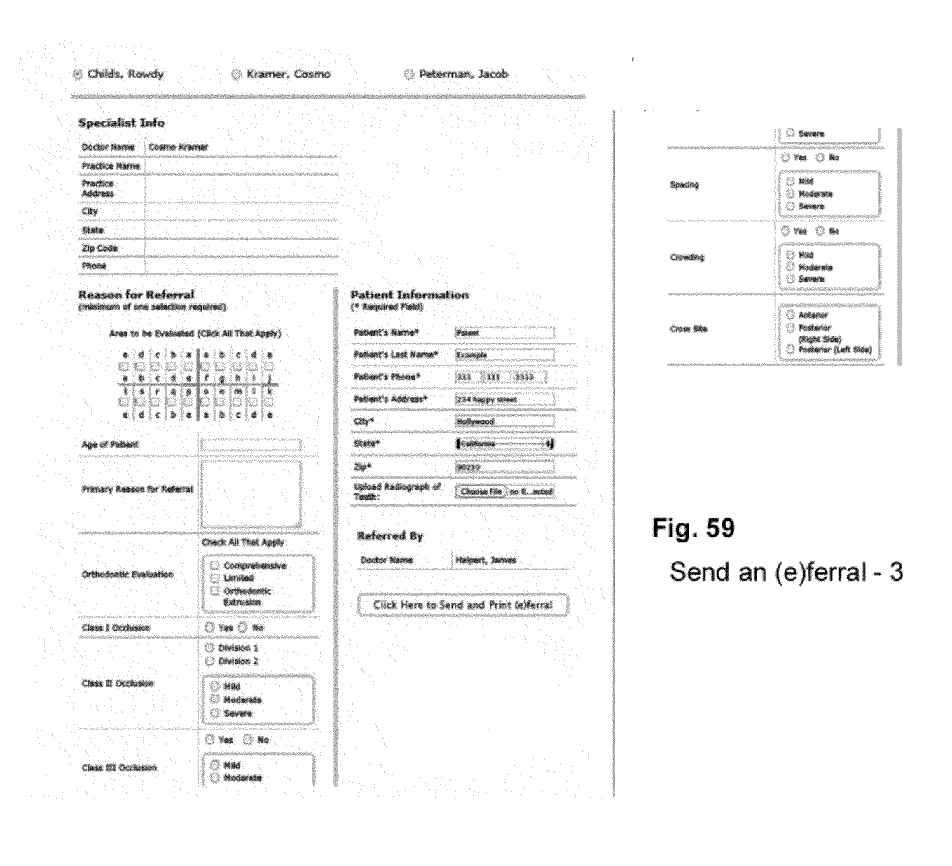

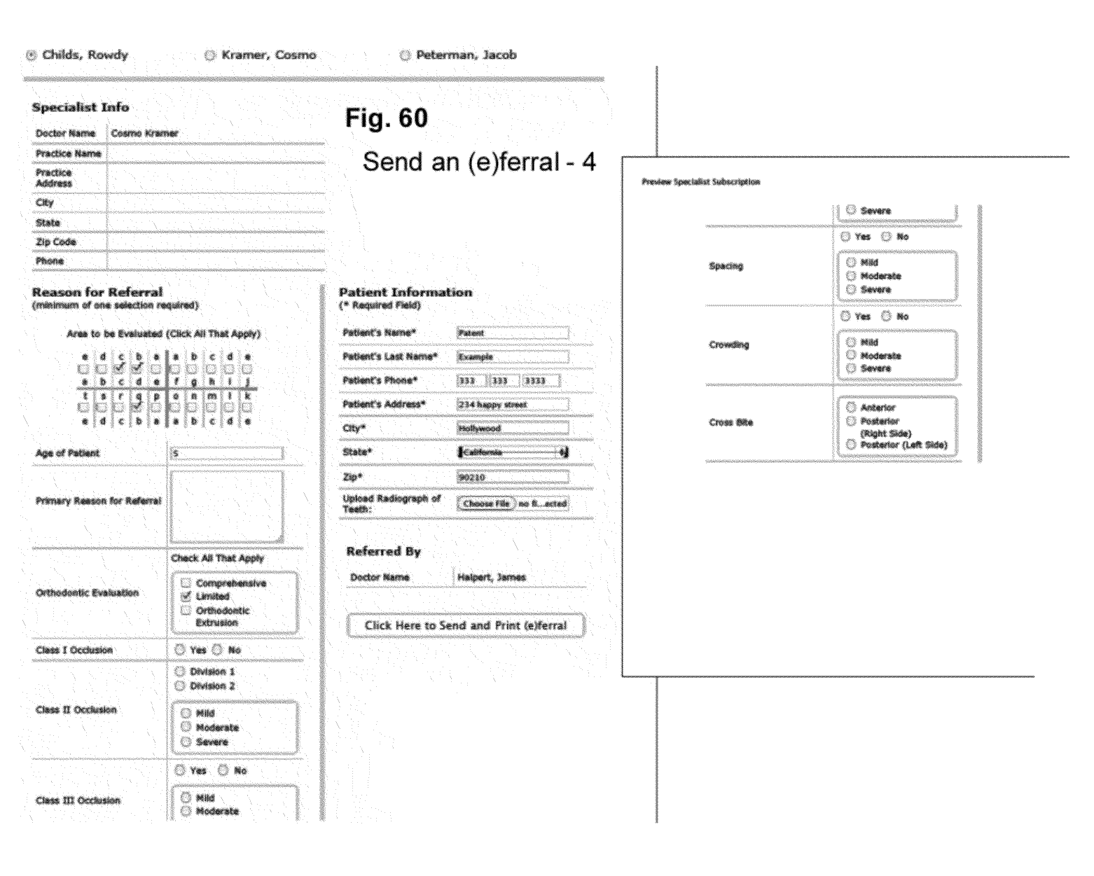

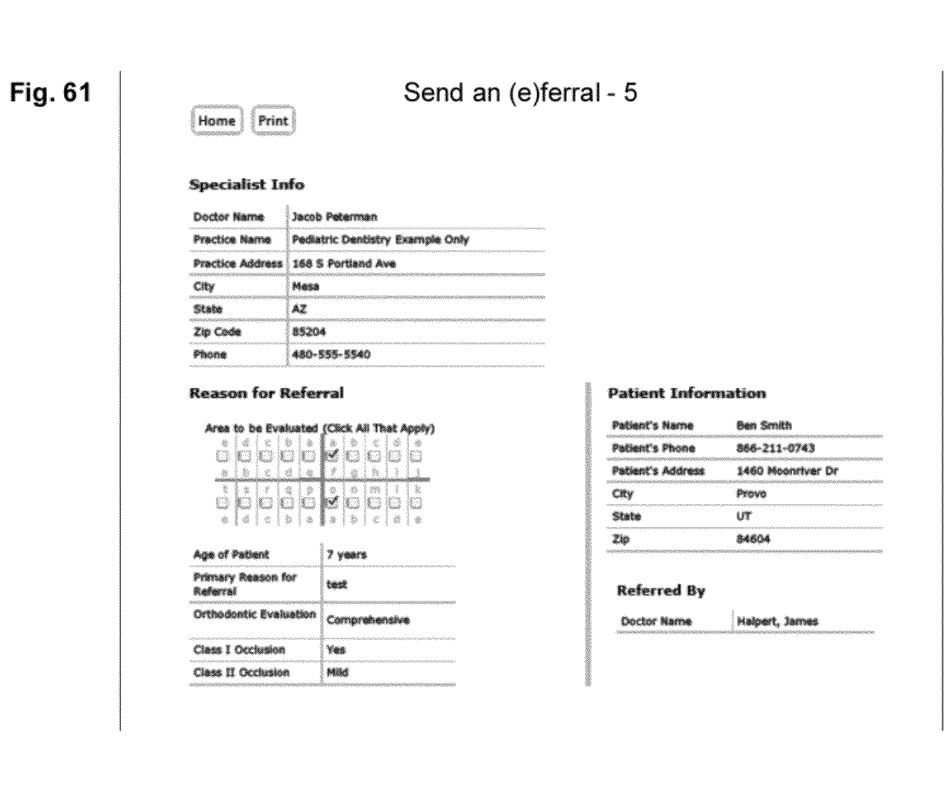

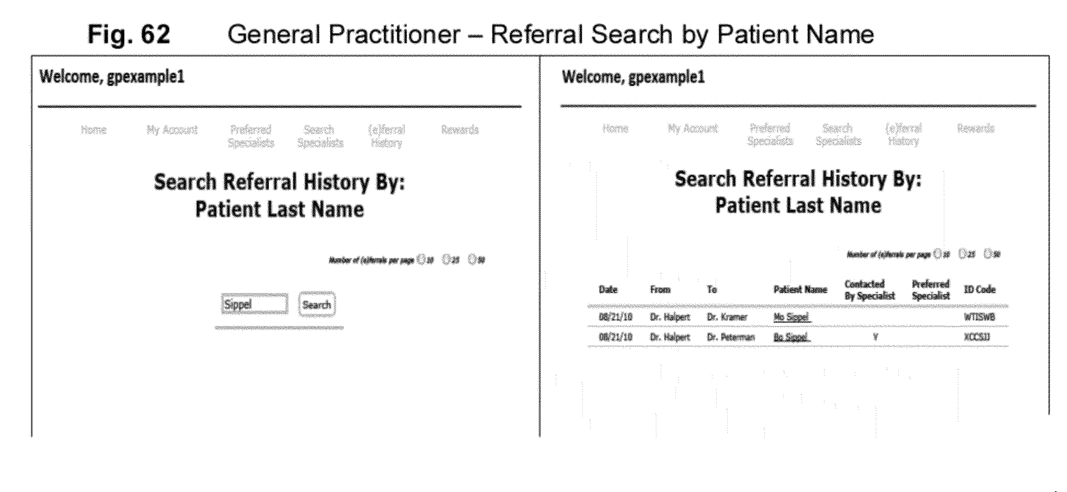

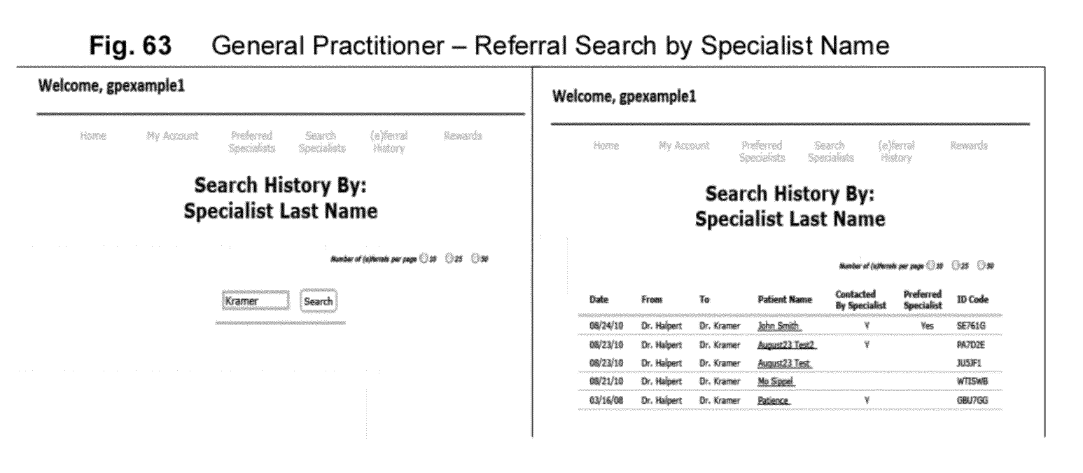

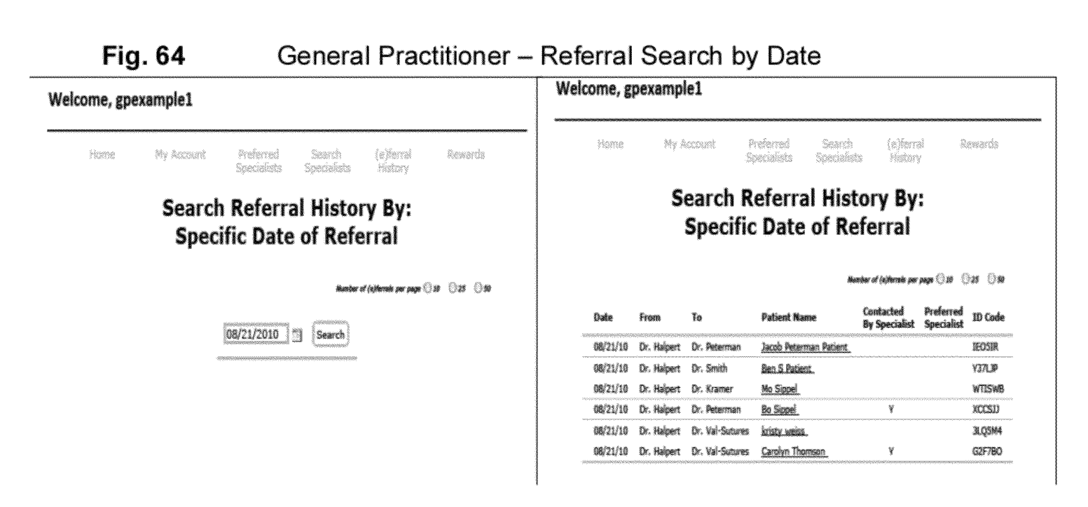

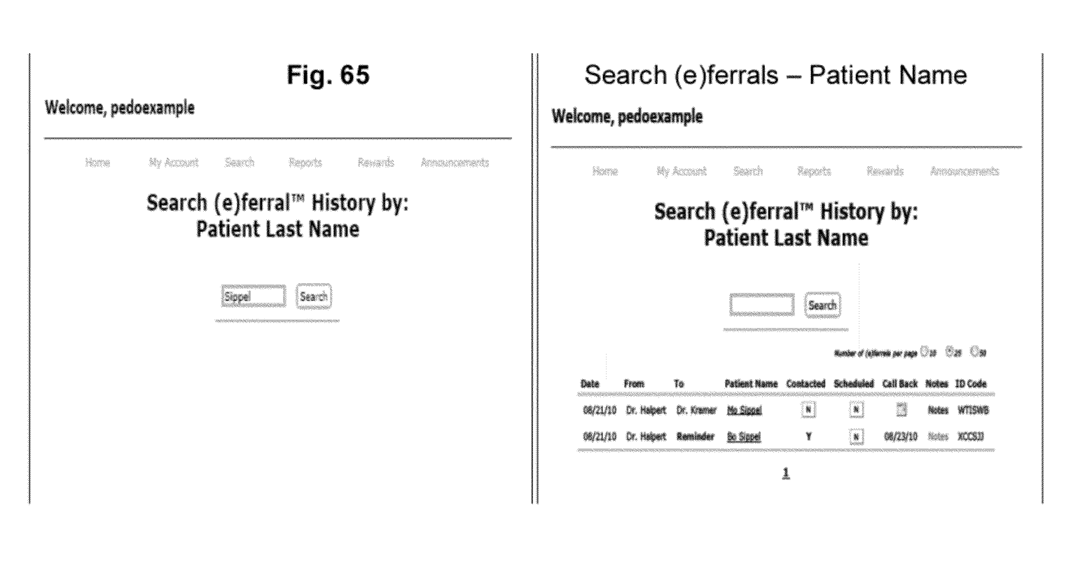

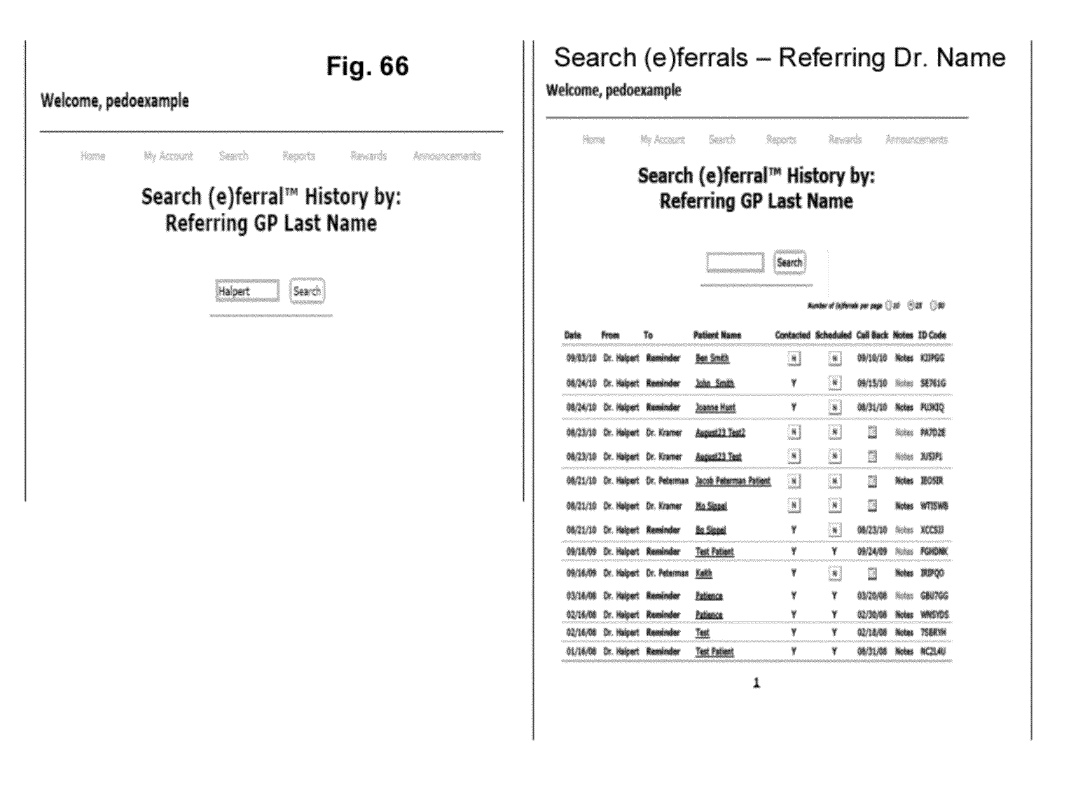

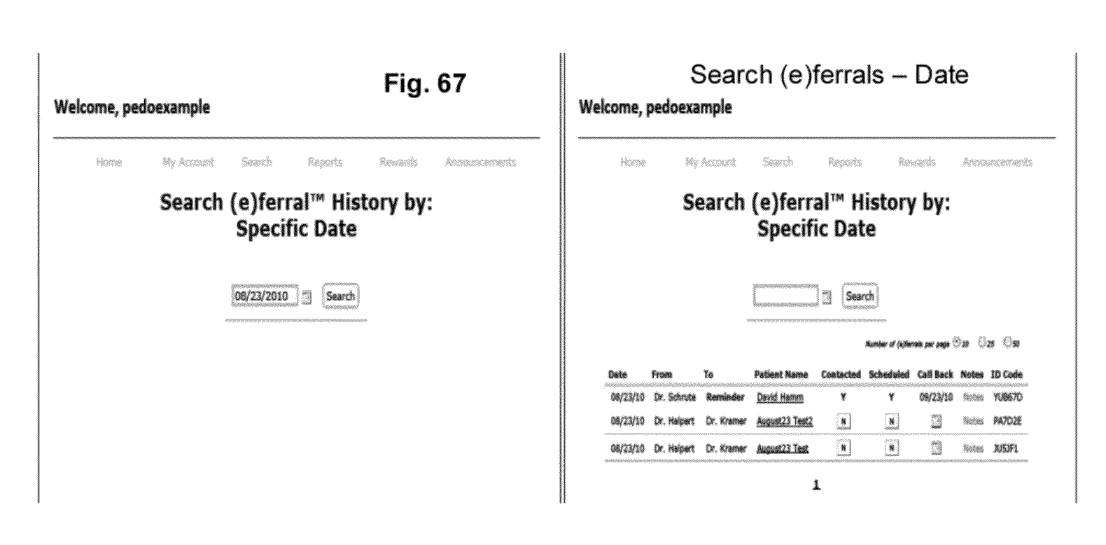

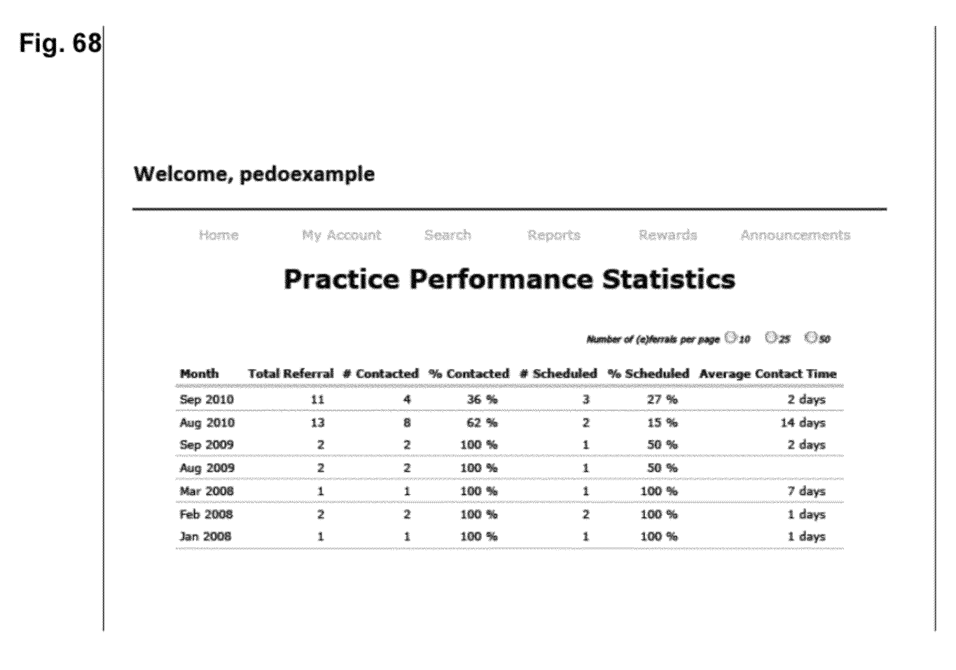

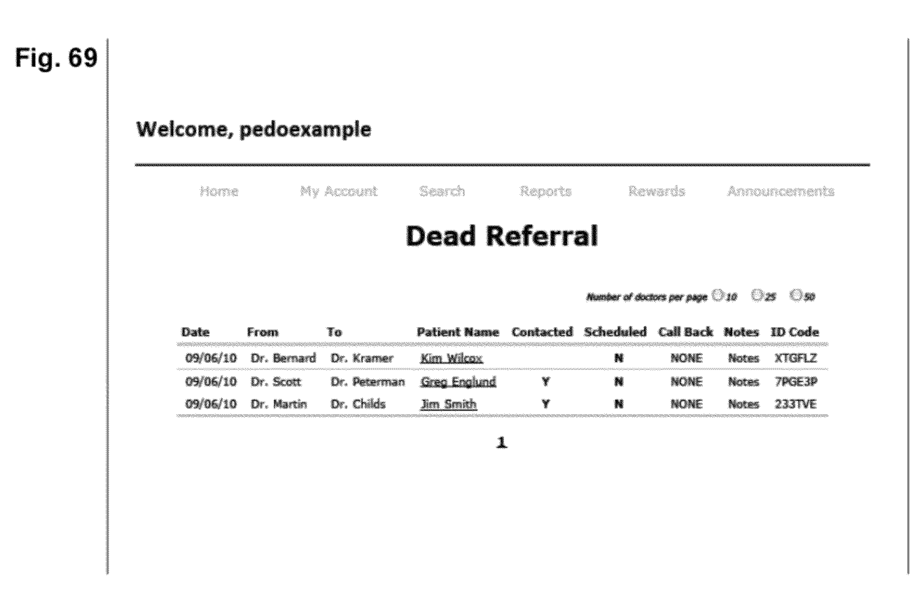

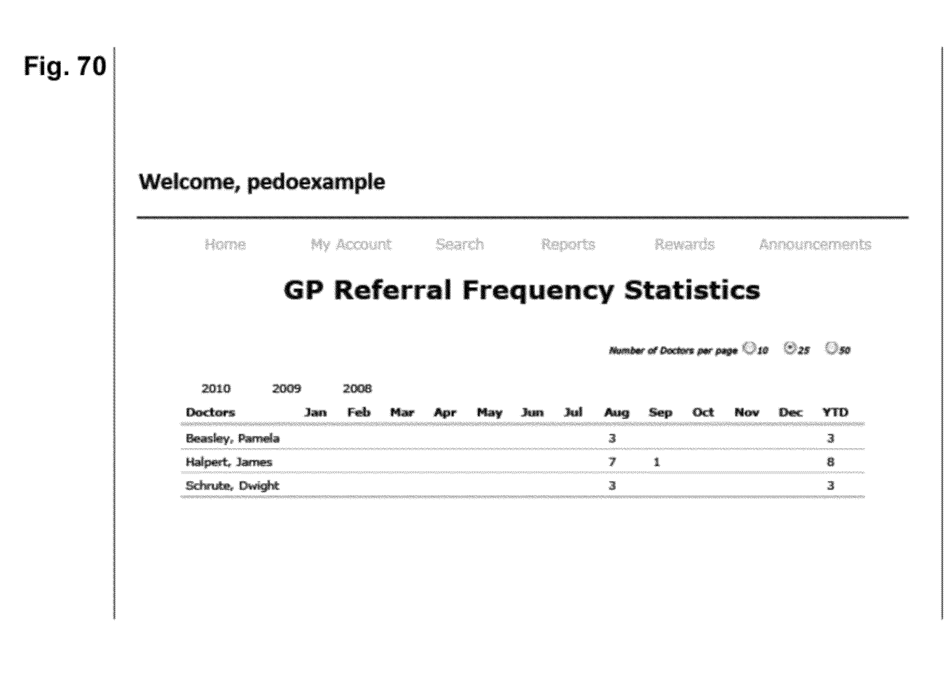

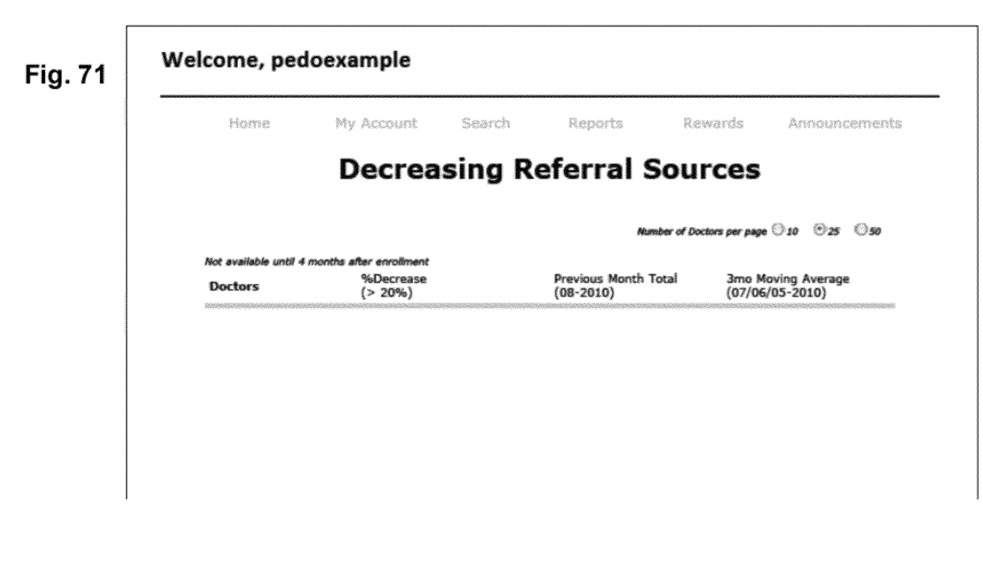

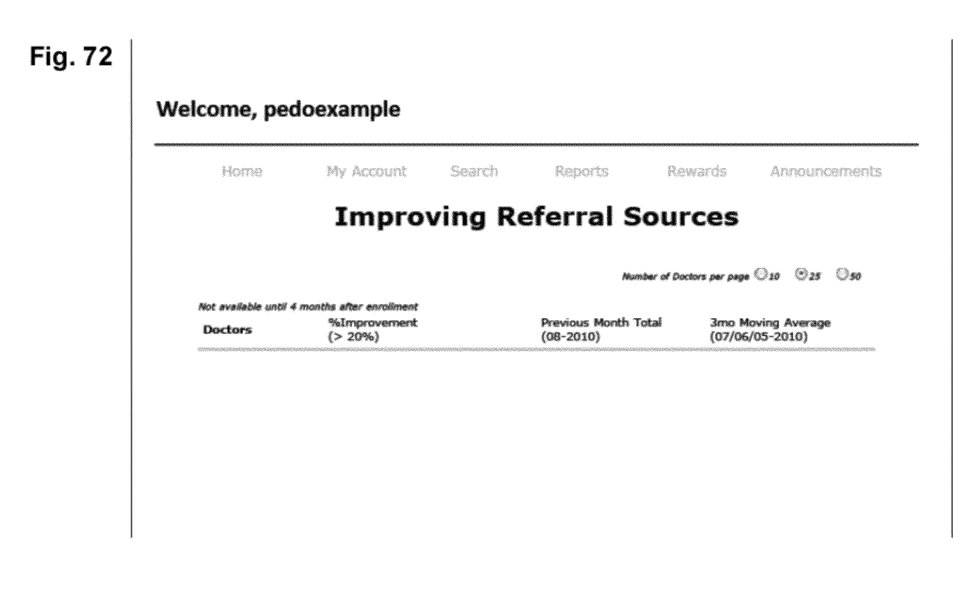

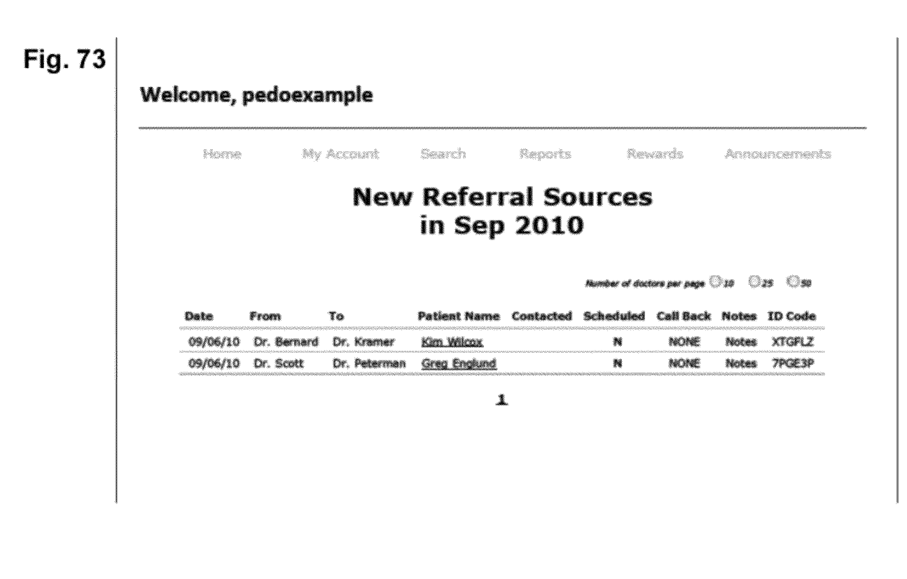

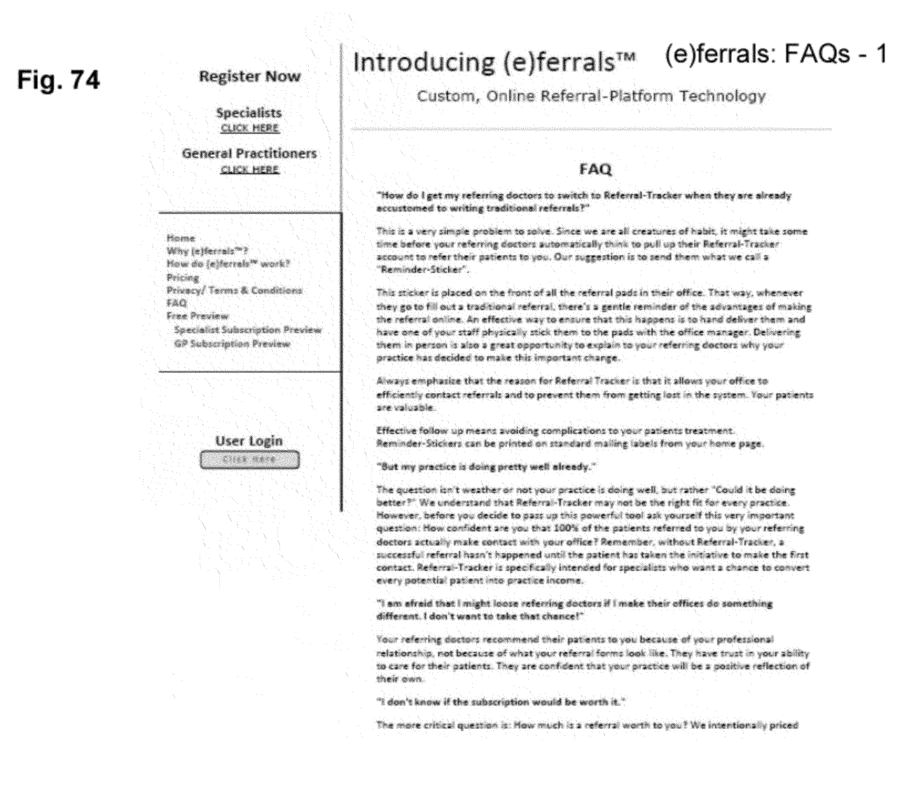

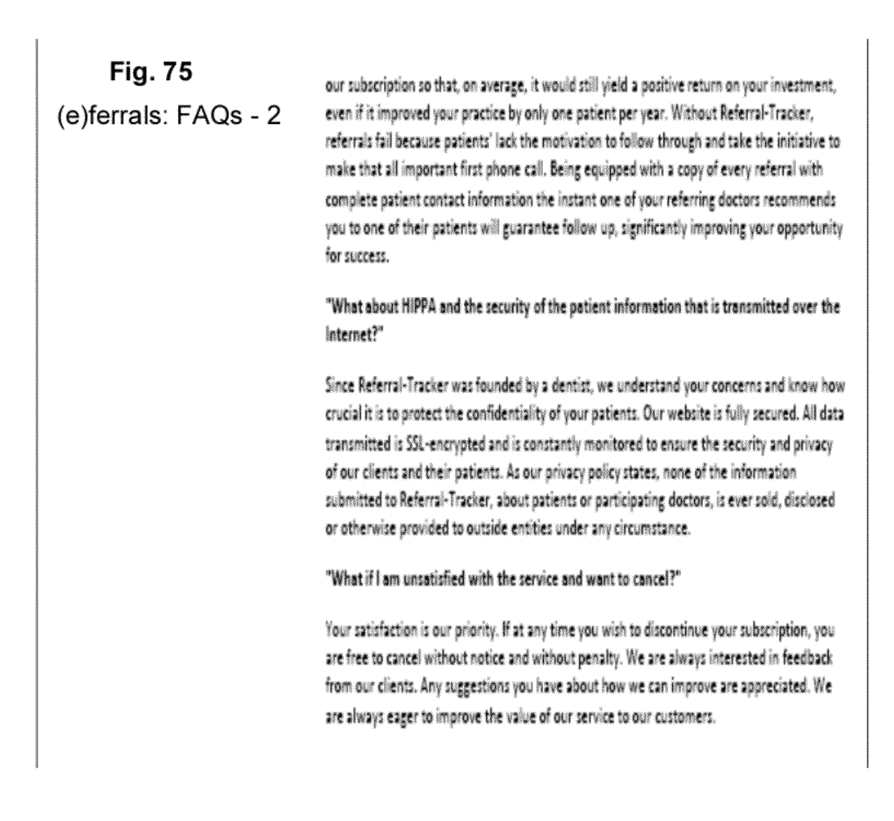

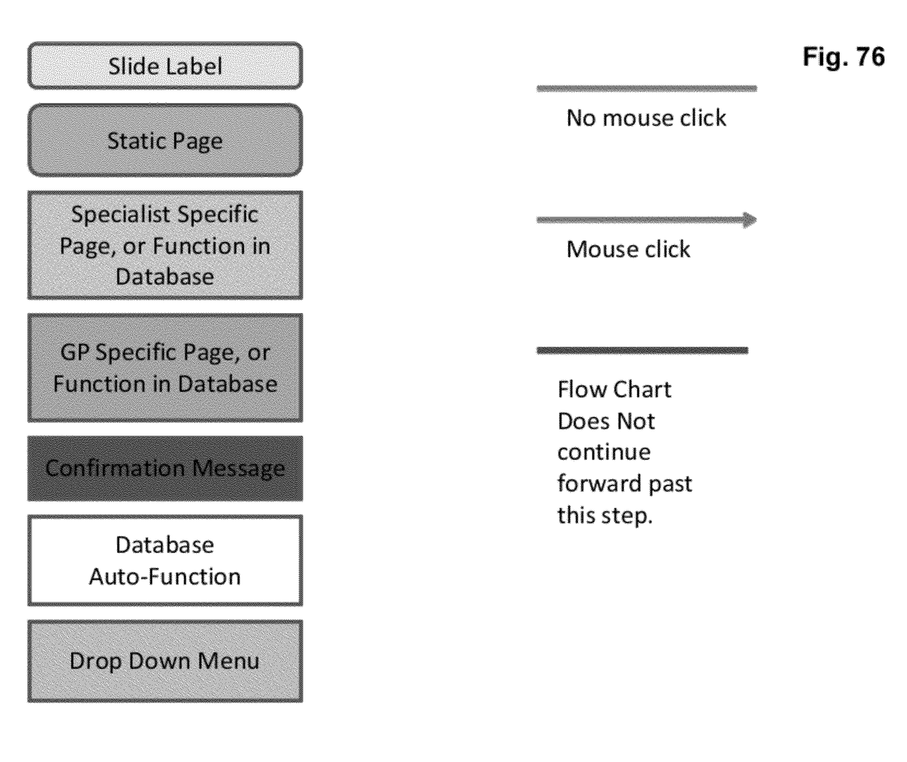

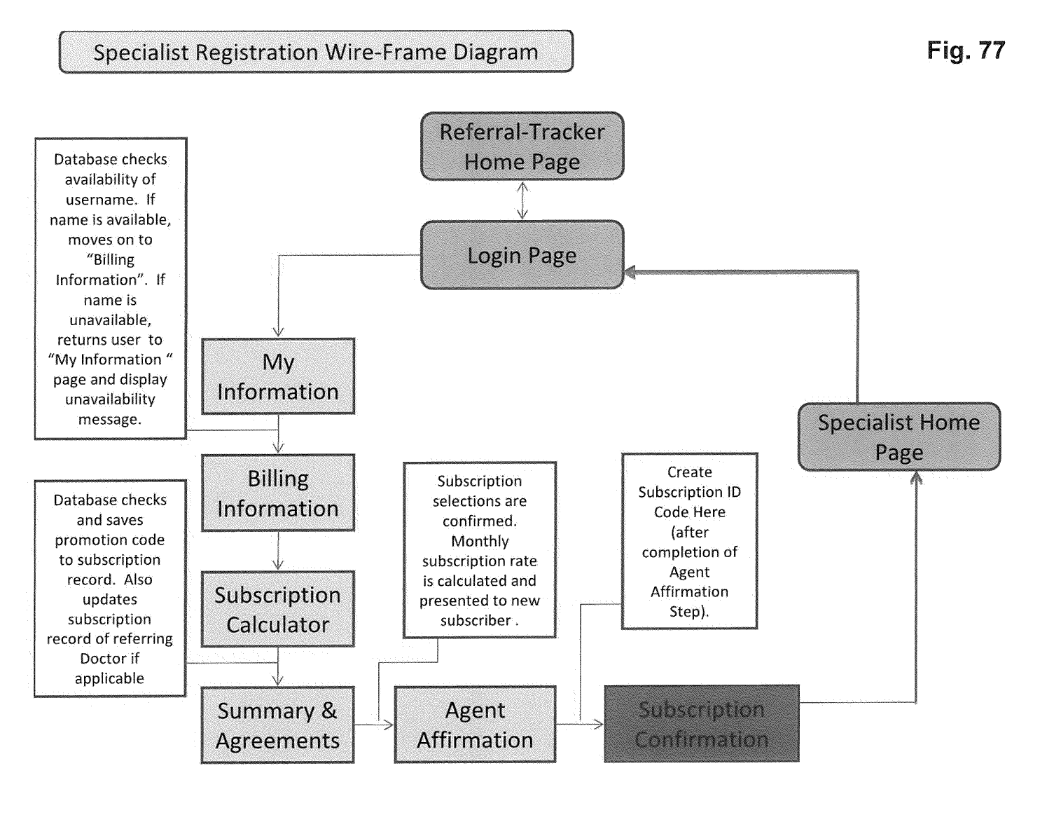

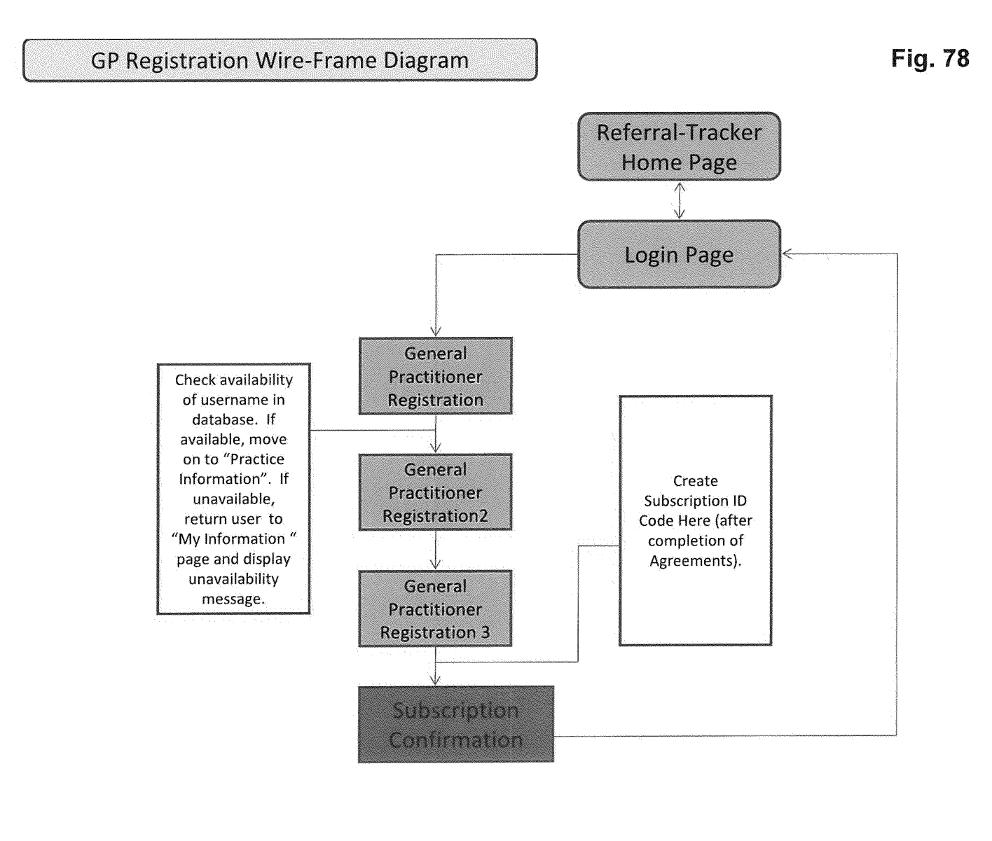

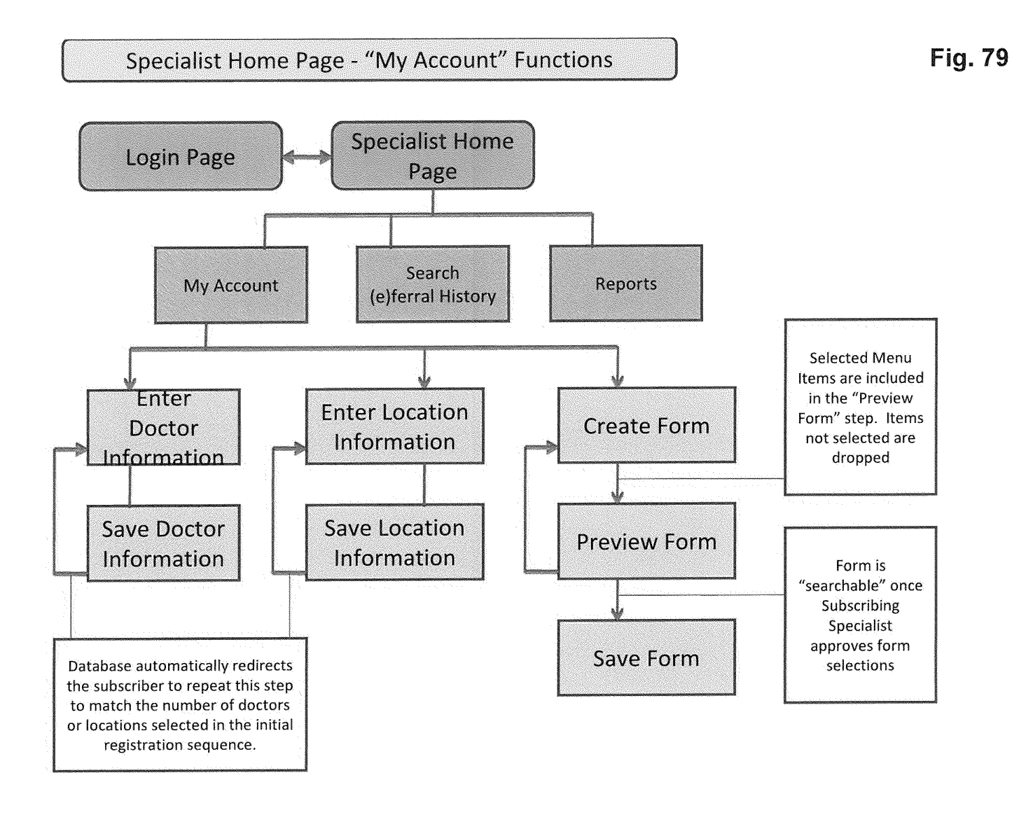

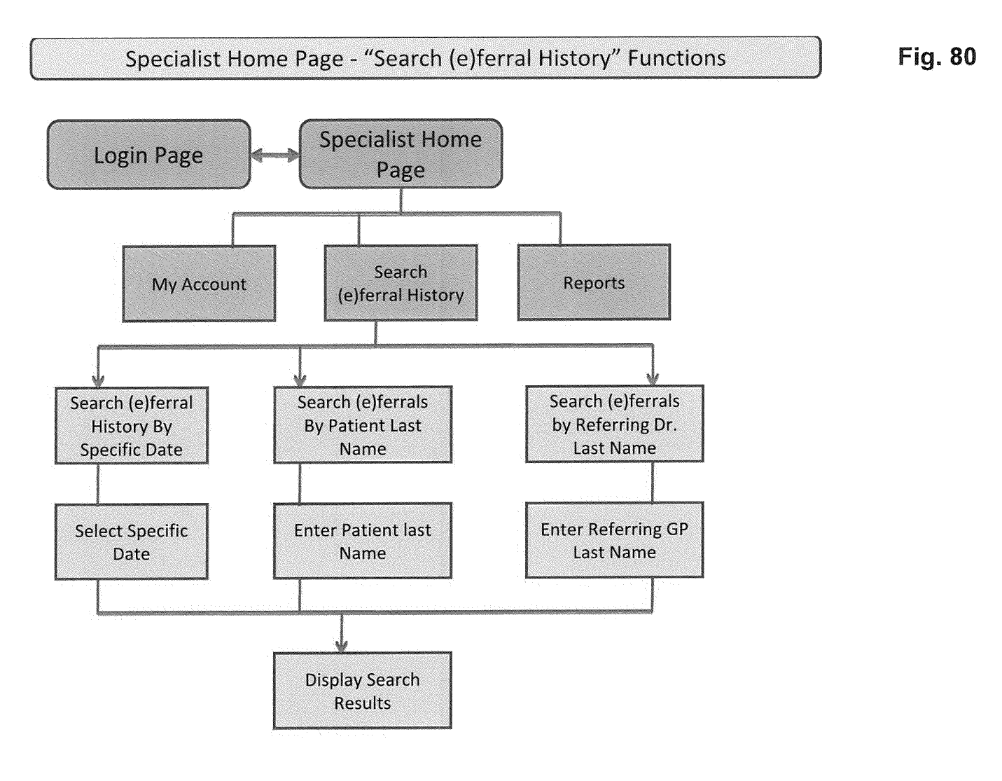

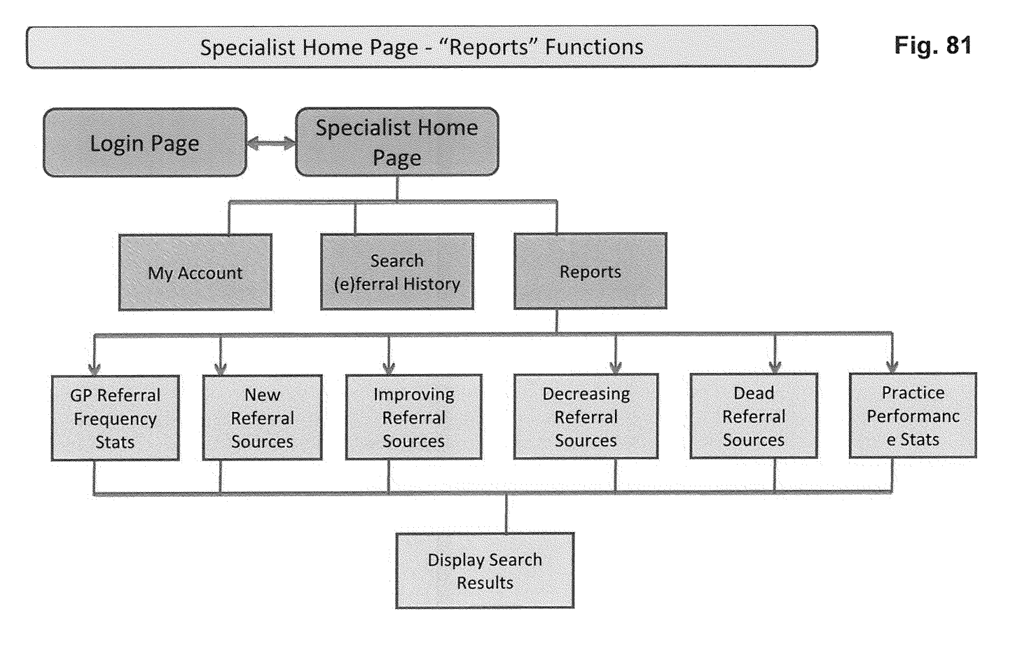

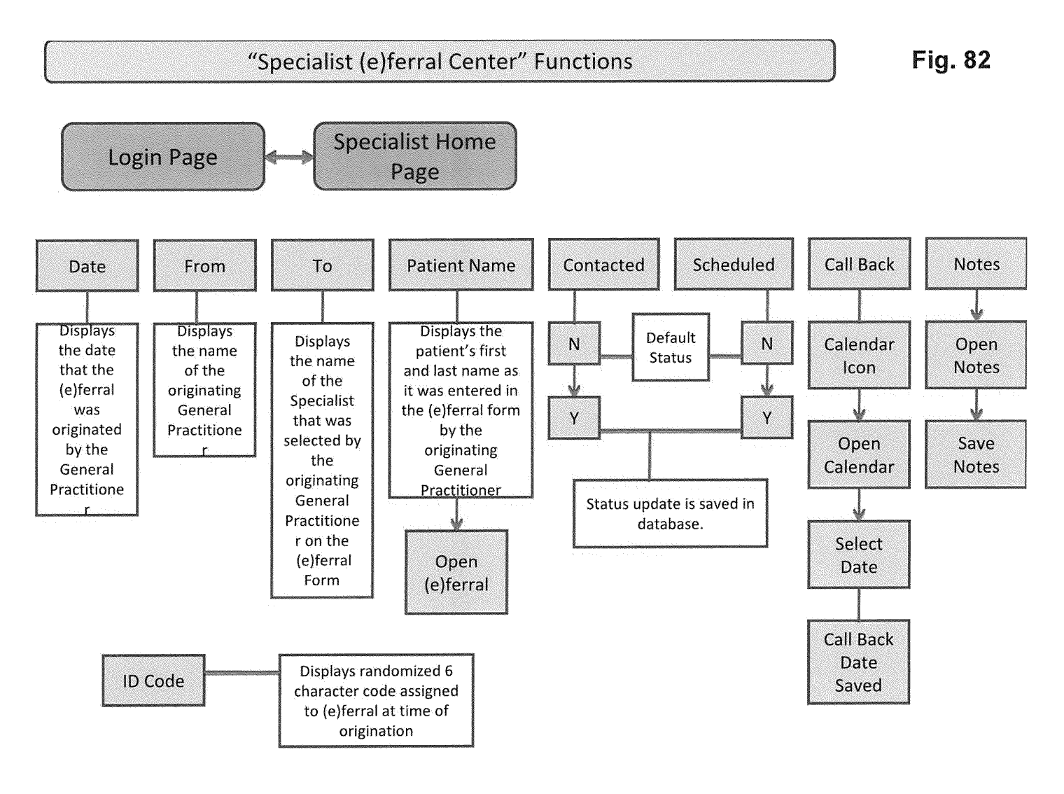

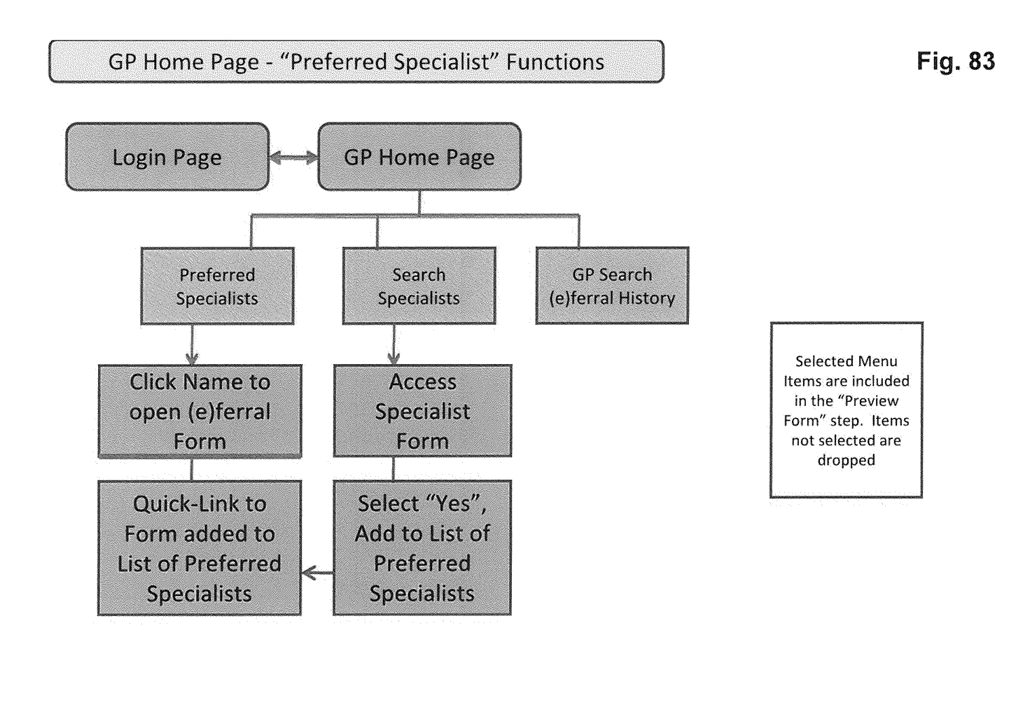

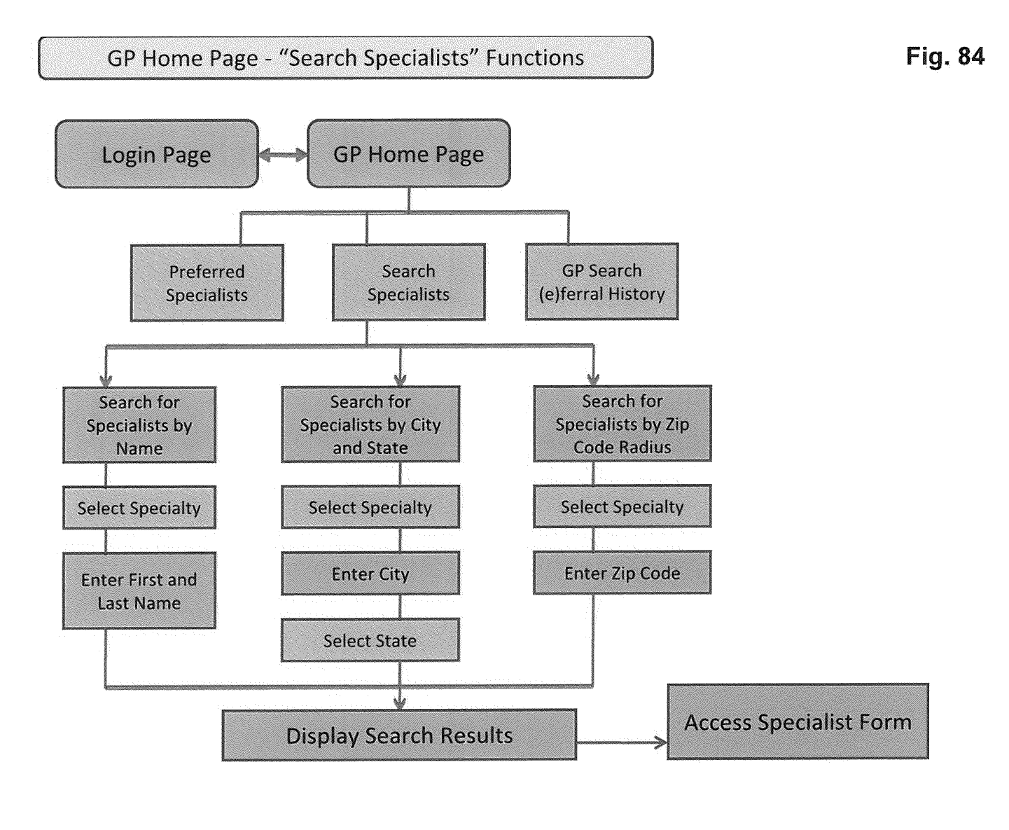

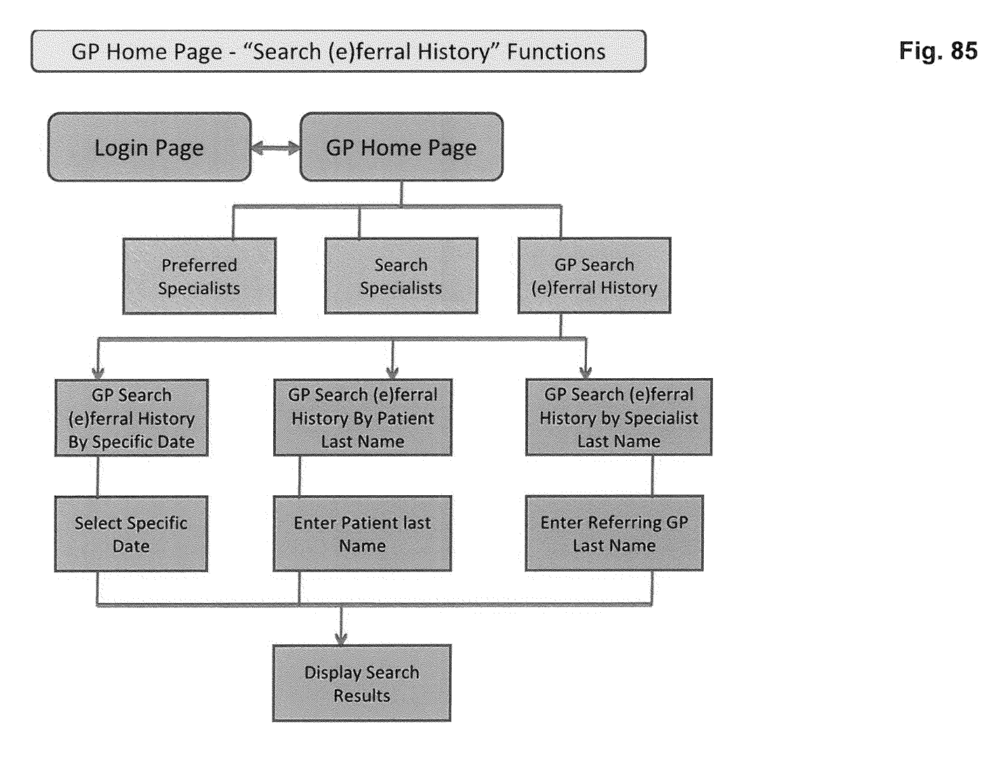

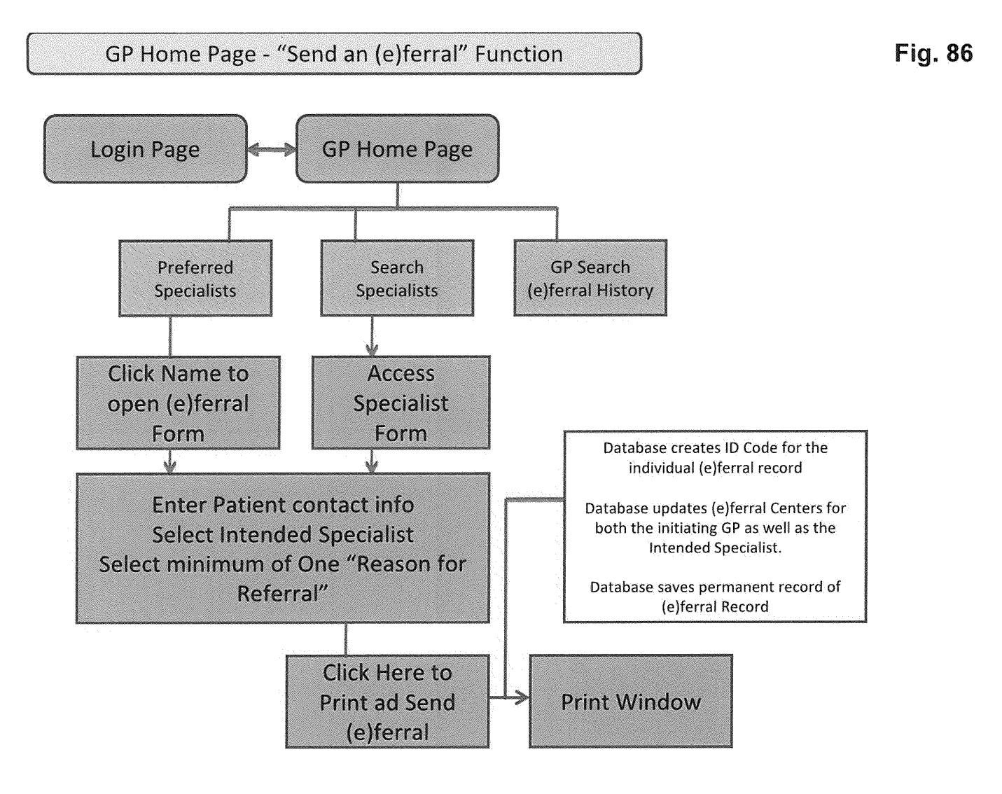

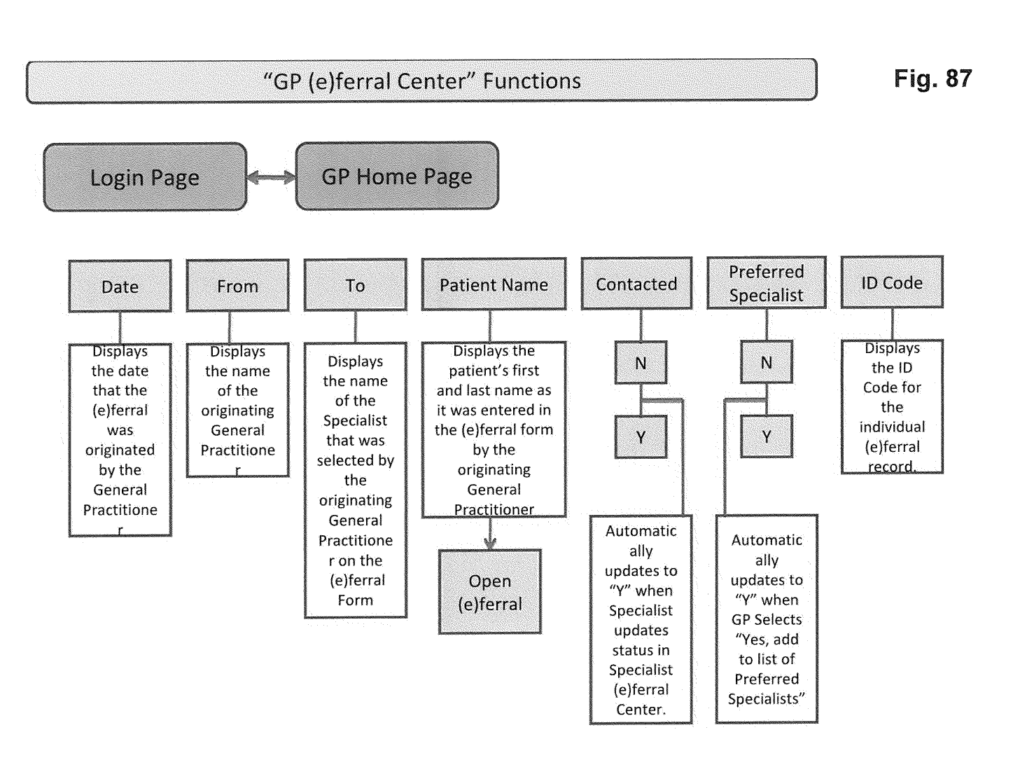

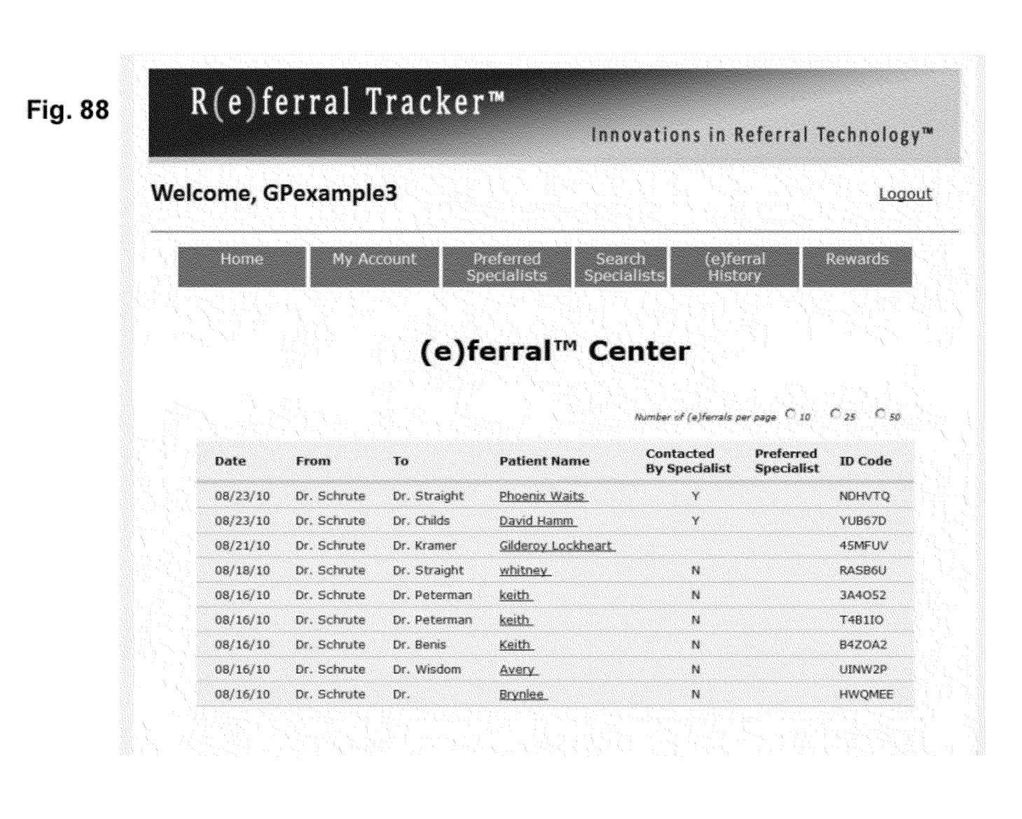

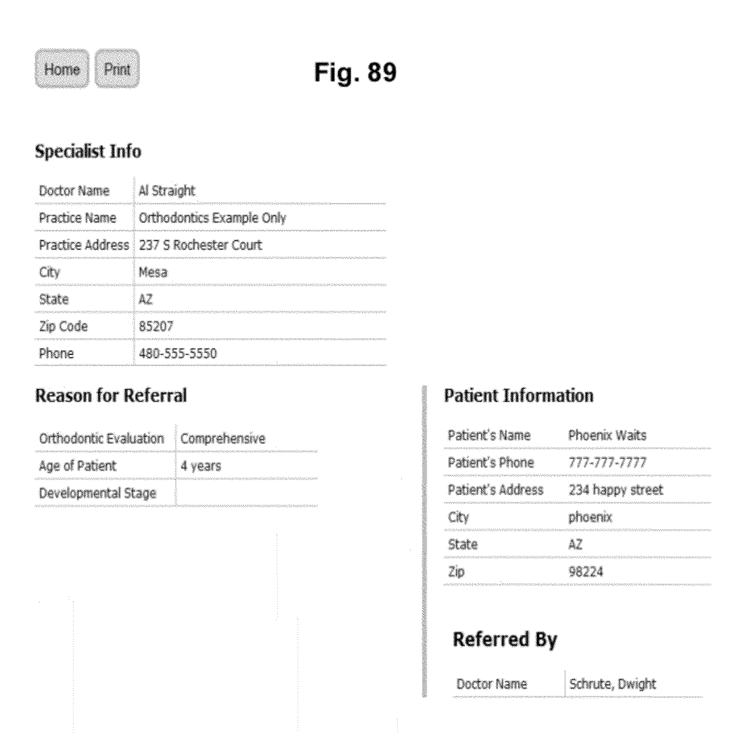

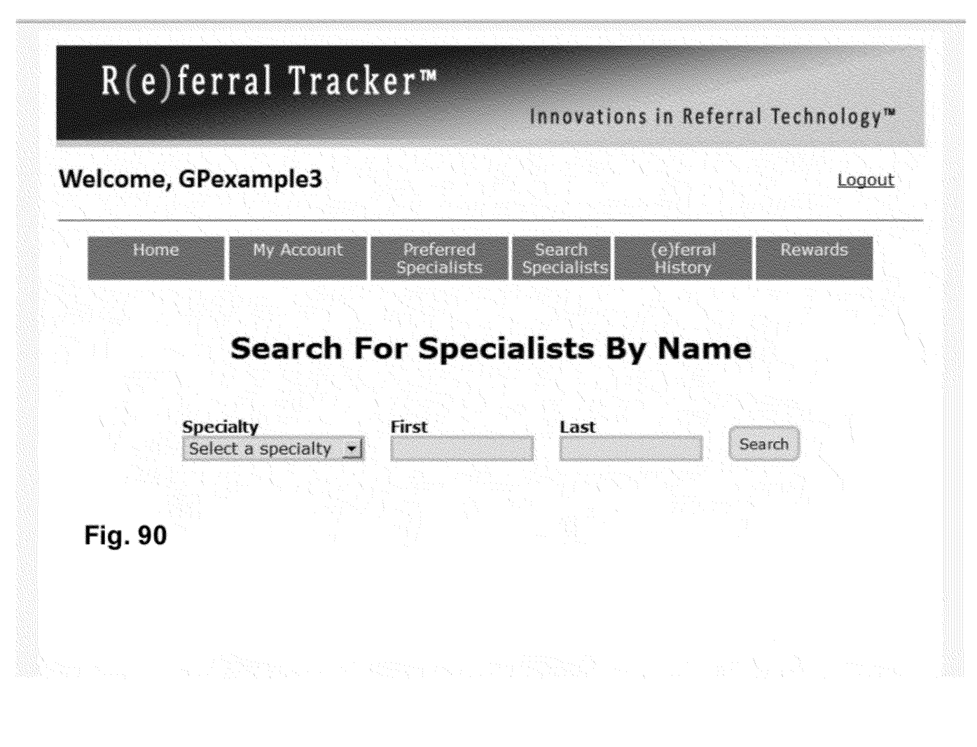

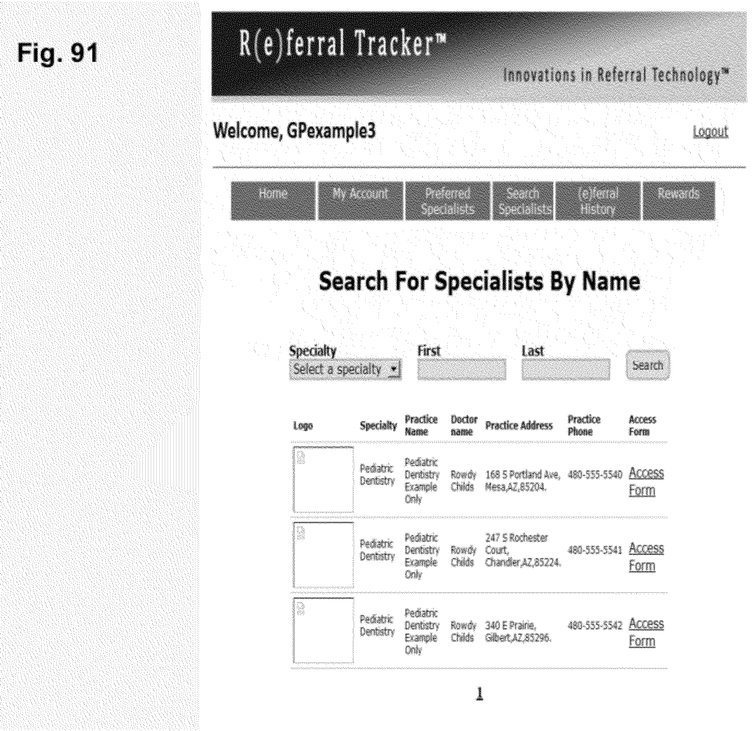

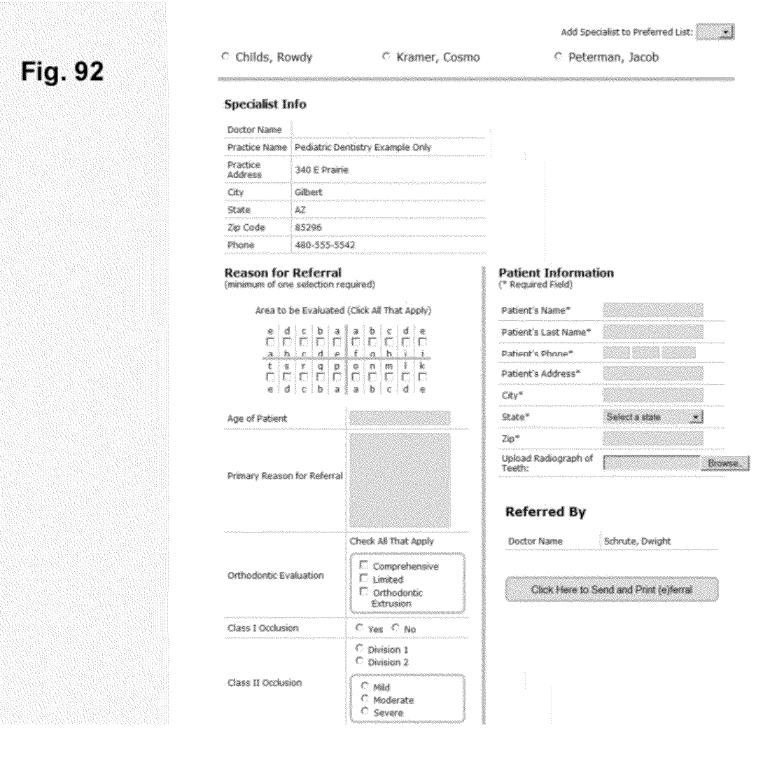

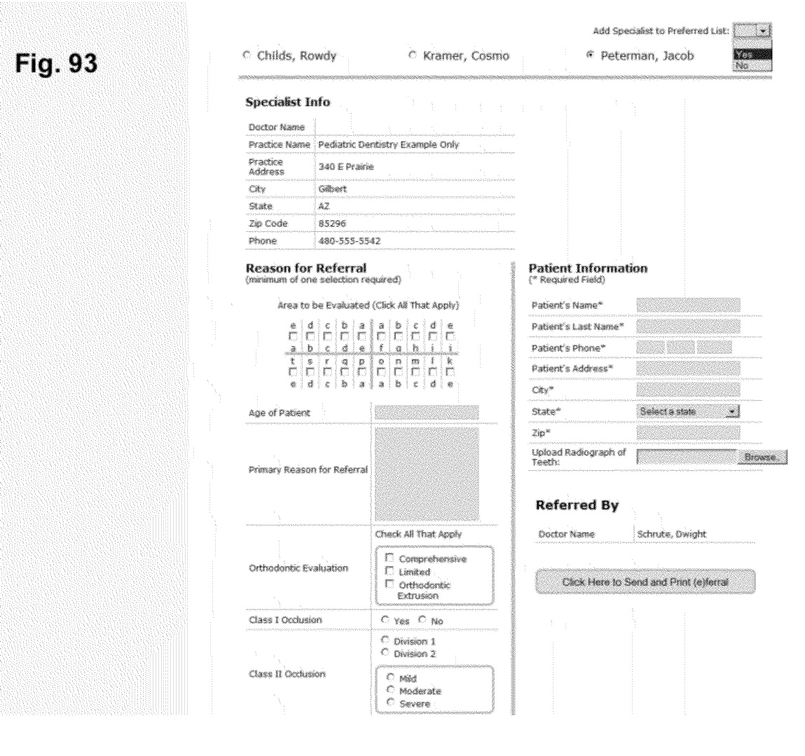

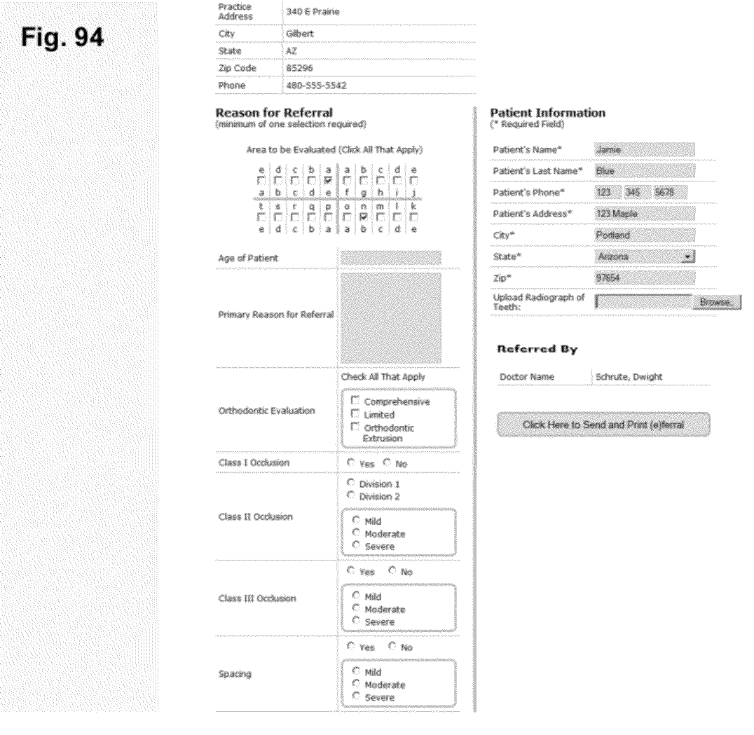

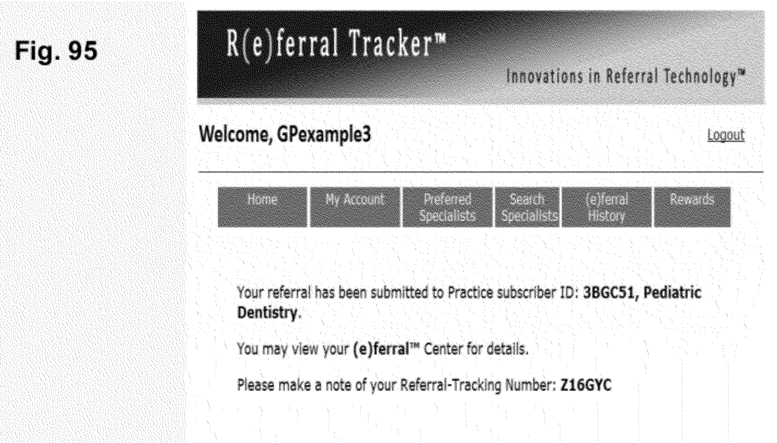

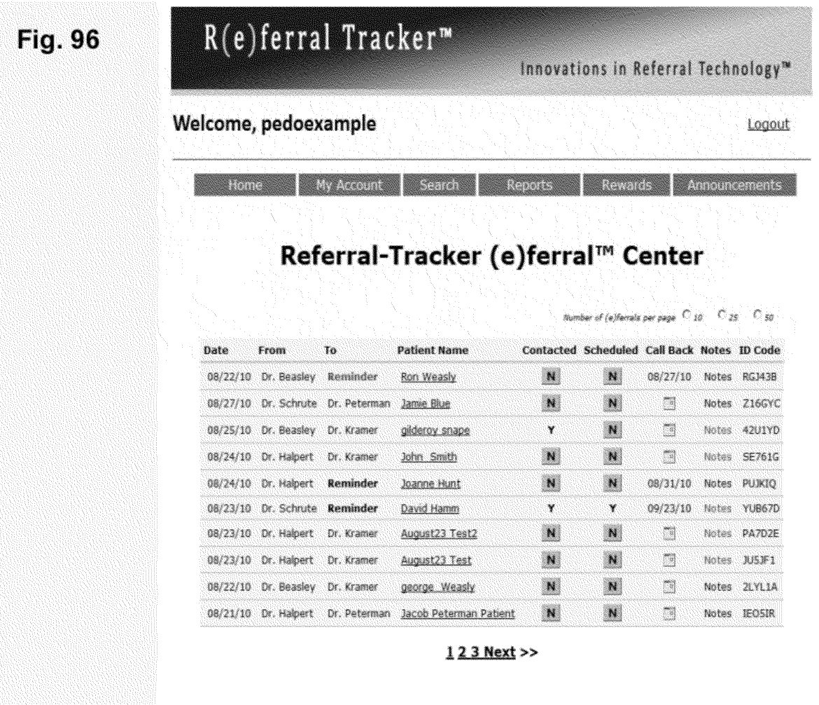

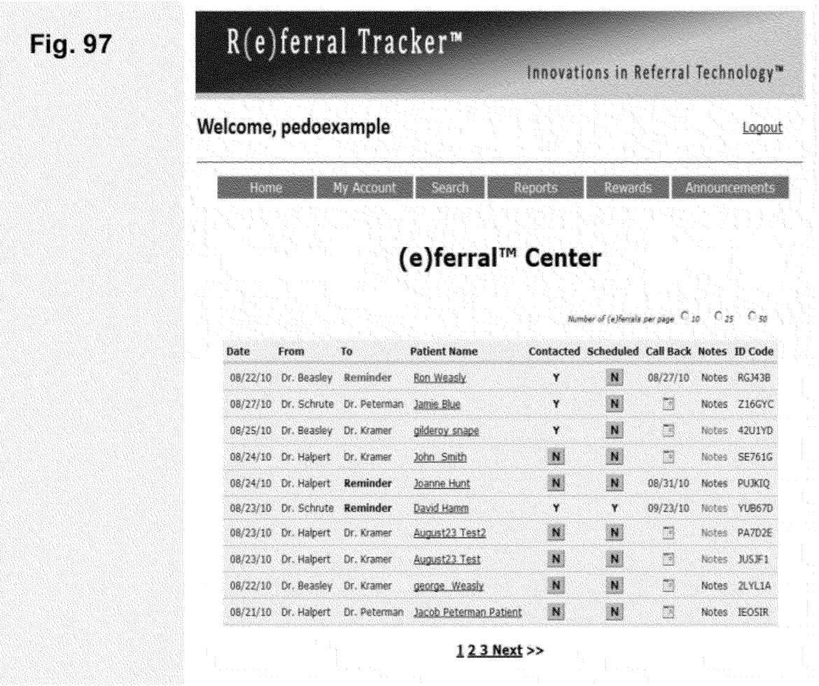

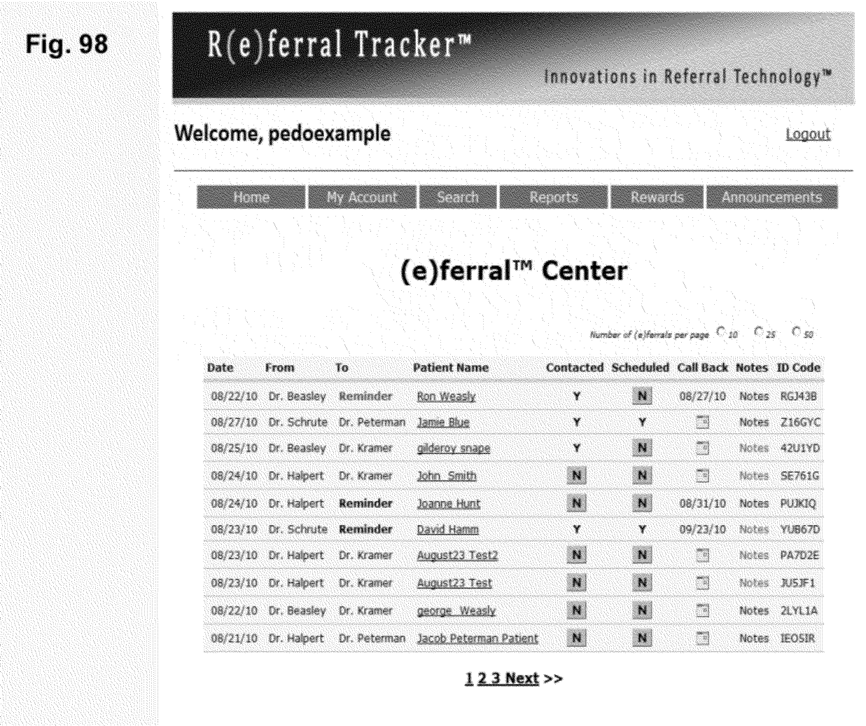

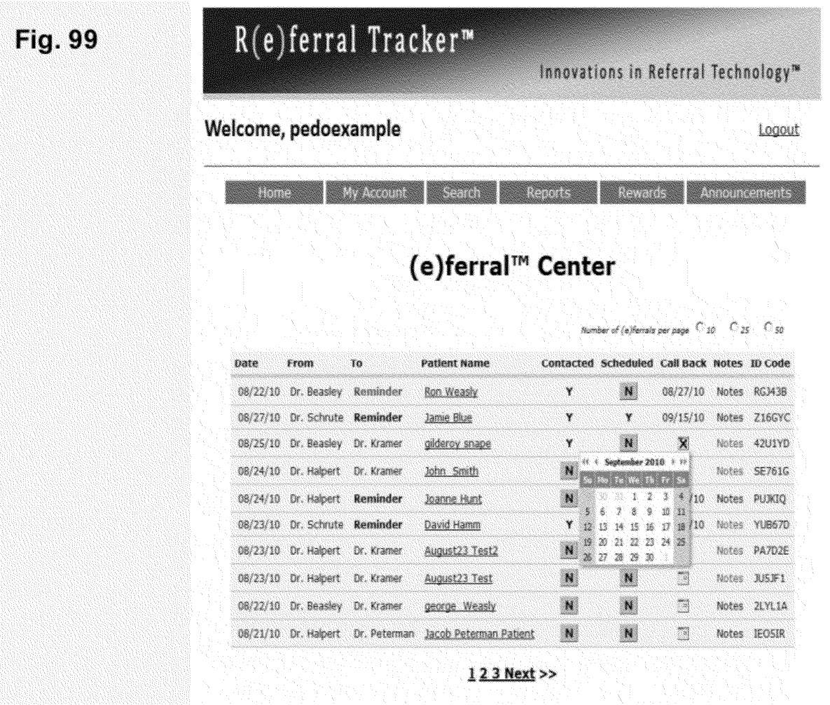

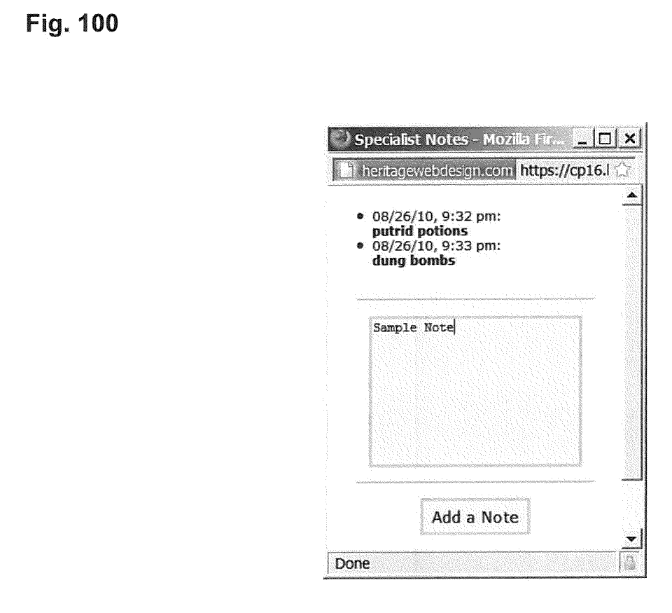

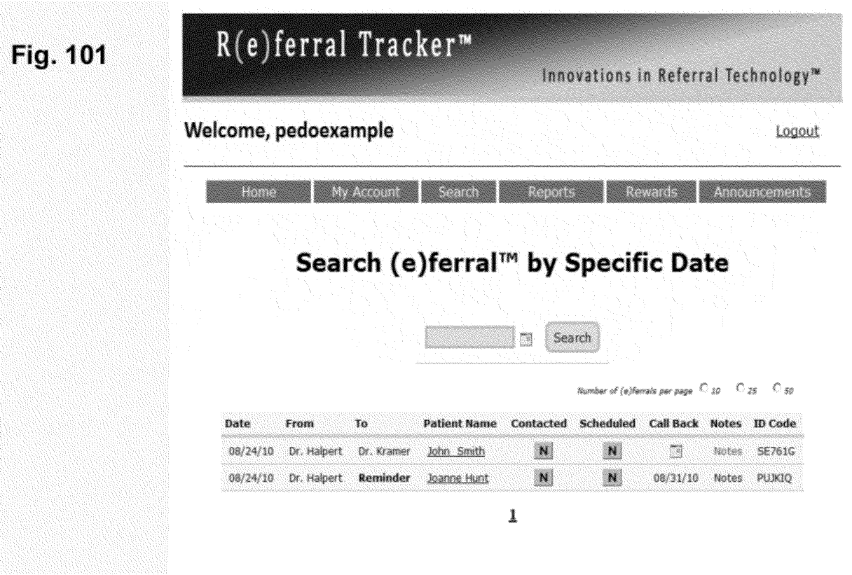

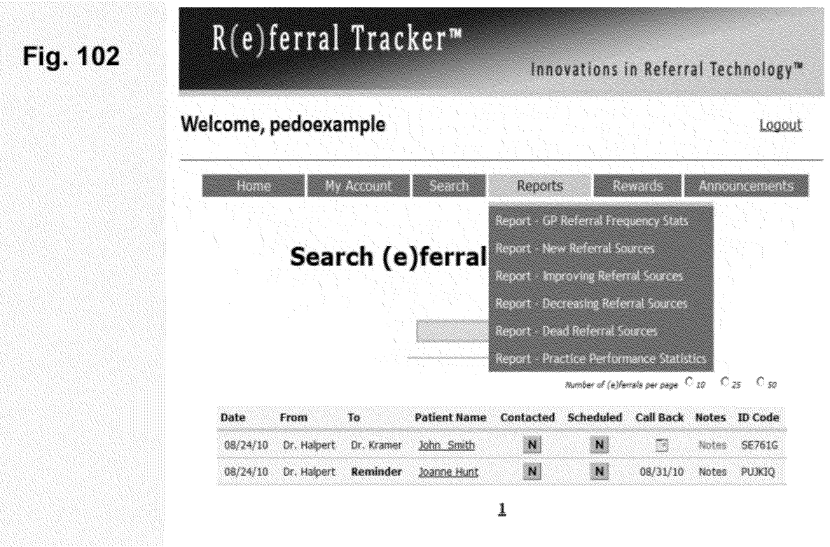

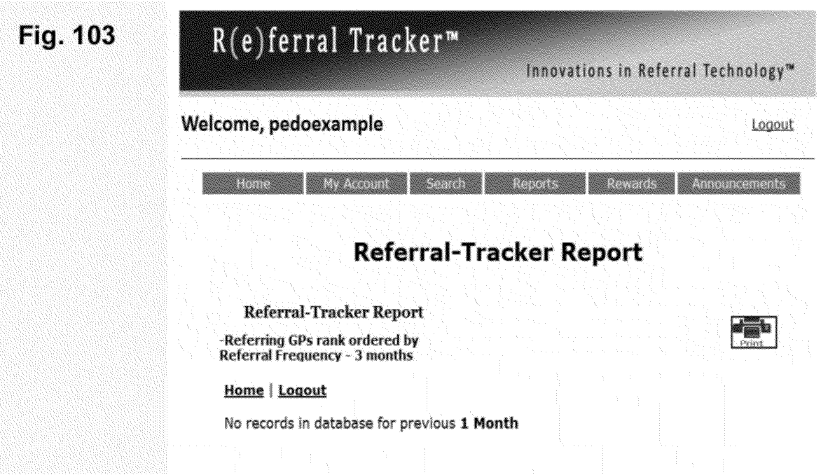

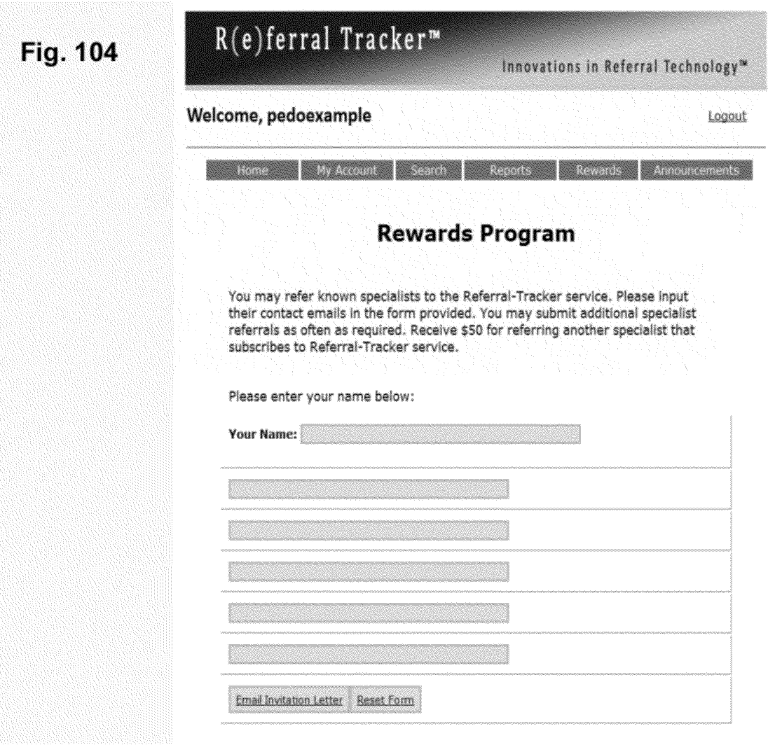

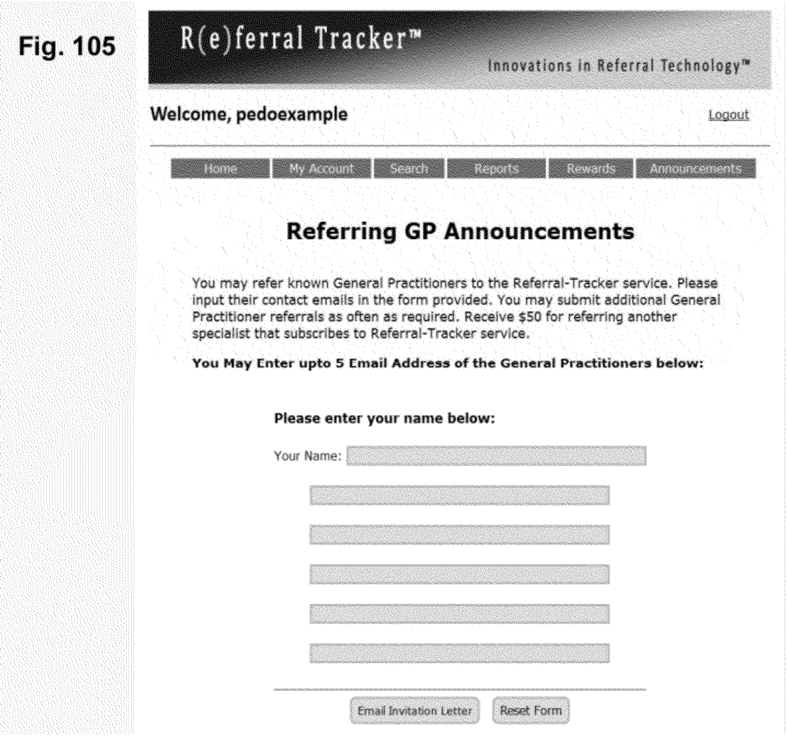

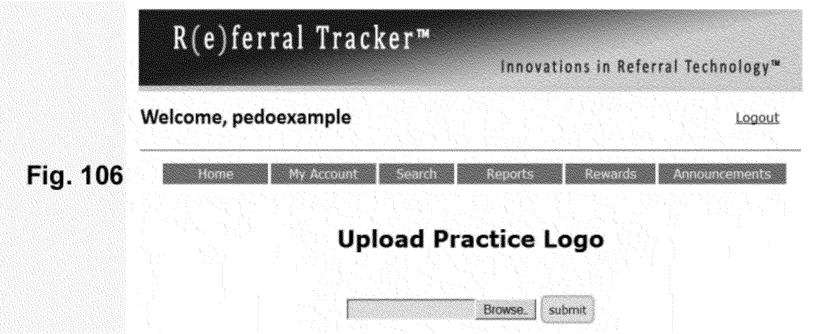

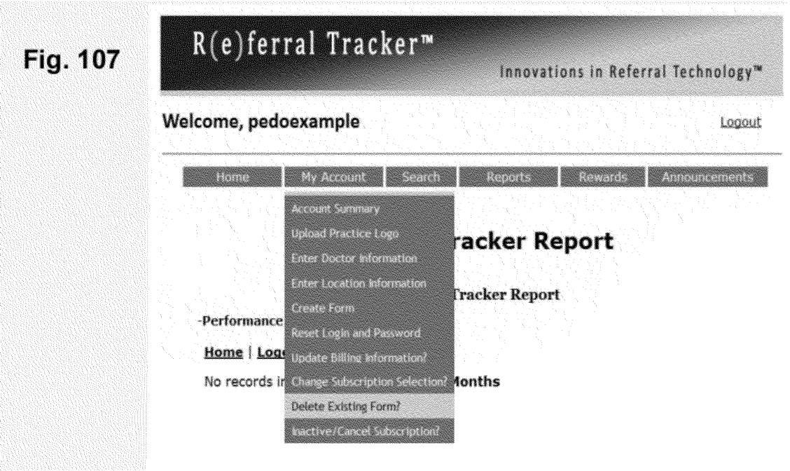

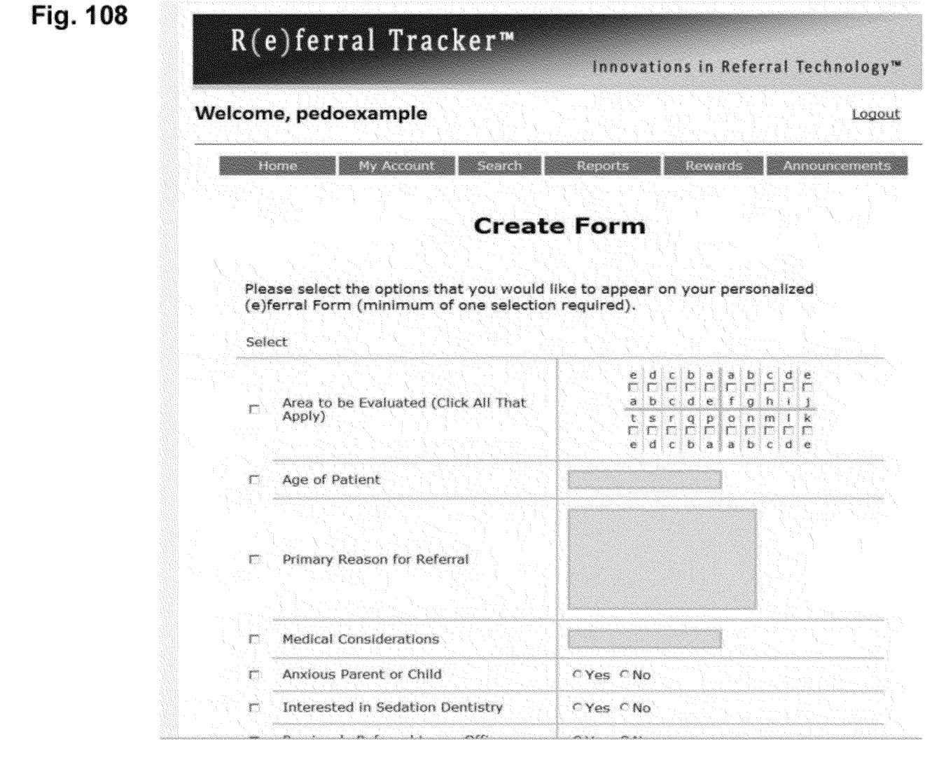

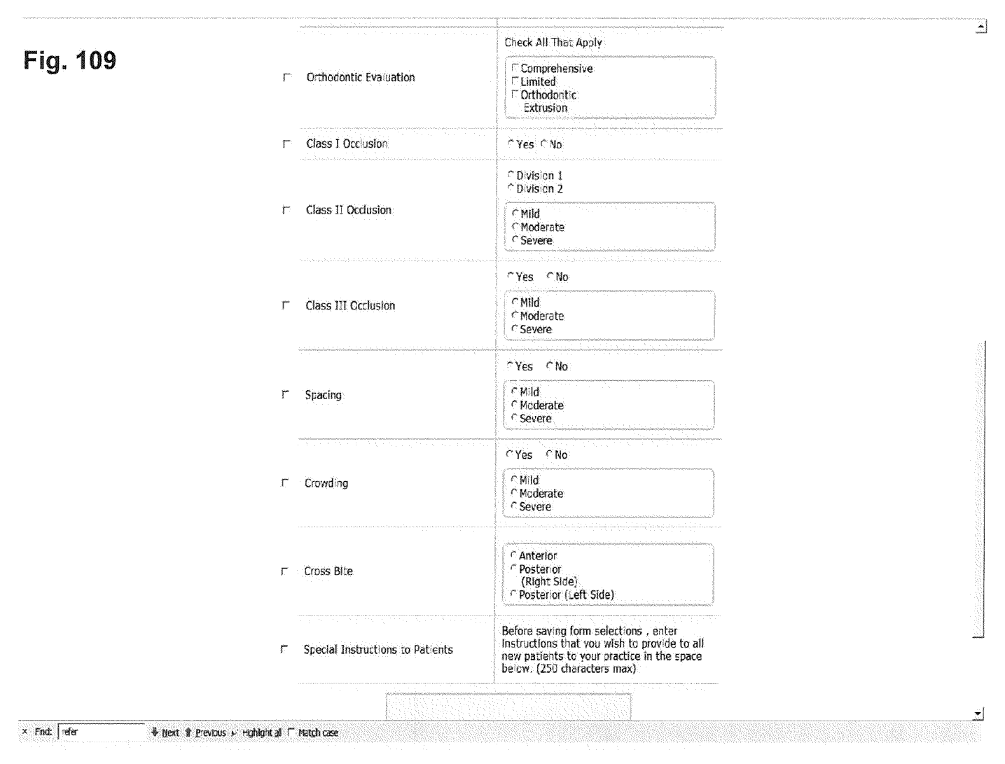

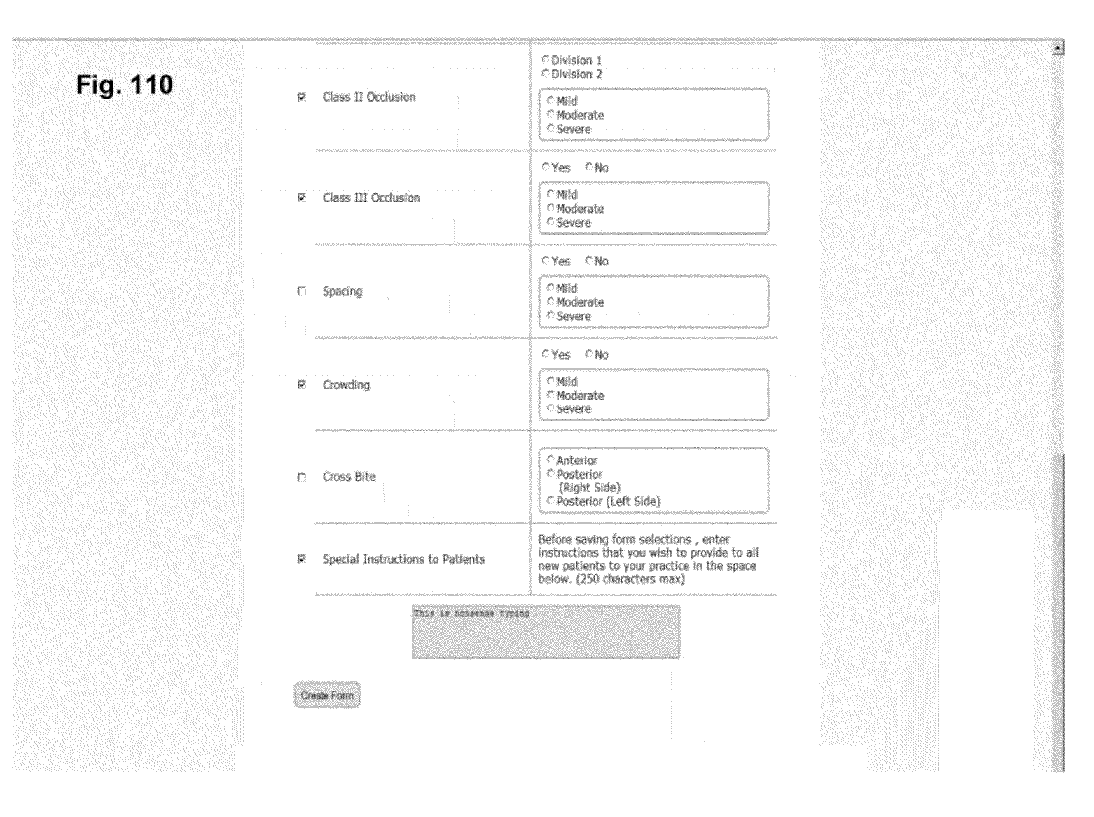

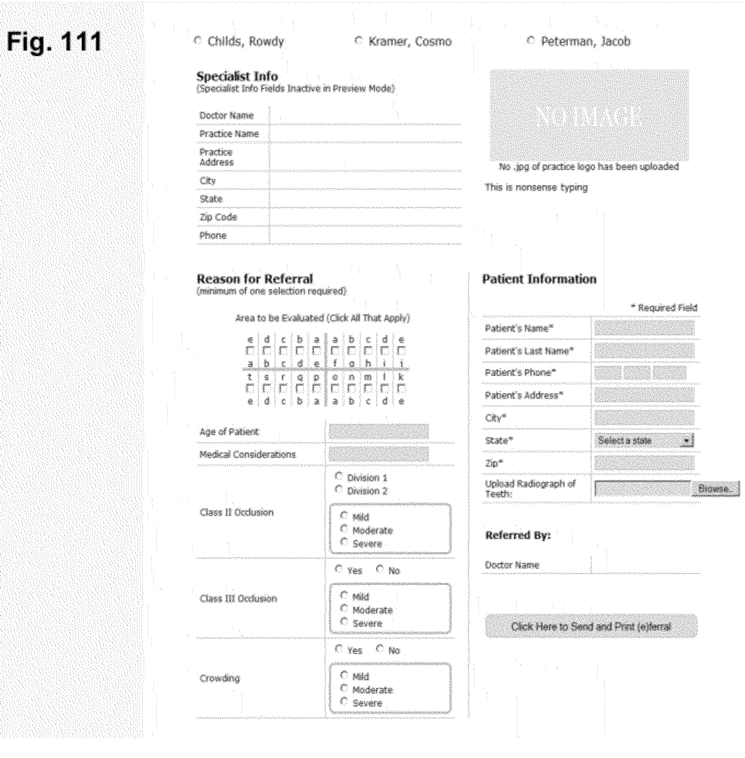

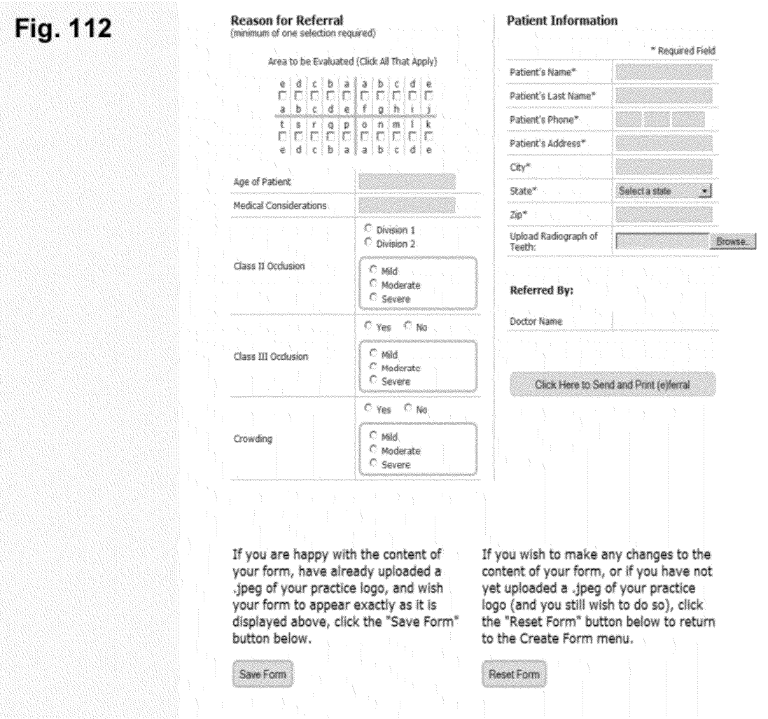

### DETAILED DESCRIPTION OF THE DISCLOSURE

In preferred embodiments, the referral database system provides a secure online database that creates a platform by which general medical service providers (general practitioners), and in particular general dentists, may communicate confidential patient information to one or more medical specialist service providers (specialists) when referring patients for specialty care activities. No special software needs to be downloaded or installed on a user's workstation or a server to operate or use either a “Specialist Subscription” or a “General Practitioner Subscription” to the referral database system. The referral database system is not a lead generating database. Subscriptions to the referral database system provide access to unique tools that enable Dental Specialists and General Dentists to improve the way they manage their existing patient referral activities.

In preferred examples, the referral database system may provide unique tools for “Specialty Subscriptions” to create a searchable, customized online referral form [which may be called a referral database form], as well as unique tools for the subscriber to manage, track, count, measure, locate and/or display information relating to individual patient referrals. In such examples, the referral database system may also provide metrics to measure globalized utilization activity for each individual “Specialty Subscription”.

The unique tools that the referral database system provides to “Specialty Subscriptions” may be unique to each individual dental specialty. For example, tools available to a subscriber identifying themselves as practicing one dental specialty might not be available to a subscriber identifying themselves as practicing one of the other dental specialties.

The referral database system may also provide tools for “General Practitioner Subscriptions” that search for, access, and save specific specialty referral database forms. The referral database system may further provide tools to manage, track, count, measure, locate and/or display information relating to individual patient referrals generated by the individual “General Practitioner Subscription”.

In preferred embodiments, The referral database system may include reporting metrics for “Specialty Subscriptions” that measure activity from a truly unique perspective: From the point of origin of the patient referral (the referrals as they are originated by General Practitioner), as an alternative to the point of destination of the patient referral (the referrals as they are received by the Specialist).

The referral database system may be scalable to fit the needs of specialty practices with either single or multiple doctors, as well as specialty practices with either single or multiple practice locations.

In some examples, the referral database system may provide for an individual patient referral record to be accessible only by the originating “General Practitioner Subscription” or the receiving “Specialty Subscription”. In some examples, the referral database system may provide for an alternative ability to access a patient referral record independently of the “General Practitioner Subscription” or the “Specialty Subscription” to which it is attached. In such examples, the referral database system may provide for attaching a randomized identification number to each patient referral. Such an identification number may be used to access some or all information contained in a patient referral record, and such access may occur independently of the “General Practitioner Subscription” or the “Specialty Subscription” to which it is attached.

The referral database system may include subsystems, modules, or routines that provide particular features for different service providers. For example, the referral database system may include modules for the following functions for “Specialist Subscriptions”, including, for example.

Registration:

1. Select Username and Password: Each subscriber may select their own unique username and password. Preferably, such selections are checked against existing entries to ensure that no usernames are duplicated.

2. Billing Information.

3. Subscription Calculator: A subscriber may select an area of specialty practice, one or more doctors included in subscription, one or more practice locations included in subscription, and a duration of the subscription term. A subscription rate, such as a monthly rate, may be calculated and presented to subscriber for approval.

4. Agent Affirmation: A Subscriber may be required to affirm they are a bona fide agent of the practice or group named in the subscription billing info.

5. Subscription Confirmation: The referral database system may first confirm a Username, Password and Subscription ID, and then activate a Subscription.

An active subscriber may provide unique, customized information to be included in their online account information, which may be used by other service providers as a basis for referrals, database research, and/or other business activity.

Such information may be entered and/or updated through a dialog, such as a My Account portal, which may include the following:

1. Upload Practice Logo: A Subscriber may select an image of a practice logo to include on their customized referral database system form.

2. Enter Doctor Information: A Subscriber may enter information for each doctor to be included in the subscription. Fields may include First Name, Last Name, License Number, and/or NPI Number.

3. Enter Location Information: A Subscriber may enter information for each practice location to be included in the subscription. Fields may include Practice Name, Street Address, City, State, Zip Code and/or Practice Telephone Number.

4. Create Form: A subscriber may be presented with a menu of options that they can choose whether or not to include on their custom referral database system form. For example, a subscriber may automatically include a menu item on the form by selecting the bubble to the left of the menu item. All selected items may be inserted in the form under the section titled “Reason for Referral”.

5. Preview Form: A subscriber may be permitted to first view a preview of the form selections that they have chosen, and then decide if they wish to save the form “as is”, or return and make changes. Once the form is saved, it becomes searchable in the database.

In preferred examples, the referral database system may include a “referral database system Center” by which individual Subscribers may interact with the referral database.

A referral database system Center may include one or more of the following features:

List referral database system summary. Such summary may include records sorted by date, with for example the most recent listings appearing at the top.

A referral database system Center listing may include some or all of the following information: Date of origination, Name of Sender, Name of intended Recipient, Patient first and last name, Contacted Status, Scheduled Status, Call Back Function, Notes Function, and/or referral database ID Code.

Contacted Status: A default status may preferably be “N” (no). A single mouse-click on “N” may change the status in database to “Y” (yes). The database may use both the action of changing the status from “N” to “Y”, as well as the time between the origination of the referral and the time when the status is changed to “Y”, in a report, which may be referred to as “Practice Performance Statistics”.

Scheduled Status: Default status is preferably “N” (no). A single mouse-click on “N” preferably changes status in database to “Y” (yes). The database may preferably use the change in status to compile a report labeled “Practice Performance Statistics”.

Call Back Function: Clicking on the calendar icon opens a calendar. Selecting a date in the calendar saves a “Reminder” status in the database. The Reminder status re-inserts the referral summary at the top of the list of results on the date selected. The Call Back function replaces the “Name of the intended Recipient” with the word “REMINDER”. The word “REMINDER” turns a color, such as red, on the date selected in the calendar.

Notes Function: Opens a window where notes may be entered. “Notes” turns a color, such as red, after notes have been added. New notes may be added serially. Each note may be identifiable by the date and time it was entered.

Access to the full Patient referral record. Clicking on a patient's name may cause the full referral record history to be opened.

The referral database system may include a function for searching referral activity through time, which may be called a search referral history.

Search referral history may include one or more of the following search capacities and features:

By Specific Date: Selecting a specific date in the calendar may display all referral database systems received on the selected date.

By Patient Last Name: Entering a patient's last name in the Search Field may display all database referrals with a matching last name.

By Referring GP Last Name: Entering the last name of a referring General Practitioner in the search field may display all database referrals sent by that doctor.

The referral database system may include a function for analyzing and reporting on referral activity included in the database.

Reports may include one or more of the following:

GP Referral Frequency Stats: Lists names of all General Practitioners who have been responsible for referring a patient to the Subscribing Specialist. Such lists may be provided sorted by name, such as in alphabetical order. Such lists may include historical detail of total number of referrals sent by each individual referring general practitioner in preceding months. Such lists may include total numbers of database system referrals sent by each individual referring general practitioner “Month-to-date” in the current month. Such report may be updated regularly, such as updated daily for “Current Month”.

New Referral Sources: Lists the names of general practitioners who do not have a positive history of referring patients to the Specialist Subscription within a prescribed time period, such as a preceding three months. A Report may include: Date of origination, Name of Sender, Name of intended Recipient, Patient first and last name, Contacted Status, Scheduled Status, Call Back Function, Notes Function, and/or referral database ID Code of the first database system referral sent by the New Referral Source. Such Report may be updated regularly, such as daily for “Current Month”.

Improving Referral Sources: Lists the names of individual referring general practitioners whose total number of database system referrals in a time period, such as a previous month, is greater than 20% higher than (i.e., is 120% of) a moving average number (e.g., a three month moving average) of database system referrals for that doctor. Such Report may include: Doctor name, % (percentage) Improvement, Previous Months Total referrals, and/or a Moving Average # (number) of referrals. Such Report may be updated regularly, such as on the first day of each month.

Decreasing Referral Sources: Lists the names of individual referring general practitioners whose total number of referrals in the previous month is more than 20% lower than (i.e., 80% of) a moving average number of referrals (such as a three month moving average) for that doctor. Such Report may include: Doctor name, (percentage) Decrease, Previous Months Total referrals, and/or a Moving Average # (number) of referrals. Such Report may be updated regularly, such as on the first day of each month.

Dead Referral Sources: Lists the names of general practitioners who do not have a positive history of referring patients to the Specialist Subscription within a defined preceding period, such as a preceding two months, but who may have a previous history of referring patients to the specialist subscription prior to that defined period. Such Report may include: Date or dates of origination, Name of Sender, Name of intended Recipient, Patient first and last name, Contacted Status, Scheduled Status, Call Back Function, Notes Function, and/or referral database ID Code of the last referral sent by the Dead Referral Source. Such Report may updated regularly, such as on the first day of each month.

Practice Performance Statistics: Lists a total number of referrals sent to the Specialist Subscription within a defined period, such as a current month. Such Report may present the number of referrals where the “Contacted” status has been updated from “N” to “Y”. Such Report may calculate a percentage of total referrals where the “Contacted” status is updated from “N” to “Y”. Such Report may present the number of referrals where the “Scheduled” status is updated from “N” to “Y”. Such Report may calculate the percentage of total referrals where the “Scheduled” status is updated from “N” to “Y”. Such Report may also calculate an average length of time between a time that a new referral is added to the database (received) and a time when the “Contacted” status is updated from “N” to “Y”. Such Report may be updated regularly, such as daily for the current month. Historical totals from previous months may also be displayed.

The referral database system may further or alternatively include features directed toward General Practitioner service provider Subscribers.

The referral database system may include one or more of the following functions for “General Practitioner Subscriptions”:

Registration:

Select Username and Password: Each subscriber is preferably allowed to select their own unique username and password. Such selections are preferably checked against existing entries to ensure that no usernames are duplicated.

Doctor Information: A subscriber may enter Information about the individual doctor. Fields may include First Name, Last Name, Street Address, City State, Zip Code, and/or Phone Number.

Agreements: A subscriber may be required to agree to a User Agreement and Privacy Policy before their subscription is activated.

Subscription Confirmation: Username, Password and Subscription ID are confirmed. Subscription is now active.

The referral database system may include one or more of the following functions for searching the database for information about Specialist service providers:

Search For Specialists by Name: A subscribing General Practitioner may search for referral system forms belonging to specific specialists by selecting the specialty from a drop down menu and then entering the specialist's first and last names. The search result will preferably yield a unique result for each practice location with which the specialist may be associated. Information included in the search result may include: Practice logo, Specialty, Practice Name, Doctor Name, Practice Address, Practice Phone Number, and/or a Quick-Link to access form.

Search For Specialists by City and State: A subscribing General Practitioner may search for referral system forms belonging to individual practice locations by selecting a specialty from a drop down menu, and then entering a location they wish to search, such as a city and state. Preferably, such a search result will yield a unique result for each practice matching the specialty in the specified location (e.g., the city and state requested). Information included in the search result may include: Practice logo, Specialty, Practice Name, Practice Address, Practice Phone Number, and/or a Quick-Link to access form.

Search for Specialists by Zip Code Radius: A subscribing General Practitioner may search for referral system forms belonging to individual practice locations by selecting a specialty from a drop down menu, entering a Zip Code, then entering a distance radius they wish to search. Such a search preferably yields a unique result for each practice matching the specialty in the specified geographical area. Information included in the search result may include: Practice logo, Specialty, Practice Name, Practice Address, Practice Phone Number, and/or a Quick-Link to access form.

The referral database system may further or alternatively include functional elements to enable a service provider to send a referral, such as a referral from a general practitioner to a specialty practitioner. Sending such a referral may include one or more of the following, which may be provided as serially operated steps:

1. Access the referral form of the intended specialist by performing one of the search options.

2. All patient contact information fields must be filled out completely or referral will not be saved/updated in the database or the Specialist's referral database Center.

3. Intended Specialist must be selected, or the referral will not be saved/updated in the database or the Specialist's referral database Center.

4. Minimum of one “Reason for Referral” must be selected or referral will not be saved/updated in the database or the Specialist's referral database Center.

5. Clicking the “Print and Send” button updates the database and opens the print window. Once the database is updated, the full patient referral record is accessible by the intended specialist, referring general practitioner, and any entity in possession of the unique, randomized character ID Code.

6. The finished referral may include the following information: Patient First Name, Patient Last Name, Full Patient Address, Patient Phone Number, Full Contact Information of Specialist, Practice Logo of Specialist (if uploaded), Specialist Custom Instructions (if selected and entered), Reason for Referral, and/or a First and Last Name of Referring General Practitioner.

7. All fields under “Reason for Referral” that are not selected by the referring General Practitioner are preferably not printed, not included in the final referral database system record, and are dropped.

The referral database system may include features directed towards a referral database Center for each subscribing General Practitioner provider.

Such General Practitioner referral database Centers may include the following:

List referral database summary: Record of all referrals sent by a General Practitioner, which may be sorted by date, such as with the most recent listings appearing at the top.

Such listing may include the following information: Date of origination, Name of Sender, Name of intended Recipient, Patient first and last name, Contacted Status, Preferred Specialist Status, and/or a referral database ID Code.

Contacted Status: Default status is preferably blank. Status is preferably changed to “Y” after specialist changes status from “N” to “Y” in their Specialist referral database Center.

Preferred Specialist: Preferably shows “Y” when the General Practitioner has indicated that they would like to include the specialist's referral database form on their list of “Preferred Specialists”. This selection may be made once the General Practitioner has accessed the specialist's referral database system form. When this status is displayed as “Y”, a quick-link to the referral database form for the specialist may be listed under a drop-down menu, such as a menu titled “Preferred Specialists” above the referral database Center.

Access to the full Patient Referral Record: Clicking on the patient's name may preferably open the full referral database system record.

Search referral database system History:

1. By Specific Date: Selecting a specific date in the calendar will display all referrals received on the selected date. Clicking on the patient's name opens the full referrals record history.

2. By Patient Last Name: Entering a patient's last name in the Search Filed will preferably display all referrals with a matching last name. Clicking on the patient's name preferably opens a full referral record history

3. By Specialist Last Name: Entering the last name of a specific specialist in the search field preferably displays all referrals sent to that doctor. Clicking on a patient's name preferably opens a full referral history.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein.

Applicant reserves the right to submit claims directed to certain combinations and subcombinations that are directed to one of the disclosed inventions and are believed to be novel and non-obvious. Inventions embodied in other combinations and subcombinations of features, functions, elements and/or properties may be claimed through amendment of those claims or presentation of new claims in that or a related application. Such amended or new claims, whether they are directed to a different invention or directed to the same invention, whether different, broader, narrower or equal in scope to the original claims, are also regarded as included within the subject matter of the inventions of the present disclosure. Where such claims recite “a” or “a first” element or the equivalent thereof, such claims should be understood to include incorporation of one or more such elements, neither requiring nor excluding two or more such elements.

What is claimed is:

1. A method of tracking referrals received from one or more referring persons to a professional, comprising:
receiving, from a referring person of the one or more referring persons, an electronic instruction to print a paper copy of referral data associated with a referral from the referring person; and
storing the referral data in first and second portions of a database in response to receiving the electronic instruction, wherein the first portion is accessible via the Internet by the referring person and the second portion is accessible via the Internet by the professional.

2. The method of claim 1, further comprising providing one or more electronic forms to the referring person to provide a template for the referring person to enter the referral data.

3. The method of claim 1, further comprising receiving at least one customized electronic form from the professional and providing the at least one customized electronic form to the referring person.

4. The method of claim 3, further comprising providing the referring person with the ability to store the at least one customized electronic form in the first portion of the database.

5. The method of claim 4, further comprising providing an electronic search tool to the referring person, the electronic search tool being configured to search for the at least one customized electronic form of the professional in the first portion of the database.

6. The method of claim 1, further comprising generating a referral frequency report that lists names of the one or more referring persons and the total number of referrals sent to the professional from the one or more referring persons.

7. The method of claim 1, where the one or more referring persons are from a population of potential referring persons, further comprising generating a new referral sources report that lists names of persons in the population of potential referring persons that are not a member of the one or more referring persons.

8. The method of claim 7, wherein the new referral sources report lists names of persons in the population of potential referring persons that are not a member of the one or more referring persons during a time period selected by the professional.

9. The method of claim 1, further comprising generating an improving referral sources report that list names of the one or more referring persons whose number of referrals in a first time period was higher than the number of referrals in a second time period that precedes the first time period.

10. The method of claim 9, wherein the improving referral sources report lists names of the one or more referring persons whose number of referrals in a first time period was higher by a percentage selected by the professional than the number of referrals in a second time period that precedes the first time period.

11. The method of claim 1, further comprising generating a decreasing referral sources report that list names of the one or more referring persons whose number of referrals in a first time period was lower than the number of referrals in a second time period that precedes the first time period.

12. The method of claim 11, wherein the decreasing referral sources report lists names of the one or more referring persons whose number of referrals in a first time period was lower by a percentage selected by the professional than the number of referrals in a second time period that precedes the first time period.

13. The method of claim 1, where the one or more referring persons are from a population of potential referring persons, further comprising generating a dead referral source report that lists names of persons in the population of potential referring persons that were not a member of the one or more referring persons in a first time period but were a member of the one or more referring persons in a second time period that precedes the first time period.

14. The method of claim 1, further comprising generating a practice performance statistics report that lists a total number of referrals sent to the professional within a time period selected by the professional.

15. The method of claim 1, further comprising generating an electronic identification code for the referral, the electronic identification code being different from electronic identification codes generated for other referrals from the one or more referring persons.

16. The method of claim 15, further comprising receiving a request via the Internet for the referral data of the referral from a user, the request having the electronic identification code generated for the referral data, locating the referral data in the database based on the electronic identification code, and transmitting the referral data to the user.

17. The method of claim 1, further comprising receiving treatment status data via the Internet from the professional, associating the treatment status data with the referral data of the referral, and storing the associated treatment status data in the first and second portions of the database.

18. A storage medium, readable by a processor of a computer system, having embodied therein a computer program of commands executable by the processor, the computer program being configured to be executed to:
receive an electronic instruction to print a paper copy of referral data associated with a referral from a referring person to a professional; and
store the referral data in first and second portions of a database in response to receiving the electronic instruction, wherein the first portion is accessible via the Internet by the referring person and the second portion is accessible via the Internet by the professional.

19. The storage medium of claim 18, wherein the computer program is further configured to be executed to:
receive at least one customized form from the professional;
provide the at least one customized form to the referring person;
provide the referring person with the ability to store the at least one customized form from the professional in the first portion of the database; and
provide a search tool to the referring person to search for the at least one customized form of the professional in the first portion of the database.

20. A method of tracking referrals received from one or more referring general practitioners to a specialist, comprising:
receiving at least one customized form from the specialist;
providing the at least one customized form to the one or more referring general practitioners;
providing the one or more referring general practitioners with the ability to store the at least one customized form from the specialist in a portion of the database;
providing the at least one customized form to a referring general practitioner of the one or more referring general practitioners;
receiving an electronic instruction to print a paper copy of the at least one customized form having referral data associated with a referral from the referring general practitioner;
storing the referral data in first and second portions of a database in response to receiving the electronic instruction, wherein the first portion is accessible via the Internet by the referring general practitioner and the second portion is accessible via the Internet by the specialist;
receiving treatment status data via the Internet from the specialist;
associating the treatment status data with the referral data of the referral; and
storing the associated treatment status data in the first and second portions of the database with the referral data.
